(19) United States
(12) Patent Application Publication
(10) Pub. No.: US 2023/0185537 A1
(43) Pub. Date: Jun. 15, 2023

(54) DESIGN OF HIGH-PERFORMANCE AND SCALABLE MONTGOMERY MODULAR MULTIPLIER CIRCUITS

(71) Applicant: UNIVERSITY OF SOUTHERN CALIFORNIA, Los Angeles, CA (US)

(72) Inventors: Bo ZHANG, Los Angeles, CA (US); Zeming CHENG, Los Angeles, CA (US); Massoud PEDRAM, Los Angeles, CA (US)

(73) Assignee: UNIVERSITY OF SOUTHERN CALIFORNIA, Los Angeles, CA (US)

(21) Appl. No.: 17/920,687

(22) PCT Filed: Apr. 23, 2021
(86) PCT No.: PCT/US2021/028896

§ 371 Date: Oct. 21, 2022

Related U.S. Application Data
(60) Provisional application No. 63/014,390, filed on Apr. 23, 2020.

(51) Int. Cl. G06F 7/72

(52) U.S. Cl. CPC G06F 7/728

(57) ABSTRACT

This patent discloses novel design and implementations of high-performance and scalable Montgomery modular multiplier circuits by utilizing and developing a combination of optimization techniques and dataflow transformations including use of carry-save compressions, multiplier decomposition using a radix of 2m, multiplicand decomposition using a radix of 2w, parallelization of computations of the quotient and intermediate results in each iteration of the Montgomery modular multiplication, replacement of multiplications and additions in each iteration with simple encoding and compression operations, and correction of potential overflows in intermediate results by doing a simple 2-bit addition.

### CROSS-REFERENCE TO RELATED APPLICATIONS

This application claims the benefit of U.S. application Ser. No. 63/014,390 filed Apr. 23, 2020, the disclosure of which is hereby incorporated in its entirety by reference herein.

### TECHNICAL FIELD

The present invention relates to a cryptographic systems, and more particularly, to a Montgomery modular multiplier including both fixed-precision and scalable designs.

### BACKGROUND

High-speed and area-efficient hardware implementation of modular multiplication (MM) has been a subject of great interest. The design of a modular multiplication significantly affects the performance of many cryptosystems like Rivest-Shamir-Adleman (RSA) [23], elliptic-curve cryptography (ECC) [11], somewhat homomorphic encryption (SHE) [17], and fully homomorphic encryption (FHE) [6, 22]. Based on the hardness of the underlying mathematical problem, a cryptosystem usually deals with large integers from hundreds of bits to thousands of bits. More concretely, the performance of a variable bitwidth N of the modulus is an important concern. Therefore, efficient hardware realization of an MM algorithm (dealing with large integers) is a key challenge.

a. Basic Modular Multiplication

To better explain algorithms, some notation is provided. An N-bit integer X will be represented as X=Σᵢ₌₀^{N-1} X[i]2ⁱ in radix-2 and X=Σᵢ₌₀ⁿ^{ₘ}⁻¹ Xᵢ2^{im} in radix-2^{m} where nₘ=┌N/m┐ and Xᵢ=X[im+m−1: im] denotes bits of X belonging to word i. X is padded with (nₘ*m−N) zeros to the left of the most significant bit (MSB). We refer to nₘ as the word count and m as the word width.

Given a multiplicand X, a multiplier Y, and a modulus M, the modular multiplication (MM) targets to compute Z=XYmodM. Realization 1 presents the basic N-bit modular multiplication, where we decompose the multiplier Y into nₘ=┌N/m┐ words. In the algorithm, we scan multiplier Y from the most significant word to the least significant word. In particular, we left shift the intermediate result Z⁽ⁱ⁺¹⁾ from the (i+1)-st iteration by m bits and add it to the product of X and Yᵢ. Next, the quotient q⁽ⁱ⁾ is computed as the floor of T⁽ⁱ⁾ divided by M, and Z⁽ⁱ⁾ is calculated by subtracting q⁽ⁱ⁾M from T⁽ⁱ⁾.

```
Realization 1 Radix-2^{m} Basic Modular Multiplication
Input: X, Y ∈ [0, M), 2^{N-1} ≤ M < 2^{N}, r = m^{m}, nₘ =
    ┌N/m┐
Output: Z ∈ [0, M)
  1: Z^{⁽ⁿ}^{m}^{⁾} = 0
  2: for i = uₘ − 1 to 0 do
  3: T⁽ⁱ⁾ = Z⁽ⁱ⁺¹⁾r + XY₁
  4: q⁽ⁱ⁾ = └T⁽ⁱ⁾ / M┘
  5: Z⁽ⁱ⁾ = T⁽ⁱ⁾ − q⁽ⁱ⁾ M
  6: end for
  7: return Z = Z⁽⁰⁾
```

It is easy to show that Z⁽ⁱ⁾ lies in the range [0, M):

$$\frac{{T}^{( i )}}{M} - {q}^{( i )} = \frac{{T}^{( i )}}{M} - [ \frac{{T}^{( i )}}{M} ] ∈ [ 0 , 1 ) \qquad ( 1 )$$

$${Z}^{( i )} = {T}^{( i )} - {q}^{( i )} M ∈ [ 0 , M )$$

We can unfold the expression of Z⁽⁰⁾ until Z⁽ⁿ^{ₘ₎} as shown below.

$${Z}^{( i )} = {T}^{( i )} - {q}^{( i )} M = {Z}^{( i + 1 )} r + {XY}_{i} - {q}^{( i )} M \qquad ( 2 )$$

$${Z}^{( 0 )} = {Z}^{( 1 )} r + {XY}_{0} - {q}^{( 0 )} M ⋯ = {Z}^{( {n}_{m} )} r + X {\sum }_{i = 0}^{{n}_{m} - 1} {Y}_{i} {r}^{i} - M {\sum }_{= 0}^{{n}_{m} - 1} {q}^{( i )} {r}^{i} = XY - M {\sum }_{i = 0}^{{n}_{m} - 1} {q}^{( i )} {r}^{i} ≡ {}_{M} XY$$

Although this realization is simple and immediately correct (i.e., it does not need a correction step as found in more advanced modular multiplication algorithms), it relies on doing large-bitwidth divisions to compute q⁽ⁱ⁾, which is quite expensive. This realization is also referred as interleaved modular multiplication (IMM), especially when m is 1 or 2 and multiplication can be easily optimized.

b. Montgomery Modular Multiplication

Montgomery modular multiplication [14] is widely used because it replaces time-consuming divisions of the basic modular multiplication with multiplications and shifts.

Let M be an N-bit odd positive integer. Instead of directly computing Z=XYmodM, the operation can be performed efficiently in Montgomery domain with Montgomery modular multiplication. Assume R is a power of 2 and R>M. We can transform \hat{X} (in the ordinary domain) into X (in the Montgomery domain) as below:

X=\hat{X}R mod M,\hat{X}=XR⁻¹ mod M (3)

where R⁻¹ is the modular multiplicative inverse of R with R⁻¹∈(0, M) and RR⁻¹modM=1. The Montgomery form Z of \hat{Z}=\hat{X}ŶmodM is represented by X, Y, and R⁻¹ as follows:

$$Z = \hat{Z} R mod M = \hat{X} \hat{Y} R mod M = ( \hat{X} R ) ( \hat{Y} R ) {R}^{- 1} mod M = {XYR}^{- 1} mod M \qquad ( 4 )$$

Notice that the transformation between X and \hat{X} can also be fitted into operation XYR⁻¹modM with different X and Y, as shown below:

$$X = \hat{X} \cdot {R}^{2} \cdot {R}^{- 1} mod M = \hat{X} \cdot ( {R}^{2} mod M ) \cdot {R}^{- 1} mod M \qquad ( 5 )$$

$$\hat{X} = X \cdot 1 \cdot {R}^{- 1} mod M$$

Therefore, the design of Z=XYR⁻¹modM determines the performance of Montgomery MM.

Depending on whether the bitwidth N is fixed or variable, the design of the Montgomery MM falls into two categories: fixed-precision [3, 7, 12] and scalable [10, 25, 26] Montgomery MM. Given a multiplicand X, a multiplier Y, and a modulus M, the modular multiplication computes Z=XYmodM. A fixed-precision Montgomery MM with radix 2^{m} (FPR2tm) assumes the bitwidth N of the modulus is fixed and computes intermediate results related to m bits of the multiplier iteratively. When N is known, some optimization techniques, like Karatsuba multiplication and Toom-Cook multiplication [7], are possible to simplify the three required multiplications in each iteration. When N is variable, a scalable Montgomery MM with radix 2^{m} (MWR2tm) focuses on designing some ingenious modules, which process w bits of the multiplicand and the modulus, and m bits of the multiplier in each iteration.

When m=1, the multiplication with 1 bit of the multiplier (radix 2 design) is simply a parallel collection of 2-input AND logic. Many prior art references focused on improving the radix 2 design, either for fixed-precision (FPR2t1) or scalable (MWR2t1) versions. The disadvantage of radix 2 design is its high cycle latency because it has to compute the intermediate results one multiplier bit a time. When m>1, the cycle latency can be reduced to approximately 1/m. However, the design becomes quite costly in terms of area and delay of the resulting circuit, which hinders the development of a high-radix Montgomery MM.

c. Fixed-Precision Montgomery Modular Multiplication

Realization 2 shows the fixed-precision radix-2^{m} Montgomery modular multiplication (FPR2tm), where we scan a group of m-bits of multiplier Yᵢ in the i-th iteration. Let d=┌N/m┐ denote the number of iterations. Bazout's identity implies that rr⁻¹−MM′=1 when r and M are positive and relatively prime with r⁻¹∈(0, M) and M′∈(0, r). Both r⁻¹ and M′ can be computed through the extended Euclidean algorithm.

```
Realization 2 Fixed-precision radix-2^{m} Montgomery
modular multiplication (PPR2tm)
Input: X, Y ∈ [0, M), odd M < 2^{N}, r = 2^{m}, d = ┌N/m┐,
  R = r^{d}, rr⁻¹ − M M′ = 1
Output: Z ∈ [0, M)
  1: Z⁽⁻¹⁾ = 0
  2: for i = 0 to d − 1 do
  3: Z⁽ⁱ⁾ = Z⁽ⁱ⁻¹⁾ + XYᵢ
  4: q⁽ⁱ⁾ = (Z⁽ⁱ⁾ mod r)M′ mod r
  5: Z⁽ⁱ⁾ = (Z⁽ⁱ⁾ + q⁽ⁱ⁾ M)/r
  6: end for
  7: Z = Z^{(d-1)}
  8: if Z > M then
  9:  Z = Z − M
10: end if
11: return Z
```

In line 3 of realization 2, the product XYᵢ is added to the intermediate result Z⁽ⁱ⁻¹⁾ obtained in the (i−1)-st iteration to produce the current intermediate result Z⁽ⁱ⁾. We compute q⁽ⁱ⁾ in line 4 so that Z⁽ⁱ⁾+q⁽ⁱ⁾M becomes a multiple of r, and therefore, the computation of (Z⁽ⁱ⁾+q⁽ⁱ⁾M)/r in line 5 is reduced to a simple right shift (Z⁽ⁱ⁾+q⁽ⁱ⁾M) by m bits. To achieve this goal, we set q⁽ⁱ⁾=Z⁽ⁱ⁾M′ so that

$${Z}^{( i )} + {q}^{( i )} M = {Z}^{( i )} + {Z}^{( i )} {M}^{′} M = {Z}^{( i )} ( 1 + {MM}^{′} ) = {Z}^{( i )} {rr}^{- 1} ≡ {}_{r} 0 \qquad ( 6 )$$

where ≡ᵣ denotes the congruence relationship modulo r. Notice that Z⁽ⁱ⁾M′ is just one of many possible choices for q⁽ⁱ⁾. Adding/subtracting any multiples of r to/from Z⁽ⁱ⁾M′ will still meet the requirement Z⁽ⁱ⁾+q⁽ⁱ⁾M ≡ᵣ 0. In other words, q⁽ⁱ⁾ is unique up to a modulo on r. Consequently, valid choices of q⁽ⁱ⁾ form a set as shown below:

q⁽ⁱ⁾=Z⁽ⁱ⁾M′+kr≡ᵣZ⁽ⁱ⁾M′ mod r,k∈ [symbol] (7)

Line 5 of realization 2 can be rewritten as in (8) below, which establishes a relation between Z⁽ⁱ⁾ and Z⁽ⁱ⁻¹⁾. Using this relation, we can recursively unfold Z⁽ⁱ⁾ until Z⁽⁻¹⁾=0:

$${Z}^{( i )} r = {XY}_{i} + {q}^{( i )} M + {Z}^{( i - 1 )} \qquad ( 8 )$$

$${Z}^{( i )} {r}^{2} = {XY}_{i} r + {q}^{( i )} Mr + {Z}^{( i - 1 )} r = {XY}_{i} r + {XY}_{i - 1} + {q}^{( i )} Mr + {q}^{( i - 1 )} M + {Z}^{( i - 2 )}$$

$$…$$

$${Z}^{( i )} {r}^{i + 1} = X {\sum }_{k = 0}^{i} {Y}_{k} {r}^{k} + M {\sum }_{k = 0}^{i} {q}_{k} {r}^{k}$$

Consider the last iteration i=d−1=┌N/m┐−1. We have Σₖ₌₀^{d-1} Yₖr^{k}=Y. Defining R=r^{┌N/m┐} and Q=Σₖ₌₀^{d-1} qₖr^{k}, we have:

$${Z}^{( d - 1 )} R = {Z}^{( d - 1 )} {r}^{⌈ N / m ⌉} = {Z}^{( d - 1 )} {r}^{d} = X {\sum }_{k = 0}^{d - 1} {Y}_{k} {r}^{k} + M {\sum }_{k = 0}^{d - 1} {q}_{k} {r}^{k} = XY + MQ \qquad ( 9 )$$

The Bezout's identity implies that RR⁻¹−MM⁻¹=1 since R is even and M is odd. Therefore, Z^{(d-1)}=Z⁽ⁿ^{ₘ}⁻¹⁾ ≡_{M} XYR⁻¹ in (10).

$${Z}^{( d - 1 )} + {Z}^{( d - 1 )} {MM}^{′} = {Z}^{( d - 1 )} ( 1 + {MM}^{′} ) = {Z}^{( d - 1 )} {RR}^{- 1} = {XYR}^{- 1} + {MQR}^{- 1} \qquad ( 10 )$$

$${Z}^{( i )} ≡ {( {}_{M} XYR )}^{- 1}$$

The range of Z^{(d-1)} for q⁽ⁱ⁾=Z⁽ⁱ⁾M′ modr can be estimated in equation (11). Since M is a N-bit odd integer, we must have M<2^{N}<2^{┌N/m┐m}=r^{d}. Consequently, the range of Z^{(d-1)} is [0,2M), and only one correction in line 8-10 is needed to adjust Z back to the range [0, M).

$${Z}^{( d - 1 )} {r}^{d} = X {\sum }_{k = 0}^{d - 1} {Y}_{k} {r}^{k} + M {\sum }_{k = 0}^{d - 1} {q}_{k} {r}^{k} = XY + M {\sum }_{k = 0}^{d - 1} {q}_{k} {r}^{k} < {M}^{2} + M ( r - 1 ) {\sum }_{k = 0}^{d - 1} {r}^{k} = {M}^{2} + M ( r - 1 ) \frac{{r}^{d} - 1}{r - 1} < ( M + {r}^{d} ) M \qquad ( 11 )$$

$${Z}^{( d - 1 )} < ( 1 + \frac{M}{{r}^{d}} ) M$$

In realization 2, we have to compute q⁽ⁱ⁾ first and Z⁽ⁱ⁾+q⁽ⁱ⁾M next. The critical path in each iteration thus encompasses three multiplications and two additions. When m=1, the multiplication with 1 bit of multiplier XY[i] can be simplified as a parallel collection of 2-input AND logic, as shown in realization 3. The quotient q⁽ⁱ⁾ is simply the least significant bit (LSB) of Z⁽ⁱ⁾ in line 4. The critical path reduces to only two additions, which can be even optimized if we use carry-save compression.

```
Realization 3 Fixed-precision radix-2 Montgomery modular
multiplication (PPR2t1)
Input: X, Y ∈ [0, M), odd M < 2^{N}, r = 2, d = N, R = 2^{N}
Output: Z ∈ [0, M)
  1: Z⁽⁻¹⁾ = 0
  2: for i = 0 to d − 1 do
  3: Z⁽ⁱ⁾ = Z⁽ⁱ⁻¹⁾ + XY[i]
  4: q⁽ⁱ⁾ = Z⁽ⁱ⁾ mod 2 = Z⁽ⁱ⁾[0]
  5: Z⁽ⁱ⁾ = (Z⁽ⁱ⁾ + q⁽ⁱ⁾ M)/2
  6: end for
  7: Z = Z^{(d-1)}
  8: if Z > M then
  9:  Z = Z − M
10: end if
11: return Z
```

The disadvantage of FPR2t1 design is its high cycle latency because it has to compute the intermediate results about one multiplier bit a time. When m>1, the cycle latency can be reduced to approximately 1/m since we scan m bits of multiplier in one iteration. However, two challenges hinders the development of a high-radix Montgomery MM:
Computationally expensive operations. In each iteration, the multiplications involved with XYᵢ and q⁽ⁱ⁾M are costly but necessary. The critical path grows up very fast when m increases. Although the cycle latency can be reduced to approximately 1/m, the time latency (product of cycle latency and clock period) does not reduce too much as we expect.
Computation dependency. We have to compute quotient q⁽ⁱ⁾ first and update intermediate result Z⁽ⁱ⁾ next. This data dependency unavoidably cause a long critical path, and the situation becomes worse when the m increases.

d. Scalable Montgomery Modular Multiplication

References [8, 27] proved that the correction step is not immediately necessary. Following equation (11) when r=2 (m=1), when inputs X and Y are in [0,M) we need d=N iterations to ensure Z in the range [0,2M). When inputs X and Y are in [0,2M), we just need to set R=2^{N+2} and use d=N+2 iterations in FPR2t1. When we need to do multiple modular multiplications, like when doing modular exponentiation, this setup allows us to start the next modular multiplication without doing the correction step. Therefore, we present various algorithms for scalable Montgomery MM to perform Z=XYR⁻¹modM where inputs X and Y and output Z are in [0,2M).

Based on the FPR2t1 algorithm, reference [26] presented a radix-2 scalable Montgomery modular multiplication. Originally, the authors described their algorithms as a multiple word radix-2 Montgomery multiplication (MWR2MM). To use a consistent naming convention throughout our article, we refer to the scalable Montgomery MM with radix-2 as MWR2t1. Realization 4 shows the MWR2t1 algorithm. Each outer loop, which goes through N+2 iterations, scans 1 bit of the multiplier Y. The i-th outer loop iteration is equivalent to computing the result of the i-th iteration of the FPR2t1. MWR2t1 uses an inner loop, which iterates e times, to scan a word of w≥2 bits of the multiplicand X in each iteration. e is equal to ┌(N+2)/w┐+1 in binary form (and ┌(N+1)/w┐+1 in carry-save form) when X, Y∈[0,2M).

```
Realization 4 Scalable radix-2 Montgomery modular
multiplication (MWR2t1)
Input: X, Y ∈ [0, 2M), odd M < 2^{N}, r = 2, d = N + 2,
    R = 2^{N + 2}
    w ≥ e = ┌(N + 2)/w┐ + 1
Output: Z ∈ [0, 2M)
  1: Z⁽⁻¹⁾ = 0
  2: for i = 0 to d − 1 do {//Outer loop}
  3: Cₐ = C_{b} = 0
  4: for j = 0 to e − 1 do {//Inner loop}
  5: (Cₐ, Zⱼ⁽ⁱ⁾) = Zⱼ⁽ⁱ⁻¹⁾ + XⱼY[i] + Cₐ
  6: if j == 0 then
  7: q⁽ⁱ⁾ = Z₀⁽ⁱ⁾[0]
  8: end if
  9: (C_{b}, Zⱼ⁽ⁱ⁾) = Zⱼ⁽ⁱ⁾ + q⁽ⁱ⁾ Mⱼ + C_{b}
10: Zⱼ₋₁⁽ⁱ⁾ = Concatenate(Zⱼ⁽ⁱ⁾[0], Zⱼ₋₁⁽ⁱ⁾[w −1 : 1])
11: end for
12: Zₑ₋₁⁽ⁱ⁾ = Z₋₁⁽ⁱ⁾ = 0
13: end for
14: return Z
```

We compute q⁽ⁱ⁾ based the least significant bit (LSB) of Z₀⁽ⁱ⁾ in the 0-th inner loop iteration and use it in the remaining inner loop iterations. The w-bit additions in lines 5 and 9 result in a (w+1)-bit integer. We assign the most significant bit to Cₐ or C_{b} and the remaining w least significant bits to Zⱼ. Finally, because we had to right shift Z by 1 bit in line 5 of the FPR2t1 algorithm, the new Zⱼ₋₁⁽ⁱ⁾ in line 10 of the MWR2t1 realization is calculated as the concatenation of Zⱼ⁽ⁱ⁾[0] and Zⱼ₋₁⁽ⁱ⁾[w−1: 1]. Note that realization 4 also work for the case where w=1. In that case, the only change is to modify line 10 of the 4 realization to read as Zⱼ₋₁⁽ⁱ⁾=Zⱼ⁽ⁱ⁾[0].

Once we finish the 1-st inner loop iteration of the i-th outer loop iteration (i.e., i,j=1), we have computed Z₀, which is required for the 0-th inner loop iteration of the (i+1)-st outer loop iteration (i.e., i+1,j=0). Therefore, if we use N+2 processing elements (PEs) to do the outer loop iterations (one PE per outer loop iteration), we can start the next PE two cycles after the current PE. Exploiting this observation, we can design multiple-PE hardware that will have an issue latency (L) of 2. The clock period of a PE is lower bounded by two w-bit additions in binary form (lines 5 and 9).

Reference [26] presented a design of a radix 2 scalable modular multiplication (MWR2t1) with the issue latency of L=2. Later references such as [9, 10, 25] improved MWR2t1 by reducing the issue latency to one (L=1) by using elaborate methods. In spite of this low issue latency, the problem remains that, with a radix 2 design, we can only issue one bit of the multiplier every L cycles. As a result, we need at least LN cycles to finish the N-bit modular multiplication. This deficiency cannot be overcome no matter how many PEs are instantiated.

The scalable architecture of Montgomery MM provide us the capability when the bitwidth N of modulus M is variable. A PE only needs e cycles to complete the assigned outer loop iteration, and we can reuse it every e cycles, etc. As shown in realization 4, the value of e is determined by bitwidth N of modulus and word width w of multiplicand X. Ideally, we prefer at least p=┌e/L┐ PEs so that the 1-st PE becomes free when the p-th PE generates Z₀. We can thus reuse the 1-st PE to compute the (p+1)-st outer loop iteration.

In contrast, we can only instantiate p PEs for a presumed bitwidth N of modulus M. When the actual bitwidth is larger than the presumed, we do not have enough PEs. The 1-st PE is still busy when the p-th PE generates Z₀, and we need a memory management unit to buffer intermediate results until 1-st PE becomes free. A memory management unit could be designed as an internal first-in first-out (FIFO) queue or an external RAM module, whose memory size can be very large. Consequently, the actual bitwidth can be larger than the presumed, as long as we can buffer all intermediate results. The non-decomposability challenge is thus solved.

The problem in the fixed-precision Montgomery MM also exists in the scalable Montgomery MM. Many references focus on improving radix-2 or radix-4 scalable Montgomery MM by reducing issue latency or critical path. High-radix design with fewer iteration is not well studied, since multiplication is an expensive operation and elongates the critical path.

### SUMMARY

Disclosed herein are three designs and implementations of highly efficient Montgomery modular multiplier circuits as summarized below.

A first design is that of a scalable high-radix (i.e., 2^{m}) Montgomery Modular (MM) Multiplication circuit replacing the integer multiplications in each iteration of the Montgomery MM algorithm (related to the product of m bits of the multiplier and the multiplicand) with carry-save compressions completely eliminating costly multiplications. The disclosed Montgomery MM decomposes the multiplicand itself using a radix of 2^{w} with w≥2m, thereby achieving a scalable design, which can deliver an issue latency of one cycle.

A second design is that of a high-performance iterative Montgomery modular multiplication circuit of fixed-precision, wherein the computations of the quotient and intermediate result in each iteration are done in parallel. This parallelism breaks the data dependency in each iteration, and thus, greatly reduces the overall circuit latency for performing a modular multiplication. This realization also replaces required multiplications and additions in each iteration with novel encoding and compressions.

The third design is that of a high-performance, yet scalable, Montgomery Modular Multiplication circuit wherein the potential overflow of intermediate results is simply corrected by a 2-bit addition, resulting in a homogeneous decomposition of intermediate results, which in turn allows us the utilize a custom processing element to decomposes the multiplicand itself using a radix of 2^{w} with w≥3m and deliver an issue latency of one clock cycle. The design of the processing element can be pipelined, wherein the optimal number of processing elements can be reduced or alternatively the circuit throughput can be increased.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIGS. 1a, 1b, and 1c. Embodiments of Montgomery modular multiplier circuits.

FIGS. 1d, 1e, and 1f. Decoders that is used in the Montgomery modular multiplier circuits.

FIG. 2. Example of i-th outer loop iteration when N=8, w=8, and m=2.

FIG. 3. Data Dependency Graph of the MWR2tm Algorithm.

FIGS. 4a and 4b. Schedule for N=6, w=4, and m=2 with (a) p=3 and (b) p=2.

FIG. 5. Internal Design of the Processing Element (PE) for the MWR2tm realization with L=1.

FIG. 6. Proposed Radix 2^{m} Scalable Architecture of Montgomery Modular Multiplication.

FIG. 7. Special Compression for 5-to 2 in PE.

FIG. 8. PEc Diagram for C Task.

FIG. 9. Special Compression for 8-to-2 in PEc.

FIGS. 10a and 10b. Time Latency of the Proposed Montgomery MM Design Presuming N=1,024 with Actual Values of (a) N≤1,024 and (b) N≥1,024.

FIG. 11. Throughput of the Proposed Montgomery MM Design Presuming N=1,024 and with Actual Values of N≥1,024.

FIG. 12. Example of Encode when m=8.

FIG. 13. Model to group k=2 bits.

FIG. 14. Example of EncodeSN when m=8.

FIG. 15. Computing q⁽ⁱ⁾.

FIG. 16. 8-bit signed multiplication with radix-4 modified Booth Coding.

FIG. 17. Data model to accurately represent Z by Z_{S}, Z_{C}, and Z_{carry}.

FIG. 18. Compute Z⁽ⁱ⁾.

FIG. 19. Block-level diagram for the hardware implementation of the proposed Montgomery modular multiplication.

FIG. 20. Data Dependency Graph.

FIGS. 21a and 21b. Schedule for N=8, w=6, and m=2 with (a) p=3 and (b) p=2

FIG. 22. Internal Design of the Processing Element (PE) for the MWR2tm realization with L=1.

FIG. 23. Proposed Radix 2^{m} Scalable Architecture of Montgomery Modular Multiplication

FIG. 24. Overflow when computing ZSMEₑ₋₁/ZCMEₑ₋₁ by truncation when m=4.

FIG. 25. Data model for overflow correction.

FIG. 26. PEc Diagram for C task.

FIG. 27. Table 1: Area and Performance of the Proposed Montgomery Modular Multiplication Design for w and m, when the Modulus M Has N=1024 Bits

FIG. 28. Table 2: Comparisons of Different Montgomery Modular Multiplication with N=1024 and N=2048.

FIG. 29. Table 3: Area and Performance of Different Montgomery Modular Multiplication Designs on Virtex-7 FPGA.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

The term “electronic component” refers is any physical entity in an electronic device or system used to affect electron states, electron flow, or the electric fields associated with the electrons. Examples of electronic components include, but are not limited to, capacitors, inductors, resistors, thyristors, diodes, transistors, etc. Electronic components can be passive or active.

The term “electronic device” or “system” refers to a physical entity formed from one or more electronic components to perform a predetermined function on an electrical signal.

It should be appreciated that in any figures for electronic devices, a series of electronic components connected by lines (e.g., wires) indicates that such electronic components are in electrical communication with each other. Moreover, when lines directed connect one electronic component to another, these electronic components can be connected to each other as defined above.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in an executable software object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

Throughout this application, where publications are referenced, the disclosures of these publications in their entireties are hereby incorporated by reference into this application to more fully describe the state of the art to which this invention pertains.

Abbreviation:

“FPGAs” means Field-Programmable Gate Arrays.

“PE” means processing element.

The terms “processing element” and “processing component” refers to a computer processor (e.g., CPU), programmable logic array, Field-Programmable Gate Array, or any assembly of logic circuits designed to implement the predetermined steps set forth below.

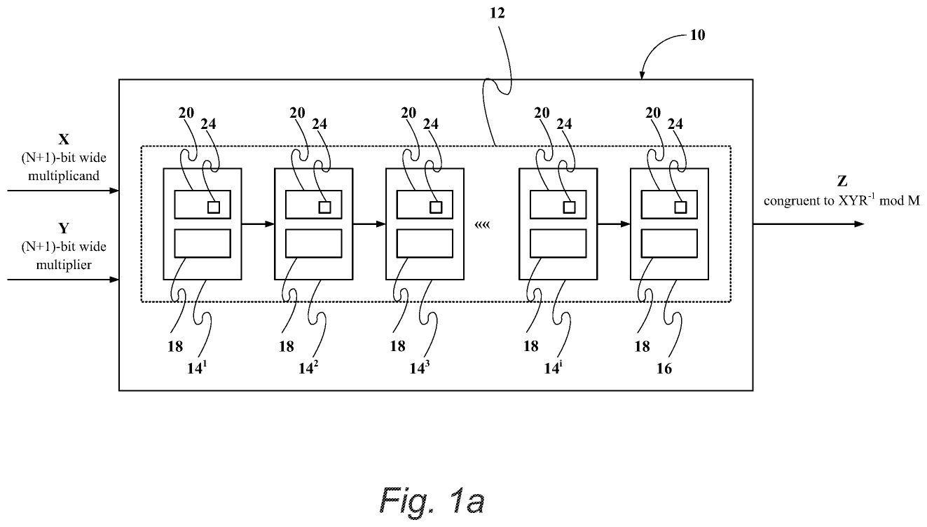

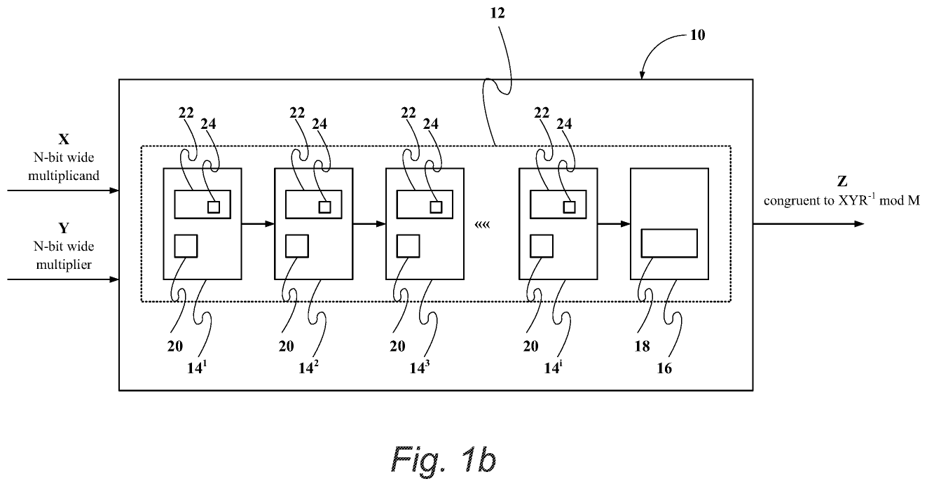

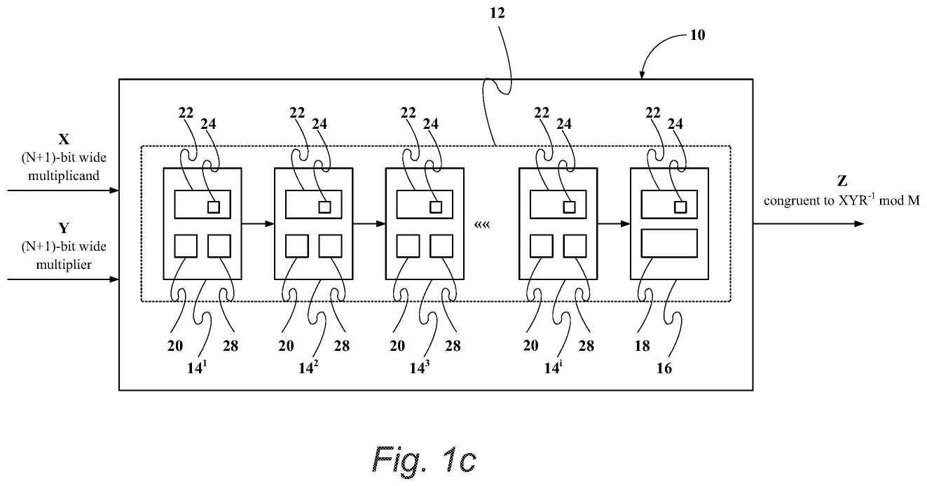

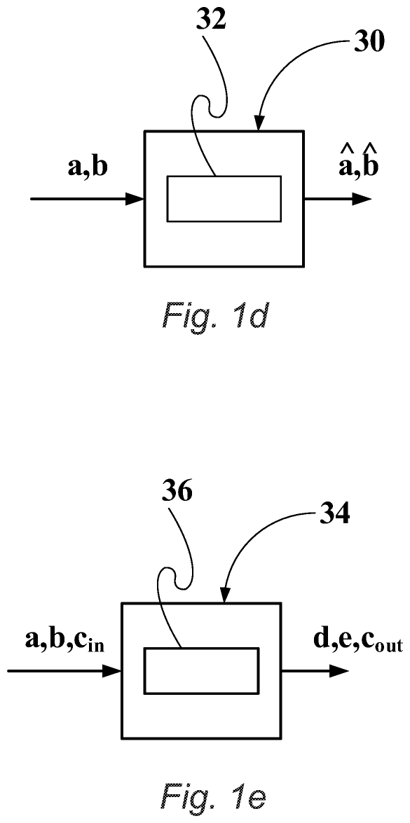

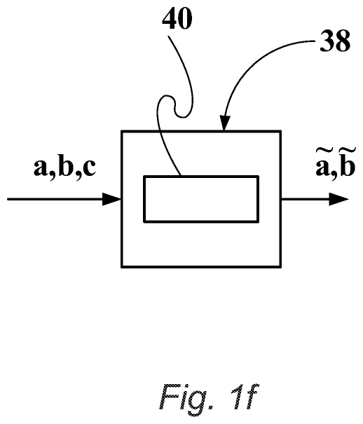

Referring to FIGS. 1a, 1b, and 1c, embodiments of a Montgomery modular multiplier circuit are provided. The Montgomery modular multiplier 10 includes at least one digital processing component 12, which produces a modular multiplication result by (i) decomposing the multiplier into a group of words, each word containing a number of bits, and (ii) calculating one or more intermediate results based on the one or more intermediate results from a previous iteration and a product of the multiplicand and each word of the multiplier in an outer loop iteration. Montgomery modular multiplier circuit 10 can also include includes a plurality of processing elements (PEs) 14ⁱ and post-processing processing element 16. The processing elements (PEs) 14ⁱ include addition block 18 and compressor bock 22 and post-processing processing element 16 includes addition block 18, where i is an integer label for the processing elements. Typically, i runs from 1 to the total number of processing elements.

In a variation, the one or more intermediate results in each outer loop iteration is decomposed into a number of parts where some of the said parts are moved to a next iteration for processing. In a refinement, carry-save compressors 24 within compressor block 22 are used to replace multiplication operations to generate one or more intermediate results. In a further refinement, at least one digital processing component 12 is configured such that (i) the multiplicand is first left-shifted by some number of bits and is then decomposed into a second group of words, each word containing a second number of bits, and (ii) the one or more intermediate results in each outer loop iteration are calculated based on the one or more intermediate results from two previous outer loop iterations and products of each word of the multiplicand and one word of the multiplier in an inner iteration loop.

In a variation, the at least one digital processing component 12 is configured such that modular multiplication result is produced by (i) decomposing the multiplier into a group of words, each word containing a number of bits, and (ii) independently calculating two sets of one or more intermediate results based on the two sets of one or more intermediate results from a previous iteration and a product of the multiplicand and each word of the multiplier in an outer loop iteration. In a refinement, encoding circuit 20 are used to speed up the calculation of any expression that may be modeled as the product of a sum of two integers with another integer.

In another variation, at least one digital processing component 12 is configured such that (i) the one or more intermediate results in each outer loop iteration are partitioned into two sets which can be calculated independently, (ii) first encoding circuits are used to speed up the calculation of any expression that may be modeled as the product of a sum of two integers with another integer, and (iii) second encoding circuits are used to decompose each of the intermediate results in the set of one or more intermediate results into two corresponding intermediate results.

In another variation, the at least one digital processing component 12 is configured such that (i) the multiplicand is first left shifted by some number of bits and is then decomposed into a third group of words, each word containing a third number of bits, (ii) the one or more intermediate results in each outer loop iteration are calculated based on the two sets of one or more intermediate results from two previous outer loop iterations and products of each word of the multiplicand and one word of the multiplier in an inner iteration loop, and (iii) second encoding circuits are used to decompose each of the intermediate results in the set of one or more intermediate results into two corresponding intermediate results.

Referring to FIG. 1a, Montgomery modular multiplier circuit calculates an output value Z congruent to XYR⁻¹modM, wherein X is an (N+1)-bit wide multiplicand and Y is an (N+1)-bit wide multiplier with X and Y being integer numbers in the range [0,2M), M is an N-bit wide modulus, R is an integer that is a power of 2 such that R>M, and R⁻¹ is a modular multiplicative inverse of R with respect to M, the Montgomery modular multiplier circuit using a first input r⁻¹∈[0, M) and a second input M′∈[0, r) such that rr⁻¹−MM′=1 with r=2^{m}. The Montgomery modular multiplier circuit 10 includes at least one digital processing component configured 12 to: a) decompose multiplier Y into nₘ=┌(N+m+2)/m┐ words of m bits each, pad (nₘ*m−N−1) zero's to the left of Y such that Y=Σᵢ₌₀ⁿ^{ₘ} Yᵢ2^{im} with Yᵢ=Y[im+m−1: m] for 0≤i≤nₘ; and b) produce output value Z by iteratively calculating and combining XYᵢr.

Still referring to FIG. 1a, the at least one digital processing component 12 includes a plurality of processing elements (PEs) 14ⁱ such that the i-th PE produces first intermediate results based on one or more intermediate results from the (i−2)-nd PE, one or more second intermediate results from the (i−1)-st PE, and the value of XYᵢr. The at least one digital processing component 12 also includes a post-processing processing element 16 which takes as input the intermediate results of the last two PEs and produces the output value Z. A weighted sum of first intermediate results produced by the i-th PE is congruent to X(Σⱼ₌₀ⁱ Yⱼ2^{jm})r⁻ⁱ.

In a variation, the at least one digital processing component 12 is further configured to:

a) left shift multiplicand X by m bits to produce X′=Xr, pad (e*w−N−m−1) zero's to the left of X′, and decompose X′ into e=┌(N+2m+2)/w┐ words of w bits each such that X′=Σⱼ₌₀^{e-1} X′ⱼ2^{jw} with X′ⱼ=X′[jw+w−1: jw] for 0≤j≤e−1; and

b) produce output value Z by iteratively calculating and combining X′ⱼYᵢ.

In a refinement thereof, the at least one digital processing component 12 comprises:

a) a plurality of processing elements (PEs) such that the i-th PE produces first intermediate results based on one or more intermediate results from the (i−2)-nd PE, one or more intermediate results from the (i−1)-st PE, and the value of XYᵢr in e cycles, where in each cycle the i-th PE receives w bits of each intermediate result from the (i−2)-nd PE and the (i−1)-st PE, and produces w bits of the first intermediate results; and

b) a post-processing PE which takes intermediate results of the last two PEs and produces the output value Z in e cycles.

In a refinement, the data initiation latency is 1 cycle and wherein the Montgomery modular multiplier circuit is scalable.

In a variation, two or more first intermediate results and two of the first intermediate results are decomposed into e=┌(N+2m+2)/w┐ words of w bits, where m≥2 and w≥2m. In a refinement, at least one of the first intermediate results has zero's at bit positions iw to iw+w−m−1 for 0≤i≤e−1. In another refinement, at least one of the first intermediate results has zero's at bit positions iw+w−m to iw+w−1 for 0≤i≤e−1.

In another variation, integer multiplication operations are unrolled into partial products, addition operations that are required to sum partial products and other results are replaced with k-to-2 compressors where k indicates numbers of integers that need to be compressed successively. In a refinement, the at least one digital processing component is further configured to pad (nₘ*m−(N+1)) zero's to the left of multiplier Y and decompose the padded Y into nₘ=┌(N+2m+2)/m┐ words of m bits each, such that Y=Σᵢ₌₀ⁿ^{ₘ}⁻¹ Yᵢ2^{im} with Yᵢ=Y [im+m−1: m] for 0≤i≤nₘ−1. The at least one digital processing component includes:

a) a plurality of processing elements (PEs), the i-th PE producing first intermediate results based on intermediate results from the (i−2)-nd PE and the (i−1)-st PE and such that a weighted sum of intermediate results is congruent to X(Σⱼ₌₀ⁱ Yⱼ2^{jm})r⁻ⁱ; and

b) a post-processing PE taking intermediate results of the last and next to the last PEs and producing the output value Z. In a refinement thereof, there are two or more first intermediate results and at least two of the first intermediate results are decomposed into e=┌(N+2m+2)/w┐ words of w bits, where m≥2 and w≥2m. At least one of the first intermediate results can have zero's at bit positions iw to iw+w−m−1 for 0≤i≤e−1. Moreover, the at least one of the first intermediate results can have zero's at bit positions iw+w−m to iw+w−1 for 0≤i≤e−1. In a refinement, one of the intermediate results is a 1-bit value. In yet another refinement, a Booth coding technique is used to speed up the compressors.

In a refinement, multiplicand X is left shifted by m bits to produce X′=Xr, padded with (e*w−m−(N+1)) zero's on the left, and the padded X′ is decomposed into e words of w bits each with such that X′=Σⱼ₌₀^{e-1} X′ⱼ2^{jw} with X′ⱼ=X′[jw+w−1: jw] for 0≤j≤e−1). The PEs compute their first intermediate results by repeatedly calculating the product of X′ⱼYᵢ for different i and j indices, thereby, enabling design of PEs that are independent of value of N, and producing a scalable Montgomery modular multiplier circuit. In a further refinement, the data initiation latency is 1 cycle. In a further refinement, the Montgomery modular multiplier circuit is scalable. Characteristically, the post-processing processing elements can repeatedly receive intermediate results of the last two PEs and produce the partial output value Z.

With reference to FIG. 1b, a Montgomery modular multiplier circuit is provided. The Montgomery modular multiplier circuit 10 calculates an output value Z congruent to XYR⁻¹modM, wherein X is an N-bit multiplicand and Y is an N-bit multiplier with X and Y being integer numbers in the range [0, M), M is a N-bit wide modulus, R is an integer that is a power of 2 such that R>M, and R⁻¹ is a modular multiplicative inverse of R with respect to M. Characteristically, the circuit uses a first additional input r⁻¹∈[0, M) and a second additional input M″∈[0, r²) such that r²r⁻¹−MM″=1 with r=2^{m}. Montgomery modular multiplier circuit 10 includes at least one digital processing component 12 configured to:

a) decompose multiplier Y into nₘ=┌N/m┐ words of m bits each, pad (nₘ*m−N) zero's to the left of Y such that Y=Σᵢ₌₀ⁿ^{ₘ}⁻¹ Yᵢ2^{im} with Yᵢ=Y[im+m−1: m] for 0≤i<nₘ; and

b) produce output value Z by iteratively calculating and combining values of XYᵢr².

Still referring to FIG. 1b, the Montgomery modular multiplier circuit 10 includes a digital processing element 14ⁱ configured to produce two intermediate results independently of one another in the i-th iteration, wherein the two intermediate results are calculated based on the value of XYᵢr² and the corresponding two intermediate results produced in the (i−1)-st iteration. The Montgomery modular multiplier circuit also includes a post-processing processing element 16 which takes the intermediate results of the last iteration as input and produces the output value Z. In a refinement, one intermediate result produced in the i-th iteration is congruent to X(Σⱼ₌₀ⁱ Yⱼr^{j})r⁻⁽ⁱ⁻¹⁾ modM where r⁻⁽ⁱ⁻¹⁾ is the multiplicative inverse of rⁱ⁻¹modM.

Referring to FIG. 1c, in a the Montgomery modular multiplier circuit, the digital processing element(s) 14ⁱ produces two groups of intermediate results independently of one another in the i-th iteration. Moreover, the two groups of intermediate results produced in i-th iteration are calculated based on the value of X\tilde{Y}ᵢr² and the corresponding two groups of intermediate results produced in the (i−1)-st iteration wherein each group contains three intermediate results and \tilde{Y}ᵢ=Yᵢ−Yᵢ[m−1]r+Yᵢ₋₁[m−1]. Encoder circuits 20 and 28 accelerate the calculation of intermediate results in the i-th iteration. Finally, a post-processing processing element which takes the intermediate results of the last iteration as input and produces the output value Z.

In a variation, a weighted sum of first intermediate results produced in the i-th iteration is congruent to X(Σⱼ₌₀ⁱ Yⱼr^{j})r⁻⁽ⁱ⁻¹⁾ modM where r⁻⁽ⁱ⁻¹⁾ is the multiplicative inverse of rⁱ⁻¹modM.

In another variation of the Montgomery modular multiplier circuit of FIG. 1c, X is an (N+1)-bit multiplicand and Y is an (N+1)-bit multiplier with X and Y being integer numbers in the range [0,2M) wherein the number of iterations d is at least ┌(N+4)/m┐ and R is r^{d-2}; and post-processing processing element 16 takes the intermediate results of the last iteration as input and produces the output value Z.

In another variation, the at least one digital processing component 12 includes a plurality of processing elements 14ⁱ such that the i-th PE produces first intermediate results based on one or more intermediate results from the (i−2)-nd PE, one or more second intermediate results from the (i−1)-st PE, and the value of X\tilde{Y}ᵢr². The at least one digital processing component 12 also includes a post-processing element which takes as input the intermediate results of the last two PEs and produces the output value Z. In a refinement, there are two or more first intermediate results and two of the first intermediate results are decomposed into e=┌(N+2m+3)/w┐ words where w≥3m.

In a variation of FIG. 1c, the Montgomery modular multiplier circuit is configured such that at least one of the first intermediate results has zero's at bit positions iw to iw+w−m−1 for 0≤i≤e−1 and at least one of the first intermediate results has a tail bit at bit positions iw for 0≤i≤e−1.

In another variation of FIG. 1c, the Montgomery modular multiplier circuit is configured such that at least one of the first intermediate results has zero's at bit positions iw+w−m to iw+w−1 for 0≤i≤e−1 and the weight of bit positions iw for 0≤i≤e−1 is −2^{iw}.

In another variation of FIG. 1c, the Montgomery modular multiplier circuit is configured such that multiplicand X is left shifted by 2m bits to produce X′=Xr², padded with (e*w−N−m−1)) zero's on the left, and the padded X′ is decomposed into e words of w bits each with such that X′=Σₖ₌₀^{e-1} X′ⱼ2^{jw} with X′ⱼ=X′[jw+w−1: jw] for 0≤j≤e−1) such that the PEs compute their first group of intermediate results by repeatedly calculating the product of X′ⱼYᵢ for different i and j indices, thereby, enabling design of PEs that are independent of value of N, and producing a scalable Montgomery modular multiplier circuit. In a refinement, the data initiation latency is 1 cycle and the Montgomery modular multiplier circuit is scalable. In another refinement, the post-processing processing element 16 repeatedly receives intermediate results of the last two PEs and producing the partial output value Z. In a refinement, the processing elements are designed into a pipeline with L stages where the data initiation latency is L cycle.

With reference to FIG. 1d, an encoder circuit is provided. The endocoder 30 calculates (t+1)-bit outputs â and \hat{b} from t-bit inputs a and b, wherein t≥3. The encoder circuit ensuring that v_{â}+v_{\hat{b}}=a+b where v_{â}=[t]2^{t}−â[t−1]2^{t-1}+Σᵢ₌₀^{t-1} â[i]2ⁱ and v_{\hat{b}}=\hat{b}[t]2^{t}−\hat{b}[t−1] 2^{t-1}+Σᵢ₌₀^{t-1} \hat{b}[i] 2ⁱ. The encoder includes at least one digital processing component 32 configured to:

a) calculate a 3-bit intermediate result d as d[2: 0]=a[t−1: t−2]+b[t−1: t−2]+(a[t−3]ANDb[t−3]);

b) if t≥4, calculate â[t−4: 0]=a[t−4: 0] and \hat{b}[t−4: 0]=b[t−4: 0];

c) calculate â[t−3]=a[t−3]XORb[t−3]; â[t−2]=d[0]; â[t−1]=d[1]; â[t]=d[2]; and

d) calculate \hat{b}[t−1: t−3]=0; \hat{b}[t]=d[1].

In a refinement, v_{â[t-1:0]}+v_{\hat{b}[t-1:0]} is congruent to a+bmod2^{t} with v_{â[t-1:0]}=−â[t−1]2^{t-1}+Σᵢ₌₀^{t-1} â[i]2ⁱ and v_{\hat{b}[t-1:0]}=−\hat{b}[t−1]2^{t-1}+Σᵢ₌₀^{t-1} \hat{b}[i]2ⁱ.

In a variation, encoder 30 calculates 3-bit outputs â and \hat{b} from 2-bit inputs a and b, wherein the encoder circuit ensures that v_{â}+v_{\hat{b}}=a+b with v_{â}=4â[2]−2â[1]+â[0] and v_{\hat{b}}=4\hat{b}[2]−2\hat{b}[1]+\hat{b}[0]. The encoder includes at least one digital processing component 32 configured to calculate a 3-bit intermediate result d as d[2: 0]=a+b; calculate â=d; and calculate \hat{b}[1: 0]=0; \hat{b}[2]=d[1], In a variation, v_{â[1:0]}+v_{\hat{b} [1:0]} is congruent to a+bmod4 with v_{â[1:0]}=−2â[1]+â[0] and v_{\hat{b}[1:0]}=−2\hat{b}[1]+\hat{b}[0].

With reference to FIG. 1e, an encoder circuit is provided. The encoder 34 calculates 1-bit outputs cₒᵤₜ and e and a 2-bit output d from 2-bit inputs a and b, and 1-bit input cᵢₙ. The encoder circuit ensures that 4cₒᵤₜ+4e−2d[1]+d[0]=a+b+cᵢₙ. The encoder 34 includes at least one digital processing component 36 configured to calculate a 2-bit value as 2c[1]+d[0]=a[0]+b[0]+cᵢₙ; calculate cₒᵤₜ=a[1]ANDb[1]; calculate d[1]=a[1]XORb[1]XORc[1]; and calculate e=a[1]XORb[1]ORc[1].

With reference to FIG. 1f, encoder circuit 38 calculates (t+1)-bit outputs ã and \tilde{b} from t-bit inputs a and b and 1-bit input c, where t≥2. The encoder circuit ensuring that v_{ã}+v_{\tilde{b}}=a+b+c where v_{ã}=Σᵢ₌₀^{t/2} ã[2i]2²ⁱ−Σᵢ₌₀^{t/2-1} ã[2i+1]2²ⁱ⁺¹ and v_{\tilde{b}}=Σᵢ₌₀^{t/2} \tilde{b}[2i]2²ⁱ−Σᵢ₌₀^{t/2-1} \tilde{b}[2i+1]2²ⁱ⁺¹. The encoder includes one digital processing component 40 configured to:

a) encode a[1: 0], b[1: 0], and c to generate outputs cₒᵤₜ⁽⁰⁾, d⁽⁰⁾, and e⁽⁰⁾;

c) encode a[2i+1: 2i], b[2i+1: 2i], and cₒᵤₜ⁽ⁱ⁻¹⁾ to generate outputs cₒᵤₜ⁽ⁱ⁾, d⁽ⁱ⁾, and e⁽ⁱ⁾ for 0<i≤t/2−1;

d) calculate ã[2i+1: 2i]=d⁽ⁱ⁾ for 0≤i≤t/2−1; ã[t]=cₒᵤₜ^{(t/2-1)}; and

e) calculate \tilde{b}[2i+2]=e⁽ⁱ⁾ for 0≤i≤t/2−1. In a refinement, if parameter t is odd, inputs a and b are padded by one 0 on the left. In another refinement, v_{ã[t-1:0]}+v_{\tilde{b}[t-1:0]} is congruent to a+bmod2^{t} with v_{ã[t-1:0]}=Σᵢ₌₀^{t/2-1} ã[2i]2²ⁱ−Σᵢ₌₀^{t/2-1} ã[2i+1]2²ⁱ⁺¹ and v_{\tilde{b}[t-1:0]}=Σᵢ₌₀^{t/2-1} \tilde{b}[2i]2²ⁱ−Σᵢ₌₀^{t/2-1} \tilde{b}[2i+1]2²ⁱ⁺¹.

In a refinement of the variation set forth above v_{ã}+v_{\tilde{b}}−c is equal to v_{â}+v_{\hat{b}}.

In a refinement of the variation set forth above, v_{ã[t-1:0]}+v_{\tilde{b}[t-1:0]}−c is equal to v_{â[t-1:0]}+v_{\hat{b}[t-1:0]}.

Additional details of the invention are set forth below.

1. Design of a Scalable Montgomery Modular Multiplier Circuit

1.1 Fixed-Precision Optimization

Depending on the value of m, the high-radix Montgomery MM falls into one of two categories: (i) using explicit and expensive multiplication units when m is large, and (ii) replacing the explicit multiplications with simplified logic expressions when m is small. When m is large, e.g., m=16, prior art references have mainly focused on optimizing the MM time latency (product of cycle latency and clock period) and hardware cost (chip area) when they have two multiplication units [13, 24] or more than two multiplication units [16]. Considering area and delay, the bitwidth of the multiplication units cannot be made very large and are commonly chosen as 16 bits to maintain a good area-latency trade-off. When m is small, e.g., m=2, the multiplication unit can be explicitly simplified, for example by using modified Booth coding to reduce partial products. It would be desirable to develop a parametric high-radix (fixed-precision or scalable) Montgomery MM to support arbitrary m.

1.1.1 Operation Rescheduling

The value of Z is updated twice in each iteration of realization 2, which in turn necessitates separate hardware resources and increases the data dependence. Fortunately, the FPR2tm realization can be rescheduled to address this shortcoming. More precisely, the accumulation of XYᵢ₊₁ into Z⁽ⁱ⁺¹⁾ in the (i+1)-st iteration can be moved to the i-th iteration. Consequently, we can compute q⁽ⁱ⁾M and XYᵢr in parallel and accumulate them into Z⁽ⁱ⁾.

Algorithm 5 is a modified version of the FPR2tm realization incorporating the rescheduling technique, where d is the number of iterations.

```
Realization 5 Modified FPR2tm version 1
Input: X, Y ∈ [0, 2M), odd M < 2^{N}, r = 2^{m}, d =
    $⌈ \frac{N + m + 2}{m} ⌉ , R = {r}^{d - 1} , {rr}^{- 1} - {MM}^{′} = 1$
Output: Z ∈ [0, 2M)
  1: Z⁽⁻¹⁾ = 0
  2: for i = 0 to d − 1 do
  3:  q⁽ⁱ⁾ = (Z⁽ⁱ⁻¹⁾ mod r)M′ mod r
  4:  Z⁽ⁱ⁾ = (Z⁽ⁱ⁻¹⁾ + q⁽ⁱ⁾M + XY, r)/r
  5: end for
  6: Z = Z^{(d-1)}
  7: return Z
```

The value of d influences the upper bound of output Z. Indeed, we must find the minimum value of d to guarantee that the output Z lies in [0,2M) as explained next. Based on the equation in line 4 of the algorithm 5.1.1, we may explicitly compute Z⁽ⁱ⁾ in terms of X, M, r, Y₁, . . . , Yᵢ, q⁽¹⁾, . . . , q⁽ⁱ⁾, by recursively unfolding the Z⁽ⁱ⁾ until Z⁽⁻¹⁾=0 in (12). Note that q⁽⁰⁾ is 0.

$${Z}^{( i )} r = {Z}^{( i - 1 )} + {q}^{( i )} M + {XY}_{i} r \qquad ( 12 )$$

$${Z}^{( i )} {r}^{2} = {Z}^{( i - 1 )} r + {q}^{( i )} Mr + {XY}_{i} {r}^{2} = {q}^{( i )} Mr + {XY}_{i} {r}^{2} + {q}^{( i - 1 )} M + {XY}_{i - 1} r$$

$$…$$

$${Z}^{( i )} {r}^{i + 1} = M {\sum }_{j = 0}^{i} {q}^{( i )} {r}^{j} + Xr {\sum }_{j = 0}^{i} {Y}_{j} {r}^{j} = Mr {\sum }_{j = 0}^{i - 1} {q}^{( j + 1 )} {r}^{j} + Xr {\sum }_{j = 0}^{i} {Y}_{j} {r}^{j}$$

In each iteration, we can scan m bits of the multiplier Y. When

$$i \geq ⌈ \frac{N + 1}{m} ⌉ ,$$

the multiplier Y is completely scanned, and we can find a tight upper bound of Z⁽ⁱ⁾ as follows:

$${Z}^{( i )} {r}^{i + 1} = Mr {\sum }_{j = 0}^{i - 1} {q}^{( j + 1 )} {r}^{j} + Xr {\sum }_{j = 0}^{i} {Y}_{j} {r}^{j} = Mr {\sum }_{j = 0}^{i - 1} {q}^{( j + 1 )} {r}^{j} + XYr < Mr ( r - 1 ) \frac{{r}^{i} - 1}{r - 1} + 4 {M}^{2} r < ( {r}^{i + 1} + 4 Mr ) M \qquad ( 13 )$$

$${Z}^{( i )} < ( 1 + \frac{4 Mr}{{r}^{i + 1}} ) M$$

Therefore, the upper bound of Z^{(d-1)} in the last iteration is

$${Z}^{( d - 1 )} < ( 1 + \frac{4 Mr}{{r}^{d}} ) M .$$

md≥N+m+2 (14)

Following the equation 14, 4Mr<2^{N+m+2}≤2^{md}=r^{d} so that we can guarantee that Z^{(d-1)}<2M. In other words, if

$$d \geq ⌈ \frac{N + m + 2}{m} ⌉ ,$$

the output Z will always lie in [0,2M) as required.

1.1.2 Intermediate Result Decomposition

During the computation of q⁽ⁱ⁾, we only need the m least significant bits of Z⁽ⁱ⁻¹⁾ because of the operation Z⁽ⁱ⁻¹⁾modr. When w≥2m, we can decompose Z into ZM and ZR as shown in (15) below. Since w−m≥m, we only need ZR (more precisely ZR₀) to compute q.

Z=Σᵢ₌₀ⁿ^{_{w}}⁻¹Zᵢ2^{wi}

Zᵢ=ZMᵢ+ZRᵢ

ZMᵢ=Zᵢ[w−1: w−m]·2^{w-m}

ZRᵢ=Zᵢ[w−m−1: 0]

Z=ZM+ZR

ZM=Σᵢ₌₀ⁿ^{_{w}}⁻¹ZMᵢ2^{wi}

ZR=Σᵢ₌₀ⁿ^{_{w}}⁻¹ZRᵢ2^{wi} (15)

This decomposition seems of little value for the FPR2tm algorithm. However, it is an important observation in order to support the MWR2tm algorithm. As shown in reference [25], the MWR2t1 realization achieves L=1 when w≥2 and m=1. This article generalizes the aforesaid result and proves that the MWR2tm realization can also achieve L=1 when w≥2m for m≥1. We describe how the word decomposition is incorporated into the FPR2tm algorithm. In the 0-th iteration of realization 5, we can decompose Z⁽⁻¹⁾ into ZM⁽⁻¹⁾ and ZR⁽⁻¹⁾. Since the w−m least significant bits of ZM⁽⁻¹⁾ are 0, we have Z⁽⁻¹⁾modr=ZR⁽⁻¹⁾modr, and therefore we only need to use ZR⁽⁻¹⁾ to compute q⁽⁰⁾.

$$\begin{matrix}{Z}^{( - 1 )} & = {ZM}^{( - 1 )} + {ZR}^{( - 1 )} \\ {q}^{( 0 )} & = ( {Z}^{- 1 )} mod r ) {M}^{′} mod r \\ & = ( {ZR}^{( - 1 )} mod r ) {M}^{′} mod r \\ {Z}^{( 0 )} & = ( {Z}^{- 1 )} + {q}^{( 0 )} M + {XY}_{0} r ) / r \\ & = ( {ZR}^{- 1} ) + {q}^{( 0 )} M + {ZY}_{0} r ) / r + {ZM}^{( - 1 )} / r\end{matrix} \qquad ( 16 )$$

We observe that ZM⁽⁻¹⁾/r is not necessary to the required computations in the 0-th iteration and can be moved to the next iteration. We define Z_{new}⁽⁰⁾ as (ZR⁽⁻¹⁾+q⁽⁰⁾M+XY₀r)/r and decompose Z_{new}⁽⁰⁾ into ZM_{new}⁽⁰⁾ and ZR_{new}⁽⁰⁾. Z⁽⁰⁾ may thus be rewritten as:

Z⁽⁰⁾=ZM_{new}⁽⁰⁾+ZR_{new}⁽⁰⁾+ZM⁽⁻¹⁾/r (17)

As before, ZM_{new}⁽⁰⁾ is not necessary to compute q⁽¹⁾, i.e.,

$$\begin{matrix}{q}^{( 1 )} & = ( ( {ZZ}_{new}^{( 0 )} + {ZM}^{( - 1 )} / r ) mod r ) {M}^{′} mod r \\ {Z}^{( 1 )} & = ( {Z}^{( 0 )} + {q}^{( 1 )} M + {XY}_{1} r ) / r \\ & = ( ( {ZR}_{new}^{( 0 )} + {ZM}^{( - 1 )} / r ) + {q}^{( 1 )} M + {ZY}_{1} r ) / r \\ & + {ZM}_{new}^{( 0 )} / r\end{matrix} \qquad ( 18 )$$

Again, ZM_{new}⁽⁰⁾/r is not necessary to the required computations in the 1-st iteration and can be moved to the second iteration. Since Z⁽⁻¹⁾=0, we can define ZM_{new}⁽⁻¹⁾=ZM⁽⁻¹⁾=0 and ZR_{new}⁽⁻¹⁾=ZR⁽⁻¹⁾=0. Now then, for an arbitrary iteration i, we define Z_{new}⁽ⁱ⁺¹⁾ as (ZR_{new}⁽ⁱ⁾+(i+1) (i+1) (i+1) ZM_{new}⁽ⁱ⁻¹⁾/r+q⁽ⁱ⁺¹⁾M+XYᵢ₊₁)/r and decompose the new Z_{new}⁽ⁱ⁺¹⁾ into ZM_{new}⁽ⁱ⁺¹⁾ and ZR_{new}⁽ⁱ⁺¹⁾.

Realization 6 is a modified version of the FPR2tm realization incorporating rescheduling and decomposition techniques. Note that the decomposition is quite easy to do in hardware.

```
Realization 6 Modified FPR2tm version 2
Input: X, Y ∈ [0, 2M), odd M < 2^{N}, r = 2^{m}, d =
    $⌈ \frac{N + m + 2}{m} ⌉ , R = {r}^{d - 1} , {rr}^{- 1} - {MM}^{′} = 1$
Output: Z ∈ [0, 2M)
  1: ZM⁽⁻²⁾ = 0, ZM⁽⁻¹⁾ = 0, ZR⁽⁻¹⁾ = 0
  2: for i = 0 to d − 1 do
  3:  q⁽ⁱ⁾ = ((ZM⁽ⁱ⁻²⁾/r + ZR⁽ⁱ⁻¹⁾) mod r)M′ mod r
  4:  Z⁽ⁱ⁾ = ZM⁽ⁱ⁻²⁾/r + ZR⁽ⁱ⁻¹⁾ + q⁽ⁱ⁾M + XYᵢr
  5:  (ZM⁽ⁱ⁾, ZR⁽ⁱ⁾) = Decompose (Z⁽ⁱ⁾/r)
  6: end for
  7: Z = ZM^{(d-2)}/r + ZM^{(d-1)} + ZR^{(d-1)}
  8: return Z
```

1.1.3 Elimination of Multiplication Operations

Even after rescheduling the original realization to remove some data dependencies, the performance of the FPR2tm realization continues to be limited by multiplications. Implementation of a multiplication operation involves generating partial products and summing them together. The timing critical paths of this operation are the carry chains for the addition of partial products. We can use a ternary tree arrangement of CSAs to speed up the compression. Meanwhile, if we use the carry-save form to pass partial results from one iteration to next and only deploy the addition at the end of the algorithm, the performance will improve further.

Instead of using Z⁽ⁱ⁾, we can use the carry-save form ZS⁽ⁱ⁾ and ZC⁽ⁱ⁾ in line 4 of realization 6 and eliminate the final addition as detailed below.

Z⁽ⁱ⁾=ZS⁽ⁱ⁾+ZC⁽ⁱ⁾ (19)

Each of ZS⁽ⁱ⁾ and ZC⁽ⁱ⁾ consists of two parts:

ZS⁽ⁱ⁾=(ZS⁽ⁱ⁾>>m)r+ZS⁽ⁱ⁾mod r

ZC⁽ⁱ⁾=(ZC⁽ⁱ⁾>>m)r+ZC⁽ⁱ⁾mod r (2)

where ZS⁽ⁱ⁾>>m=└ZS⁽ⁱ⁾/r┘, meaning that we right shift by m bits and thus ignore the least m significant bits of ZS⁽ⁱ⁾. As a result, Z⁽ⁱ⁾/r can be rewritten as:

$$\begin{matrix}\frac{{Z}^{( i )}}{r} & = ( {ZS}^{( i )} >> m ) + ( {ZC}^{( i )} >> m ) \\ & + \frac{{ZS}^{( i )} mod r + {ZC}^{( i )} mod r}{r}\end{matrix} \qquad ( 21 )$$

Based on the modular definition, we have

0≤ZS⁽ⁱ⁾mod r<r,0≤ZC⁽ⁱ⁾mod r<r (22)

Since Z⁽ⁱ⁾ is a multiple of r, (ZS⁽ⁱ⁾modr+ZC⁽ⁱ⁾modr) can only be either 0 or r. When ZC⁽ⁱ⁾modr=0, we have to choose ZS⁽ⁱ⁾modr=0 since ZS⁽ⁱ⁾modr cannot be r. When ZC⁽ⁱ⁾modr≠0, we have to choose ZS⁽ⁱ⁾modr=r−ZC⁽ⁱ⁾modr≠0 since ZC⁽ⁱ⁾modr cannot be negative. We may define the indicator c⁽ⁱ⁾ to represent the (ZS⁽ⁱ⁾modr+ZC⁽ⁱ⁾modr)/r as follows (Notice that it is also correct to use ZS⁽ⁱ⁾modr to define c⁽ⁱ⁾). An indicator 1(x)=1 when the condition x is true and 0 otherwise.

$$\begin{matrix}{c}^{( i )} = ( \begin{matrix}1 & if {ZC}^{( i ( )} mod r \neq 0 \\ 0 & otherwise\end{matrix} \\ = 1 ( {ZC}^{( i )} mod r \neq 0 )\end{matrix} \qquad ( 23 )$$

In summary, Z⁽ⁱ⁾/r in line 5 of realization 6 may be replaced by the summation of ZS⁽ⁱ⁾>>m, ZC⁽ⁱ⁾>>m, and c⁽ⁱ⁾. Moreover, ZS⁽ⁱ⁾>>m and ZC⁽ⁱ⁾>>m can be decomposed into (ZSM⁽ⁱ⁾, ZSR⁽ⁱ⁾) and (ZCM⁽ⁱ⁾, ZCR⁽ⁱ⁾), respectively, and c⁽ⁱ⁾ moved forward to the next iteration.

Realization 7 is a modified version of the FPR2tm realization utilizing operation rescheduling, word decomposition, and CSA compression. Each iteration now consists of three compressions and one addition instead of three multiplications as was the case in realization 2. The first compression in line 5 compresses the 5-operand addition into 2 (temporary) integers (TS⁽ⁱ⁾, TC⁽ⁱ⁾). Next, the required computation q⁽ⁱ⁾=(TS⁽ⁱ⁾+TC⁽ⁱ⁾modr)M′ modr is performed into two steps: a compression and an addition. In particular, a second compression in line 6 takes O(log m) units of delay to compress the 2m-operand addition into 2 integers (qS⁽ⁱ⁾, qC⁽ⁱ⁾. Notice that products (TS⁽ⁱ⁾modr)M′ and (TC⁽ⁱ⁾modr)M′, each produce m partial product terms that need to be added together. The m least significant bits of qS⁽ⁱ⁾ and qC⁽ⁱ⁾ are summed up in line 7, where the sum is generated by a logarithmic carry propagate adder (CPA), like the Kogge-Stone adder (KSA), requiring O(log m) levels of logic. Finally, the third compression in line 8 compresses the (2m+2)-operand addition into 2 integers (ZS⁽ⁱ⁾, ZC⁽ⁱ⁾). Notice that multiplication with r=2^{m} is simply done by left shifting the operand and that the products q⁽ⁱ⁾M and XYᵢr, each produce m partial product terms which must be summed together with TS⁽ⁱ⁾ and TC⁽ⁱ⁾.

```
Realization 7 Modified FPR2tm version 3
Input: X, Y ∈ [0, 2M), odd M < 2^{N}, r = 2^{m}, d =
    $⌈ \frac{N + m + 2}{m} ⌉ , R = {r}^{d - 1} , {rr}^{- 1} - {MM}^{′} = 1$
Output: Z ∈ [0, 2M)
  1: ZSM⁽⁻²⁾ = 0, ZSM⁽⁻¹⁾ = 0, ZSR⁽⁻¹⁾ = 0
  2: ZCM⁽⁻²⁾ = 0, ZCM⁽⁻¹⁾ = 0, ZCR⁽⁻¹⁾ = 0
  3: c⁽⁻¹⁾ = 0
  4: for i = 0 to d − 1 do
  5:  (TS⁽ⁱ⁾, TC⁽ⁱ⁾) = Compress(ZSM⁽ⁱ⁻²⁾/r +
      ZCM⁽ⁱ⁻²⁾/r + ZSR⁽ⁱ⁻¹⁾ + ZCR⁽ⁱ⁻¹⁾ + c⁽ⁱ⁻¹⁾)
  6:  (qS⁽ⁱ⁾, qC⁽ⁱ⁾) = Compress((TS⁽ⁱ⁾ mod r)M′ +
      (TC⁽ⁱ⁾ mod r)M′)
  7:  q⁽ⁱ⁾ = (qS⁽ⁱ⁾ + qC⁽ⁱ⁾) mod r
  8:  (ZS⁽ⁱ⁾, ZC⁽ⁱ⁾) = Compress(TS⁽ⁱ⁾ + TC⁽ⁱ⁾ + q⁽ⁱ⁾M + XYᵢr)
  9:  c⁽ⁱ⁾ = 1(ZC⁽ⁱ⁾ mod r ≠ 0)
  10:  (ZSM⁽ⁱ⁾, ZSR⁽ⁱ⁾) = Decompose(ZS⁽ⁱ⁾ >> m)
  11:  (ZCM⁽ⁱ⁾, ZCR⁽ⁱ⁾) = Decompose(ZC⁽ⁱ⁾ >> m)
  12: end for
  13: Z = ZSM^{(d-2)}/r + ZSM^{(d-1)} + ZSR^{(d-1)} +
    ZCM^{(d-2)}/r + ZCM^{(d-1)} + ZCR^{(d-1)} + c^{(d-1)}
  14: return Z
```

1.1.4 Booth Coding

Because of the modular property to compute q⁽ⁱ⁾=(qS⁽ⁱ⁾+qC⁽ⁱ⁾)modr, q⁽ⁱ⁾ is not always identical to use qS⁽ⁱ⁾modr and qC⁽ⁱ⁾modr unless the sum of them is always less than r. Although it is possible to replace q⁽ⁱ⁾ with qS⁽ⁱ⁾modr and qC⁽ⁱ⁾modr, the resulting (qS⁽ⁱ⁾modr)M and (qC⁽ⁱ⁾modr)M would cause double area compared with q⁽ⁱ⁾M. Instead, we choose to complete the modular addition q⁽ⁱ⁾=(qS⁽ⁱ⁾+qC⁽ⁱ⁾)modr. Consequently, we can use radix-4 modified Booth coding to reduce the number of partial products for each multiplication performed in line 6 of realization 5.1.3 from 2m to m+2. Subsequently, we save m−2 CSAs and also reduce the delay. Modified Booth coding is not compatible with the carry-save form because it can achieve the correct result only after the final addition and ignore potential overflows. This is why we do not use Booth coding to improve the third compression in line 8 of realization 7.

1.2 Radix-2^{m} Scalable Montgomery Design

To extend the fixed-precision realization 7 to a scalable one (see realization 8 below), we need to iteratively compute w bits of intermediate results in realization 7 (see line 8). Moreover, we must find the maximum values of the intermediate results in order to derive e in terms of m. Equation (12) provides a way to compute the intermediate result Z⁽ⁱ⁾ as shown next.

$$\begin{matrix}{Z}^{( i )} {r}^{( i + 1 )} & = Mr {\sum }_{j = 0}^{i - 1} {q}^{( j + 1 )} {r}^{j} + Xr {\sum }_{j = 0}^{i} {Y}_{j} {r}^{j} \\ & \leq Mr ( r - 1 ) {\sum }_{j = 0}^{i - 1} {r}^{j} + Xr ( r - 1 ) {\sum }_{j = 0}^{i} {r}^{j} \\ & = Mr ( r - 1 ) \frac{{r}^{i} - 1}{r - 1} + Xr ( r - 1 ) \frac{{r}^{i + 1} - 1}{r - 1} \\ & < ( M + Zr ) {r}^{i + 1} \\ {Z}^{( i )} & < M + Xr < ( 2 r + 1 ) < {2}^{N + m + 2}\end{matrix} \qquad ( 24 )$$

Equation (24) shows that the maximum possible value of intermediate result Z⁽ⁱ⁾ is always less than 2^{N+m+2} so that it can be presented in N+m+2 bits. Note that lines 10 and 11 of the realization 7 performs a division by r using a right shift by m bits. The maximum possible value of the intermediate result is the value just before the division, which can be presented in N+2m+2 bits. Therefore, minimum value of e can be set as

$$e = ⌈ \frac{N + 2 m + 2}{w} ⌉ .$$

Notice that that w≥2m, utilizing the triangle inequality

$$e = ⌈ \frac{N + 2 m + 2}{w} ⌉ \leq ⌈ \frac{N + 2}{w} ⌉ + 1 ,$$

we can derive a somewhat pessimistic lower bound on e which is

$$e = ⌈ \frac{N + 2}{w} ⌉ + 1$$

as was done for realization 4.

Partial results ZSR⁽ⁱ⁻¹⁾ and ZCR⁽ⁱ⁻¹⁾ in the i-th iteration of realization 7 may be explicitly represented as in equation (25), where the most m significant bits of ZSRⱼ⁽ⁱ⁻¹⁾ and ZCRⱼ⁽ⁱ⁻¹⁾ are 0.

ZSR⁽ⁱ⁻¹⁾=Σⱼ₌₀^{e-1}ZSRⱼ⁽ⁱ⁻¹⁾2^{wj}

ZCR⁽ⁱ⁻¹⁾=Σⱼ₌₀^{e-1}ZCRⱼ⁽ⁱ⁻¹⁾2^{wj} (25)

Similarly, partial results ZSM⁽ⁱ⁻²⁾/r and ZCM⁽ⁱ⁻²⁾/r may explicitly be represented as in equation (26), where again the least w−m significant bits of ZSMⱼ⁽ⁱ⁻²⁾ and ZCMⱼ⁽ⁱ⁻²⁾ are 0. Note that ZSM⁽ⁱ⁻²⁾ and ZCM⁽ⁱ⁻²⁾ are multiples of r=2^{m} because w−m≥m.

ZSM⁽ⁱ⁻²⁾/r=Σⱼ₌₀^{e-1}(ZSMⱼ⁽ⁱ⁻²⁾/r)2^{wj}

ZCM⁽ⁱ⁻²⁾/r=Σⱼ₌₀^{e-1}(ZCMⱼ⁽ⁱ⁻²⁾/r)2^{wj} (26)

Consequently, line 5 of realization 7 may be rewritten as:

$$\begin{matrix}{\sum }_{j = 0}^{e - 1} ( {ZSM}_{j}^{( i - 2 )} / r & + {ZCM}_{j}^{( i - 2 )} / r + {ZSR}_{j}^{( i - 1 )} \\ & + {ZCR}_{j}^{( i - 1 )} ) {2}^{wj} + {c}^{( i - 1 )} \\ & = {TS}^{( i )} + {TC}^{( i )}\end{matrix} \qquad ( 27 )$$

Moreover, because r=2^{m}, we have:

$$\begin{matrix}{q}^{( i )} & = ( ( {TS}^{( i )} mod r ) {M}^{′} + ( {TC}^{( i )} mod r ) {M}^{′} ) mod r \\ & = ( {ZSM}_{0}^{( i - 2 )} / r + {ZCM}_{0}^{( i - 2 )} / 2 + {ZSR}_{0}^{( i - 1 )} \\ & + {ZCR}_{0}^{( i - 1 )} + {c}^{( i - 1 )} ) {M}^{′} mod r\end{matrix} \qquad ( 28 )$$

Finally, X′Yᵢ=Xr·Yᵢ and q⁽ⁱ⁾M can also be represented explicitly as follows:

X′Yᵢ=Σⱼ₌₀^{e-1}X′ⱼYᵢ2^{wj},q⁽ⁱ⁾M=q⁽ⁱ⁾Mⱼ2^{wj} (29)

The expression TS⁽ⁱ⁾+TC⁽ⁱ⁾+q⁽ⁱ⁾M+XYᵢr in line 8 of realization 7 can thus be written as:

$$\begin{matrix}{TS}^{( i )} & + {TC}^{( i )} + {q}^{( i )} M + {XY}_{i} r \\ & = {\sum }_{j = 0}^{e - 1} ( {ZSM}_{j}^{( i - 2 )} / r + {ZCM}_{j}^{( i - 2 )} / r \\ & + {ZSR}_{j}^{( i - 1 )} + {ZCR}_{j}^{( i - 1 )} + {X}_{j}^{′} {Y}_{i} + {q}^{( i )} {M}_{j} ) {w}^{wj} \\ & + {c}^{( i - 1 )}\end{matrix} \qquad ( 30 )$$

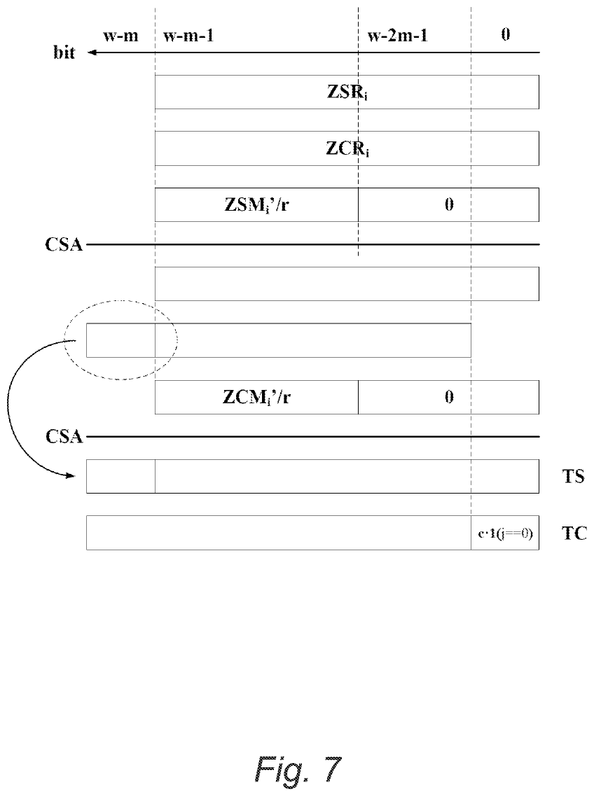

In the context of the MWR2tm realization where N is variable, when Yᵢ is provided in the i-th iteration, we need an inner loop to scan w bits of X′ and M in successive iterations. Consider any iteration i of the outer loop. In the 0-th inner loop iteration (j=0), let us redefine intermediate results (TS, TC) as the compression of ZSR₀+ZCR₀+ZSM′₀/r+ZCM′₀/r+c·1(j==0), where ZSR₀⁽ⁱ⁻¹⁾ and ZCR₀⁽ⁱ⁻¹⁾ denote ZSR₀⁽ⁱ⁾ and ZCR₀⁽ⁱ⁾ in (current) iteration i whereas ZSM′₀ and ZCM′₀, denote ZSM₀⁽ⁱ⁻¹⁾ and ZCM₀⁽ⁱ⁻¹⁾ in (previous) iteration i−1. We can guarantee that only TS and TC need w−m+1 bits as shown in FIG. 7. From equation (28), TS and TC contain necessary information to allow calculation of q in the 0-th inner loop iteration.

Next, we compress TS+TC+X′₀Yᵢ+qM₀ into intermediate results (OS, OC). Assume the bitwidths of OS and OC are w+x where x>0. The w least significant bits of OS and OC are actually ZS₀⁽ⁱ⁾ and ZC₀⁽ⁱ⁾ (parts of ZS⁽ⁱ⁾ and ZC⁽ⁱ⁾ in line 8 of realization 7), respectively. Consequently, we can compute c⁽ⁱ⁾, ZSR₀⁽ⁱ⁾, and ZCR₀⁽ⁱ⁾. The most x significant bits of OS and OC will affect the computation of ZSR₁⁽ⁱ⁾ and ZCR₁⁽ⁱ⁾ and so on. These are named as FBS and FBC and used in the next inner loop iteration. Similarly, when we get to the 1-st inner loop iteration (j=1), we can update (TS, TC) as the compression of ZSR₁+ZCR₁+ZSM′₁/r+ZCM′₁/r+c·1(j==0). Furthermore, we update (OS, OC) as the compression of TS+TC+X′₁Yᵢ+qM₁+FBS+FBC. As before, the w least significant bits of OS and OC are actually ZS₁⁽ⁱ⁾ and ZC₁⁽ⁱ⁾ such that we can partition and assign them to ZSM₀, ZCM₀, ZSR₁, and ZCR₁. FBS and FBC are still updated as the x most significant bits of OS and OC. The procedure can proceed until all e inner loop iterations are completed.

One important question is how to set the bitwidths of FBS and FBC to guarantee that the bitwidths of OS and OC are large enough to avoid overflows. In another word, assume FBS and FBC each have x bits, the sum of OS and OC must be precisely representable with w+x bits. Equation (31) captures the constraints.

$$\begin{matrix}( ( {2}^{w} - 1 ) ( {2}^{m} - 1 ) & + ( {2}^{w - m + 1} - 1 ) \\ & + ( {2}^{x} - 1 ) ) \times 2 < {2}^{w + x}\end{matrix} \qquad ( 31 )$$

One can easily prove the following result:

$$\frac{{2}^{2} - 1}{{2}^{w - 1} - 1} = \frac{2 ( {2}^{w - 1} - 1 ) + 1}{{2}^{w - 1} - 1} < 3 \\ \frac{{2}^{w - m + 1} - 2}{{2}^{w - 1} - 1} < 1 \qquad ( 32 )$$

Therefore, we can set x=m+2.

$$\begin{matrix}\frac{( {2}^{w} - 1 ) ( {2}^{m} - 1 ) + ( {2}^{w - m + 1} - 2 )}{{2}^{w - 1} - 1} & < 3 ( {2}^{m} - 1 ) + 1 \\ & < {2}^{m + 2} \leq {2}^{x}\end{matrix} \qquad ( 33 )$$

Based on realization 7, we describe a radix-2^{m} scalable Montgomery modular multiplication (MWR2tm) with an issue latency of L=1. Because the final result Z is in the range [0,2M), Z can also be represented in e words.

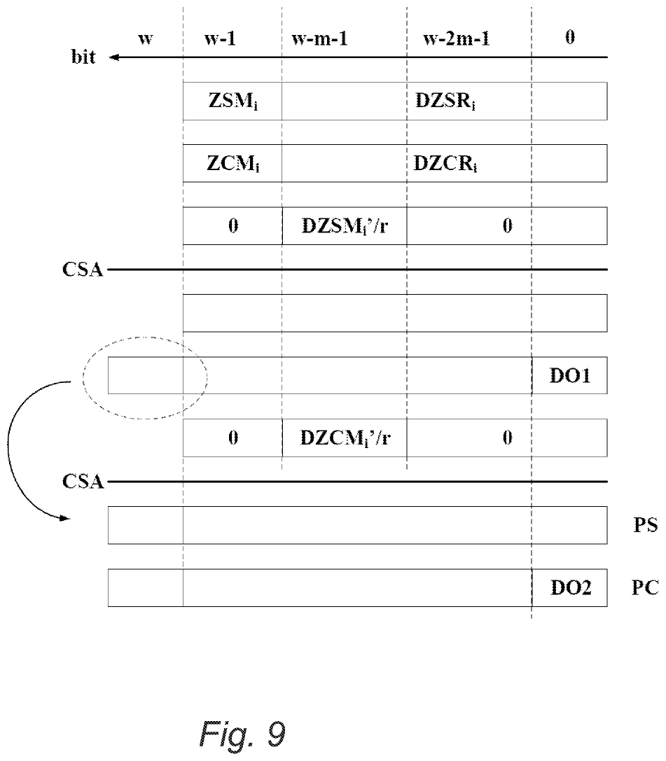

The last thing is to collect all carry-save form results together and compute the final Z=XYR⁻¹modM. Once we have computed ZSM₀, ZCM₀, ZSR₀, ZCR₀, ZSM′₀/r, ZCM′₀/r, we are able to compress their sum into two (w+1)-bit integers (PS, PC). The w least significant bits PS[w−1: 0] and PC[w−1: 0] cooperate with c (working as the carry-in bit) to compute the last word Z₀. The carry-out bit during the addition automatically works as carry-in in the next cycle. The two most significant bits are named as DO1 and DO2 to be added with ZSM₁, ZCM₁, ZSR₁, ZCR₁, ZSM′₁/r, and ZCM′₁/r. We thus compute Z₁ and update DO1 and DO2. The procedure continues until we collect all e words of Z. We can guarantee it suffices to use two 1-bit DO1 and DO2 in (34). Detail of the compression is in the FIG. 9.

$$\begin{matrix}( ( {2}^{m} - 1 ) \times {2}^{w - m} & + ( {2}^{w - m} - 1 ) \\ & + ( {2}^{m} - 1 ) \times {2}^{w - 2 m} ) \times 2 + 2 \\ & \leq 2 \times ( {2}^{w + 1} - 1 )\end{matrix} \qquad ( 34 )$$

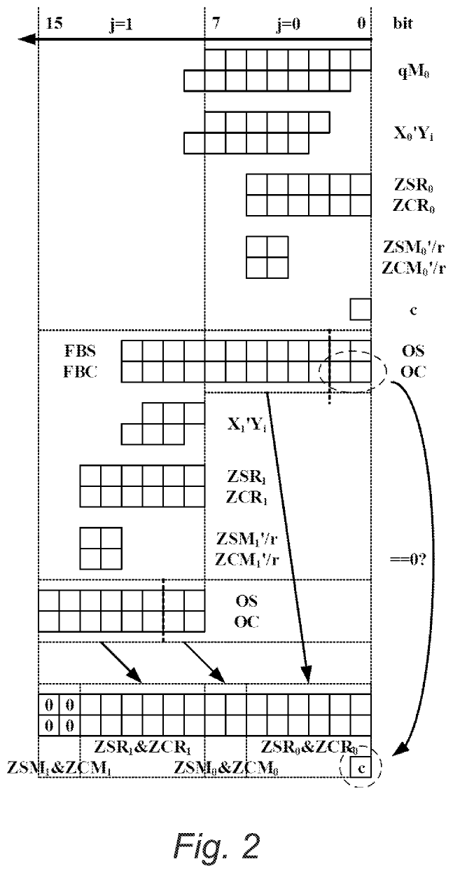

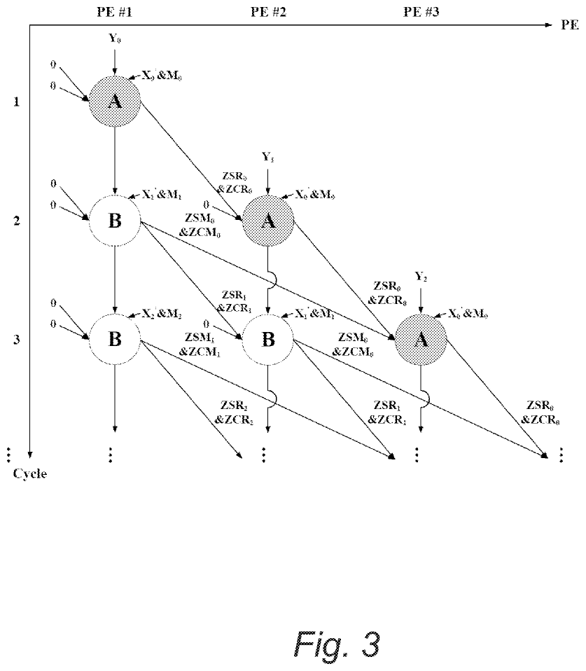

FIG. 2 shows an example of the i-th outer loop iteration when N=8, w=8, m=2, and

$$e = ⌈ \frac{N + 2 m + 2}{w} ⌉ = 2.$$

The modulus M has 8 bits so that M₁ are 0. Because X E [0,2M), X′=Xr has N+1+m=11 bits and the least m=2 significant bits are 0.

Realization 8 Inventive scalable radix-2^{m} Montgomery modular
multiplication (MWR2tm)

```
Input: X, Y ∈ [0, 2M), X′ = Xr, odd M < R = r^{kp-1},
    $r = {2}^{m} , {rr}^{- 1} - {MM}^{′} = 1 , w \geq 2 m , e = ⌈ \frac{N + 2 m + 2}{w} ⌉ ,$
    $k = ⌈ \frac{N + m + 2}{m p} ⌉ , p = PE count$
Output: Z ∈ [0, 2M)
  1: ZSM′ = 0, ZSM = 0, ZSR = 0
  2: ZCM′ = 0, ZCM = 0, ZCR = 0, c = 0
  3: for i = 0 to kp − 1 do {/ /outer loop}
  4:  FBS = FBC = 0
  5:  for j = 0 to e − 1 do {/ /inner loop}
  6:  (TS, TC) = Compress(ZSRⱼ + ZCRⱼ + ZSMⱼ′/r +
        ZCMⱼ′/r + c · 1(j = = 0))
  7:  if j = = 0 then
  8:  (qS, qC) = Compress(TS mod r)M′ + (TC mod r)M′)
  9:  q = (qS + qC) mod r
10:  end if
11:  (OS, OC) = Compress(TS + TC + Xⱼ′Yᵢ + qMⱼ + FBS +
        FBC)
12:  c = 1(OC[m − 1:0] ≠ 0 and j = = 0)
13:  ZSMⱼ₋₁ = ZSMⱼ₋₁
14:  ZCMⱼ₋₁ = ZCMⱼ₋₁
15:  ZSMⱼ₋₁ = OS[m − 1:0]2^{m-m}
16:  ZCMⱼ₋₁ = OC[m − 1:0]2^{m-m}
17:  ZSRⱼ = OS[w − 1:m]
18:  ZCRⱼ = OC[w − 1:m]
19:  FBS = OS[w + m + 1:w]
20:  FBC = OC[w + m + 1:w]
21:  end for
22:  ZSMₑ₋₁ = ZSM₋₁ = 0
23:  ZCMₑ₋₁ = ZCM₋₁ = 0
24: end for
25: DO1 = DO2 = 0
26: Carry = c
27: for i = 0 to e − 2 do
28:  (PS, PC) = Compress(ZSMᵢ + ZCMᵢ + ZSRᵢ +
      ZCRᵢ + ZSMᵢ′/r + ZCMᵢ′/r + DO1 + DO2)
29:  (Carry, Zᵢ) = PS[w − 1:0] + PC[w − 1:0] + Carry
30:  DO1 = PS[w], DO2 = PC[w]
31: end for
32: return Z
```

1.3. Scheduling and Performance Estimation

FIG. 2 shows the data dependency graph of realization 8. Node A denotes tasks of 0-th inner loop iteration for the MWR2tm algorithm. Node B denotes tasks of inner loop iteration when j≠0. Node C denotes the task in lines 25-31 of the MWR2tm algorithm. We can start the A task of PE i as soon as we finish the A task of PE i−1. The issue latency is thus L=1.

Each PE needs e cycles to execute one A task and (e−1) B tasks. Ideally, we need

$$p = ⌈ \frac{N + m + 2}{m} ⌉ PEs .$$

In the context of a scalable design, the bitwidth N of modulus M is variable such that we cannot know how many PEs are required in advance. As we mentioned earlier, after e cycles, a PE becomes free and may thus be reused. Assume p PEs are employed. Let k denote the number of rounds we use all p PEs, resulting in kp outer loop iterations in algorithm 5.2. From (14), it is easy to see that

$$k = ⌈ \frac{N + m + 2}{mp} ⌉$$

guarantees that output Z will lie in [0,2M) as required.

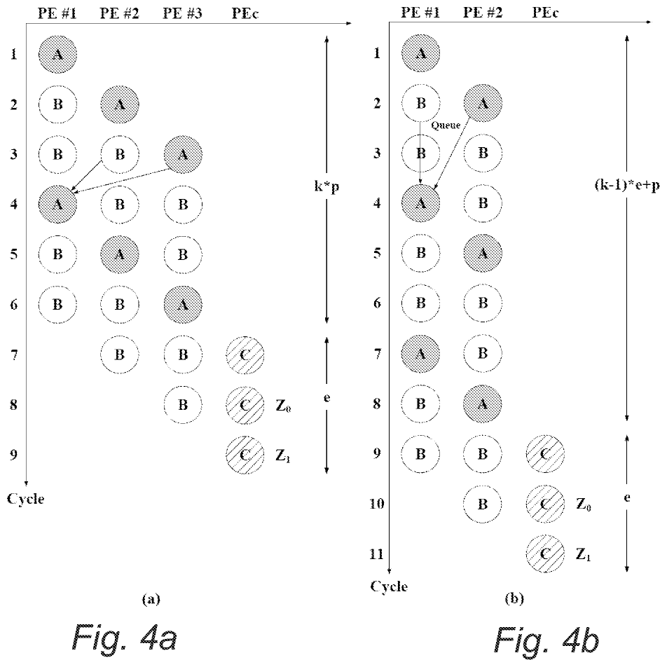

FIG. 4 shows an example when N=6, w=4, m=2, and e=3. When we have p=3 PEs (p≥e) in FIG. 4(a), we need k=2 rounds. PE 1 finishes the computation about Y₀ and becomes free when we need to issue Y₃. Therefore, we need kp cycles to finish all A tasks. When we only have 2 PEs (p<e) in FIG. 4(b), we need k=3 rounds. When we want to issue Y₂, PE 1 is still busy and we have to wait. Therefore, we need (k−1)e+p cycles to finish all A tasks. When all A tasks are done, we can start the C tasks and collect all carry-save form results, which needs e+1 cycles.

Based on the magnitude of p and e, the number of cycles required to perform Z=XYR⁻¹modM (where inputs X and Y and output Z are in [0,2M)) by using the MWR2tm realization is as follows:

$$\begin{matrix}cycle\_cnt = ( \begin{matrix}kp + e + 1 & ife \leq p \\ ke + p + 1 & otherwise\end{matrix} \\ where \\ r = {2}^{m} , p = PEcount , R = {r}^{kp - 1} = {2}^{m ( kp - 1 )} & ( 35 ) \\ e = ⌈ \frac{N + 2 m + 2}{w} ⌉ , k = ⌈ \frac{N + m + 2}{mp} ⌉ & ( 36 )\end{matrix}$$

A simpler (upper bound) equation for the cycle count is:

cycle_cnt≤k max(e,p)+min(e,p)+1 (37)

where

n_{w}=┌M/w┐

nₘ=┌N/m┐

e=n_{w}+2

k=┌(nₘ+2)/p┐ (38)

Note that we use radix-2^{w} for decomposing the multiplicand into e words of w bits each, and radix r=2^{m} for decomposing the multiplier.

To start a required iteration of realization 7 on a new PE, we must collect enough information to compute the least m significant bits of TS⁽ⁱ⁾ and TC⁽ⁱ⁾ in line 5 so as to compute q⁽ⁱ⁾. When w≥2m, after the first cycle, we finish the computation about the w−m least significant bits because we need to right shift by m bits. After the second cycle, we finish the computation about the 2w−m≥m least significant bits. The procedure goes on until all e inner loop iterations are done. So the issue latency is L=1.

Unfortunately, when m≤w<2m so that w−m<m, the MWR2tm realization cannot support an issue latency of L=1. Instead, we have 2w−m≥m and thus can only start computations on a new PE with an issue latency of 2 cycles. Generally speaking, the issue latency of realization 8 is L=┌(2m)/w┐. One may modify realization 8 and the corresponding data dependency graph to support various combination of w and m, some resulting in an issue latency of 1 cycle, others to an issue latency of 2 cycles or more.

Other optimization methods (such as increasing the cycle latency or increasing the circuit area as in [9, 10]) may be used to achieve L=1 even when m≤w<2m. In view of the above discussion, setting w≥2m provides the highest performance realization (i.e., realization 7) in terms of circuit area (hardware usage), cycle latency, and issue latency (L=1).

1.4. Hardware Implementation

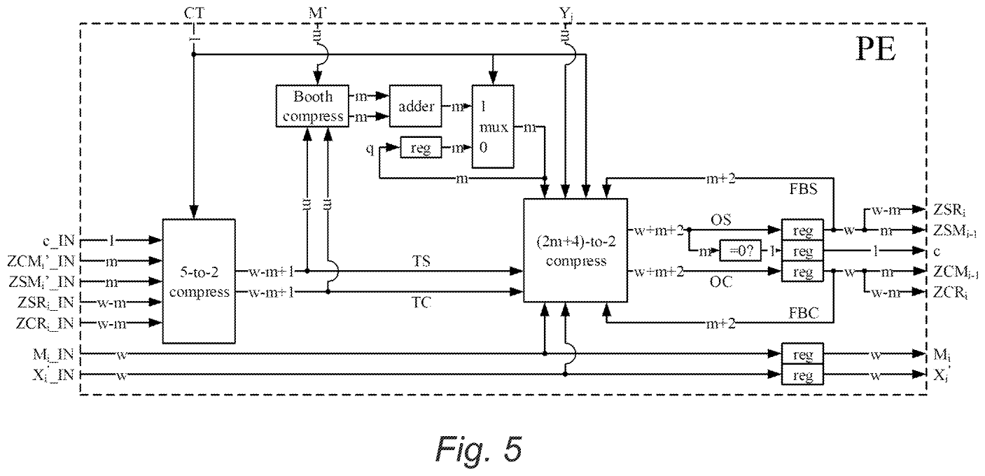

As we can observe, tasks A and B have many similarities and thus can be implemented in one PE by using a control signal CT as depicted in FIG. 5. In the A task (CT=1), the 5-to-2 compression handles variable c, the (2m+4)-to-2 compression masks inputs FBS and FBC to be 0 and forces the least m bits of outputs OS and OC to be 0, and finally q is calculated. In the B task (CT=0), the 5-to-2 compression masks c and thus forces it to be 0, the (2m+4)-to-2 compression accepts inputs FBS and FBC and generates OS and OC, and finally the stored value of q is used. Notice that ZSMᵢ, ZSRᵢ, etc. are represented by m bits, w−m bits, etc. instead of w bits, since the remaining bits are known to be zeros.

FIG. 7 shows the 5-to-2 compression of c·1(j==0), ZSM′ᵢ/r, ZCM′ᵢ/r, ZSRᵢ, and ZCRᵢ by using two (w−m)-bit CSAs. Recall that the w−2m least significant bits of ZSM′ᵢ/r are 0.

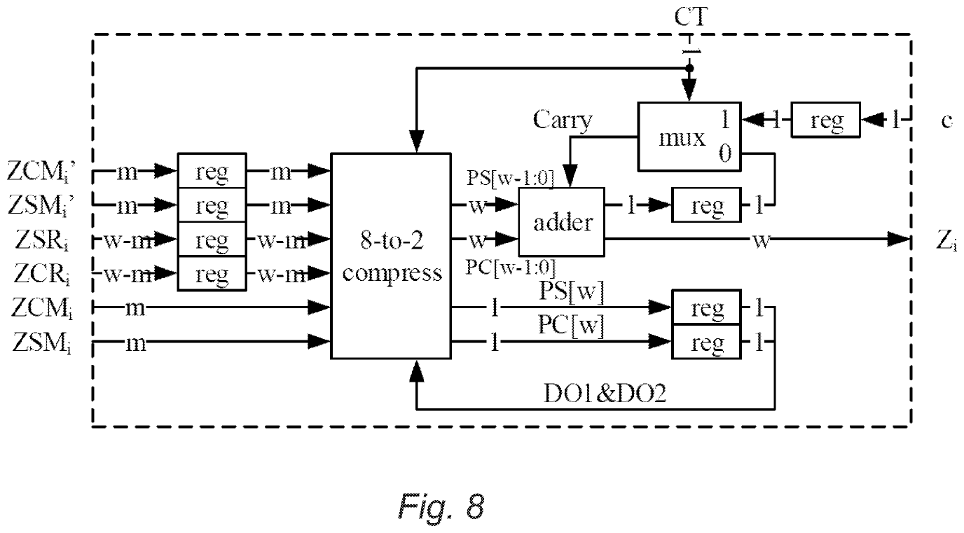

Unlike A and B tasks, the C task needs only one special processing element (named PEc). FIG. 8 shows the implementation of the PEc. When CT=1, we force feedback signals DO1 and DO2 to 0 and set carry signal as c. When CT=0, we accept feedback signals DO1 and DO2 and set carry signal as the carry-out bit from the previous cycle.

Although there are 8 integers, we can compress them by using two w-bit CSAs as in FIG. 9. DZSRᵢ stands for the delayed ZSRᵢ (it is delayed by one clock cycle). The main delay of the C task is thus a w-bit addition, where we can use a KSA with a gate delay of log(w) to speed up the computation.

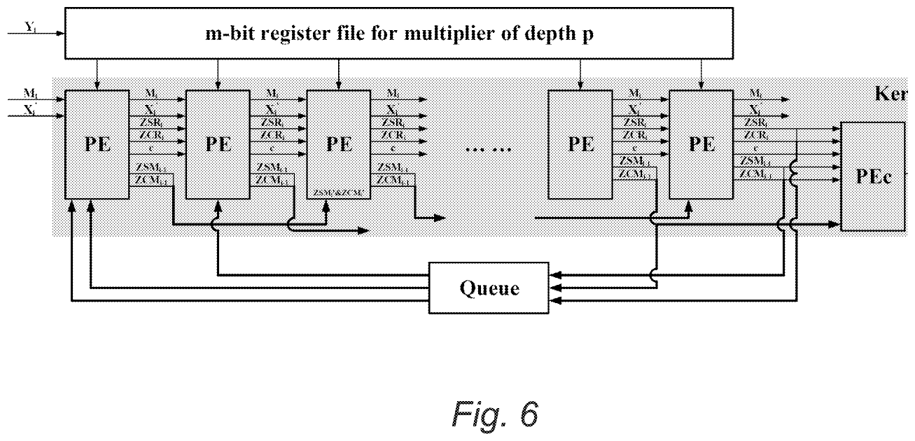

We show the block-level architecture of the proposed radix-2^{m} scalable Montgomery modular multiplication in FIG. 6. The required ZSM′ᵢ and ZCM′ᵢ in the i-th outer loop iteration in realization 8 are actually ZSMᵢ and ZCMᵢ which are generated in the (i−2)-nd outer loop iteration. Similarly, ZSM′ᵢ and ZCM′ᵢ required in the PEc are ZSMᵢ and ZCMᵢ generated by the next to the last PE. To compute Zᵢ, we need ZSM′ᵢ, ZCM′ᵢ, ZSMᵢ, ZCMᵢ, ZSRᵢ, ZCRᵢ, and c. However, they are not generated in the same cycle. More precisely, ZSMᵢ and ZCMᵢ are generated in the (i+1)-st inner loop iteration whereas ZSM′ᵢ, ZCM′ᵢ, ZSRᵢ, ZCRᵢ, and c are generated in the i-th inner loop iteration and need to be delayed by one clock cycle as shown in FIG. 8. When p<e as in FIG. 4(b), a first-in first-out queue with a depth of e−p slots is necessary to buffer the outputs.

1.5. Hardware Emulation Results

1.5.1 Analysis of Area and Time

The MWR2tm realization was coded in the Verilog hardware description language and implemented using the Xilinx Vivado Virtex 7 xc7v585tffg1157-3. Given a chip area constraint and the word size m of multiplier, there are many possible kernel configurations with the number p of PEs and the word size w of multiplicand for a designer-specified bitwidth N of the modulus M.

The number of cycles is a function of e and p as shown in equation (35). When e≤p, the cycle count is kp+e+1. A PE becomes free before we issue another word of the multiplier, meaning that we have instantiated too many PEs. The reduction of p can improve resource utilization until p=e. Note also that the change of p does not affect cycle count since kp is roughly a constant. When e>p, the cycle count is ke+p+1. A PE is still busy when we want to issue another word, so we have to wait for PEs to become available. Increasing p causes k to be reduced and thus lowers the cycle count until p becomes equal to e. Therefore, for a designer-specified bitwidth N of the modulus M, the optimum value of p is e.

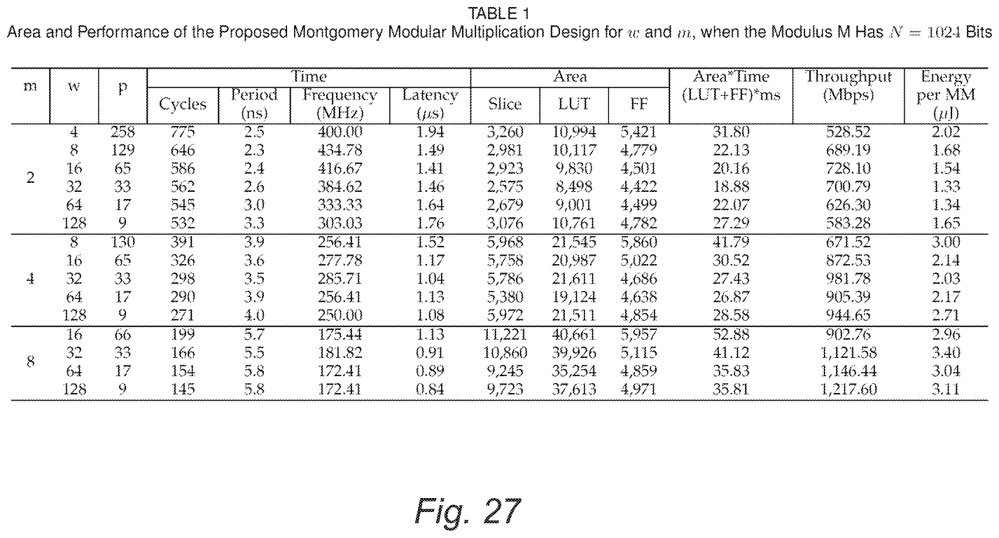

Table 1 presents our implementations for different w and m combinations. (see, FIG. 27) As we discussed, the optimum p is

$$e = ⌈ \frac{N + 2 m + 2}{w} ⌉ ,$$

which is almost independent of m when w≥2m, and thus, decreases with the increase of w. Meanwhile, increasing w means that a PE is more complex, and hence, it will require more LUTs to do the required compressions and addition. Consequently, different implementations of the Montgomery MM with a fixed m have nearly the same area (in terms of the number of LUTs they need). The clock period of the kernel in FIG. 6. is bounded by the critical paths in both the PEs and the PEc. By increasing w, more computations are implemented as purely combinational logic, and thus the area decreases. However, when w becomes too large, the latency of the KSA addition in the PEc dominates the clock period such that the Montgomery MM time latency increases whereas the cycle latency is somewhat reduced. The placement and routing inside a PE also become more complex and require more area. Based on the product of area and time, the configurations (32,2), (64,4), and (128,8) for (w, m) achieve the best trade-off. When we run multivariate linear regression, we can estimate the area (LUT+FF) to scale as follows:

LUT_count=4.34wmp+6107 (39)

In the context of a scalable Montgomery MM design, N is a designer-specified variable, and therefore, we cannot optimize the architecture for a given N a priori. Instead, we presume an N value under constraints on the time latency and area. Choices of w, m, and p determine the latency and area for a presumed N as shown in table 1.

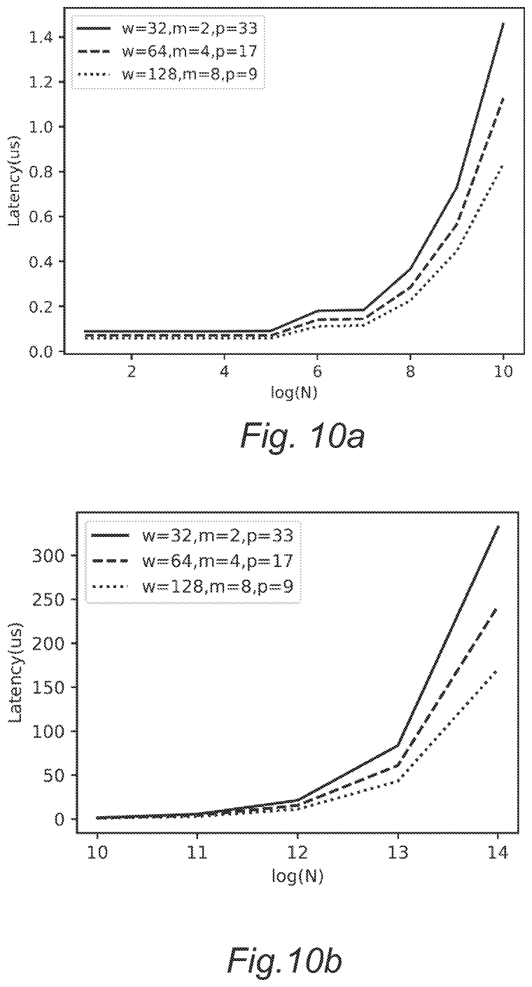

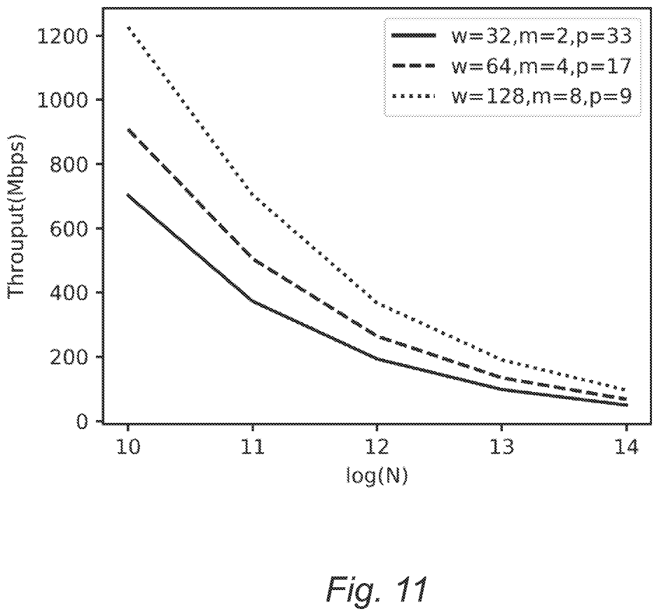

FIG. 10 shows the time latency of three scalable Montgomery modular multiplications with a presumed value of N=1,024. When the actual (designer-specified) N is less than or equal to 1,024, the difference of time latency is small as shown in FIG. 10(a). However, when the actual N is larger than 1,024 where e>p, a PE is still busy when we want to issue another word of the multiplier such that we have to wait. FIG. 10(b) shows the curve of time latency when N>1,024. When m increases, the slope decreases. Consequently, for actual N=16,384, the time latency of the configuration w=128, m=8, and p=9 is only 170.64 μs whereas the configuration w=32, m=2, and p=33 results in 332.2 μs time latency. FIG. 11 shows the corresponding throughput of the same configurations for the presumed N=1,024.

1.5.2 Performance Comparison

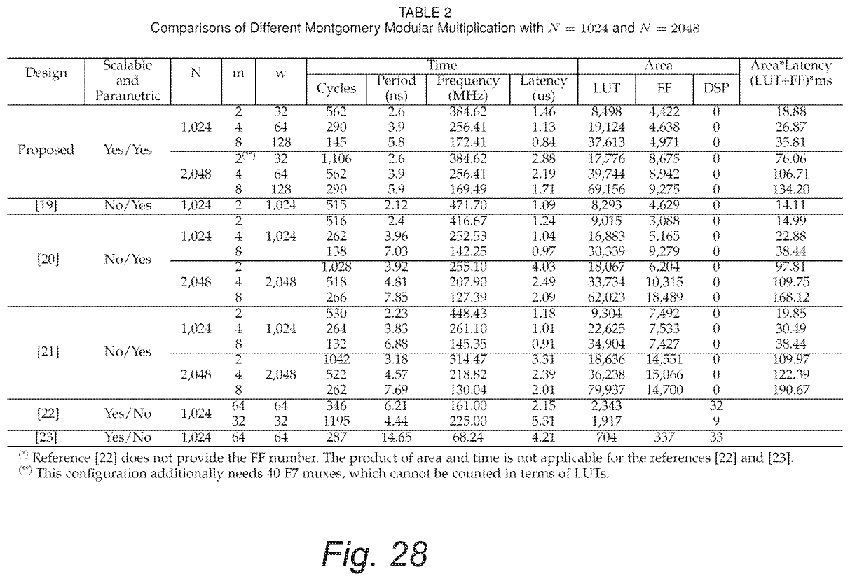

Table 2 reports the performance of different Montgomery modular multiplications in terms of time and area. (see, FIG. 28). Notice that different radix (different m values) result in different products of area and time. Ideally, it would be fair to compare our design with other scalable designs under the same m value. However, to the best of the authors' knowledge, there is no high-radix scalable design, which does not use DSP's. Strictly speaking, we do not know the complexity of a DSP (used as a multiplier) in terms of an equivalent number of LUTs. Although we cannot compare area with DSP-based design [1, 15], the worst latency of our design when m=2 is still smaller than their latency. Meanwhile, many references [13, 16, 20] (regardless of whether they are scalable or not) focus on optimizations for a given radix (i.e., m is fixed). When m is small, the required multiplications can be explicitly optimized. When m is large, the multiplication cost becomes non-negligible, and many designs make use of the well-optimized DSP modules on FPGA. It is difficult or inefficient to extend these designs to support a parameterized m value.

References [4, 5, 21] provide parameterized but non-scalable designs. Recall that a scalable design optimized for a presumed value of N, for example N=1,024, can still support Montgomery modular multiplication for any N>1024, e.g., N=2048 and N=4096, whereas a non-scalable design cannot support cases when N>1024. Evidently, there are time and area overheads to convert a non-scalable design to a scalable one (if this conversion is possible at all), for example to perform decomposition of the intermediate results and employ complex connections among PEs. When m=2 and m=4, the area and time product of our proposed scalable design is 29.95% and 17.44% larger than the reference [21]. However, our design's overhead is constant since each PE has a fixed number of inputs and is only connected with at most two neighboring PEs. Recall that the critical delay of a PE is that of performing three compressions and one m-bit addition. Therefore, the clock period of a PE scales as O(log m). As a result, when m=8, our scalable design has a smaller product of area and time than the non-scalable designs in [4, 21].

4. Inventive Design of a High-Performance, Fixed-Precision Montgomery Modular Multiplier Circuit

Feedforward Montgomery MM [19, 28] is a variant of Montgomery MM, which is able to compute q⁽ⁱ⁾ and Z⁽ⁱ⁾ in parallel. However, feedforward Montgomery MM can only guarantee that Z^{(d-1)} in the last iteration falls in the range [0, 2^{m+1}M). We cannot easily adjust Z back to the range [0, M) with a constant number of corrections. Note that the value of d can change for different variants of the Montgomery MM. In contrast, this thesis proposes an efficient fixed-precision Montgomery MM. For the sake of clarity, we first present a basic version of proposed Montgomery MM, in which we parallelize the computation of q⁽ⁱ⁾ and Z⁽ⁱ⁾ while guaranteeing that Z^{(d-1)} lies in the range [0,2M). The basic version shows the correctness of proposed Montgomery MM. Next, we present an advanced version of the proposed Montgomery MM, in which multiplication and addition operations are replaced with encoding and compression operations. This advanced version significantly reduces the critical path delay while guaranteeing that Z^{(d-1)} lies in the range (−M, 2M).

2.1 Basic Version.

Realization 9 shows the basic version of proposed Montgomery MM. In this algorithm, q⁽ⁱ⁾ and Z⁽ⁱ⁾ are independent of each other and can thus be computed in parallel. Based on BÃ©zout's identity, we can find r⁻¹∈(0, M) and M″∈(0, r²) such that r²r⁻¹−MM″=1.

```
Realization 9 Inventive fixed-precision radix-2^{m} Montgomery
modular multiplication: basic version
Input: X, Y ∈ [0, M), odd M < 2^{N}, r = 2^{m}, d = ┌N/m┐ +
  2, R = r^{┌N/m┐},
  r²r⁻¹ − M M″ = 1
Output: Z ∈ [0, M)
  1: Z⁽⁻¹⁾ = 0, q⁽⁻¹⁾ = 0
  2: for i = 0 to d − 1 do
  3: g⁽ⁱ⁾ = (Z⁽ⁱ⁻¹⁾ mod r²)M″ mod r²
  4: q⁽ⁱ⁾ = (g⁽ⁱ⁾ − q⁽ⁱ⁻¹⁾)/r
  5: Z⁽ⁱ⁾ = (Z⁽ⁱ⁻¹⁾ + XYᵢr² + q⁽ⁱ⁻¹⁾M)/r
  6: end for
  7: Z = Z^{(d-1)}
  8: if Z > M then
  9:  Z = Z − M
10: end if
11: return Z
```

Let us prove the correctness of realization 9 by mathematical induction. At the beginning, Z⁽⁻¹⁾+q⁽⁻¹⁾M=0 ≡ᵣ 0. Assume q⁽ⁱ⁻¹⁾∈[0, r) and Z⁽ⁱ⁻¹⁾+q⁽ⁱ⁻¹⁾M ≡ᵣ 0. We would like to derive a q⁽ⁱ⁾∈[0, r) such that Z⁽ⁱ⁾+q⁽ⁱ⁾M ≡ᵣ 0. Note that this condition must be met in every iteration of the realization to ensure that the computational result is correct. To do this we first define: g⁽ⁱ⁾=Z⁽ⁱ⁻¹⁾M″ modr²=(Z⁽ⁱ⁻¹⁾modr²)M″ modr² as in line 3 of realization 9. Next we show that Z⁽ⁱ⁻¹⁾+g⁽ⁱ⁾M ≡ᵣ_{²} 0 as follows:

$$\begin{matrix}{Z}^{( i - 1 )} + {g}^{( i )} M & = {Z}^{( i - 1 )} + ( {Z}^{( i - 1} {M}^{″} mod {r}^{2} ) M \\ & {≡}_{{r}^{2}} {Z}^{( i - 1 )} + {Z}^{( i - 1 )} {M}^{″} M \\ & = {Z}^{( i - 1 )} ( 1 + {MM}^{″} ) \\ & = {Z}^{( i - 1 )} {r}^{2} {r}^{- 1} \\ & {≡}_{{r}^{2}} 0\end{matrix} \qquad ( 40 )$$

Furthermore, equation (40) implies the following:

Z⁽ⁱ⁻¹⁾+g⁽ⁱ⁾M≡ᵣ0

Z⁽ⁱ⁻¹⁾+(g⁽ⁱ⁾mod r)M≡ᵣ0 (41)

Because both q⁽ⁱ⁻¹⁾ and (g⁽ⁱ⁾modr) are valid choices in [0, r), due to uniqueness of q⁽ⁱ⁻¹⁾ up to a modulo on r, we conclude q⁽ⁱ⁻¹⁾=g⁽ⁱ⁾modr. Therefore, g⁽ⁱ⁾−q⁽ⁱ⁻¹⁾ is a multiple of r i.e.,

g⁽ⁱ⁾−q⁽ⁱ⁻¹⁾≡ᵣ0 (42)

In line 4 of realization 9, we have q⁽ⁱ⁾=(g⁽ⁱ⁾−q⁽ⁱ⁻¹⁾)/r. Because g⁽ⁱ⁾ is 2m bits and q⁽ⁱ⁻¹⁾ is m bits, q⁽ⁱ⁾ is also m bits. With this choice for q⁽ⁱ⁾, and based on line 5 of realization 9, we can now prove that Z⁽ⁱ⁾+q⁽ⁱ⁾M ≡ᵣ 0. From equation (40), we know

$$\begin{matrix}{Z}^{( i - 1 )} + {XY}_{i} {r}^{2} + {g}^{( i )} M & {≡}_{{r}^{2}} 0 \\ & ⇔ \\ ( \frac{{Z}^{( i - 1 )} + {XY}_{i} {r}^{2} + {q}^{( i – 1 )} M}{r} + \frac{{g}^{( i )} - {q}^{( i - 1 )}}{r} M ) r & {≡}_{{r}^{2}} 0 \\ & ⇔ \\ {Z}^{( i )} + {q}^{( i )} M & {≡}_{{r}^{2}} 0\end{matrix} \qquad ( 43 )$$

And the proof is complete.

Consequently, the three multiplications in realization 9 may be done in parallel. The critical path for computing Z⁽ⁱ⁾ is thus reduced to one multiplication and two additions. We can also unfold the expression of Z⁽ⁱ⁾ until Z⁽⁻¹⁾ as shown below:

Z⁽ⁱ⁾rⁱ⁺¹=Xr²Σₖ₌₀ⁱYₖr^{k}+MΣₖ₌₀ⁱ=q^{(k-1)}r^{k}

Z⁽ⁱ⁾rⁱ⁺¹=Xr²Σₖ₌₀ⁱYₖr^{k}+Mr²Σₖ₌₀ⁱ⁻²q^{(k+1)}r^{k}

Z⁽ⁱ⁾rⁱ⁻¹=XΣₖ₌₀ⁱYₖr^{k}+MΣₖ₌₀ⁱ⁻²q^{(k+1)}r^{k} (44)

Because Z⁽⁻¹⁾=0, we have q⁽⁻¹⁾=q⁽⁰⁾=0.

When i≥┌N/m┐−1, we have Σₖ₌₀ⁱ Yₖr^{k}=Y. Because q⁽ⁱ⁾∈[0, r), we can estimate the upper bound of Z⁽ⁱ⁾ as follows:

$$\begin{matrix}{Z}^{( i )} {r}^{i - 1} & = X {\sum }_{k = 0}^{i} {Y}_{k} {r}^{k} + M {\sum }_{k = 0}^{i - 2} {q}^{( k + 1 )} {r}^{k} \\ & \leq XY + M ( r - 1 ) {\sum }_{k = 0}^{i - 2} {r}^{k} \\ & = XY + M ( r - 1 ) \frac{{r}^{i - 1} - 1}{r - 1} \\ & < ( M + {r}^{i - 1} ) M \\ {Z}^{( i )} & < ( 1 + \frac{M}{{r}^{i - 1}} ) M\end{matrix} \qquad ( 45 )$$

When (i−1)m≥N, we have M<2^{N}≤2^{(i-1)m}=rⁱ⁻¹ such that Z⁽ⁱ⁾<2M. Therefore, when we set d=┌N/m┐+2, we have Z^{(d-1)}∈[0,2M). Compared with realization 2, realization 9 only needs two additional iterations.

4.2 Advanced Version

Although realization 9 breaks the data dependency between q⁽ⁱ⁾ and Z⁽ⁱ⁾ and thus reduces the computation latency, multiplications and additions still hinder the development of a very high-performance Montgomery modular multiplication. Realization 10 shows an advanced version of the proposed Montgomery MM, which replaces all multiplications and additions in each iteration with encoding and compression operations. The result is an realization which can be implemented in hardware with much lower hardware area and computation latency than any and all prior art designs.

```
Realization 10 Inventive fixed-precision radix-2^{m} Mont-
gomery modular multiplication: advanced version
Input: X, Y ∈ [0, M), odd M < 2^{N}, r = 2^{m}, d = ┌N/m┐ +
  2, R = r^{┌N/m┐},
  r²r⁻¹ − M M″ = 1
Output: Z ∈ [0, M)
  1: Z_{S}⁽⁻¹⁾ = Z_{C}⁽⁻¹⁾ = Z_{carry}⁽⁻¹⁾ = q_{S}⁽⁻¹⁾ = q_{C}⁽⁻¹⁾ = q_{carry}⁽⁻¹⁾ = 0
  2: for i = 0 to d − 1 do
  3: Z⁽ⁱ⁻¹⁾ = (Z_{S}⁽ⁱ⁻¹⁾, = Z_{C}⁽ⁱ⁻¹⁾, = Z_{carry}⁽ⁱ⁻¹⁾)
  4: Z_{L}⁽ⁱ⁻¹⁾ = (Z_{S}⁽ⁱ⁻¹⁾[2m − 1 : 0], Z_{C}⁽ⁱ⁻¹⁾[2m − 1 :
      0], Z_{carry}⁽ⁱ⁻¹⁾)
  5: Z_{L}⁽ⁱ⁻¹⁾ = Encode(Z_{L}⁽ⁱ⁻¹⁾)
  6: q⁽ⁱ⁻¹⁾ = (q_{S}⁽ⁱ⁻¹⁾, q_{C}⁽ⁱ⁻¹⁾, q_{carry}⁽ⁱ⁻¹⁾)
  7: \tilde{q}⁽ⁱ⁻¹⁾ = Encode(q⁽ⁱ⁻¹⁾), \hat{q}⁽ⁱ⁻¹⁾ = EncodeSN(q⁽ⁱ⁻¹⁾)
  8: q_{S}⁽ⁱ⁾, q_{C}⁽ⁱ⁾ = Compress(\tilde{Z}_{L}⁽ⁱ⁻¹⁾ M″ − \hat{q}⁽ⁱ⁻¹⁾)
  9: q_{carry}⁽ⁱ⁾ = q_{S}⁽ⁱ⁾[m − 1] OR q_{C}⁽ⁱ⁾[m − 1]
10: q_{S}⁽ⁱ⁾ = q_{S}⁽ⁱ⁾ >> m, q_{C}⁽ⁱ⁾ = q_{C}⁽ⁱ⁾ >> m
11: Yᵢ = Yᵢ − Yᵢ[m − 1]r + Yᵢ₋₁[m − 1]
12: (Z_{S}⁽ⁱ⁾, Z_{C}⁽ⁱ⁾) = Compress(Z⁽ⁱ⁻¹⁾ + X\tilde{Y}ᵢr² + \hat{q}⁽ⁱ⁻¹⁾ M)
13: (Z_{S}⁽ⁱ⁾[N + 3m] = (Z_{S}⁽ⁱ⁾[N + 3m] XNOR Z_{C}⁽ⁱ⁾[N + 3m]
14: Z_{C}⁽ⁱ⁾[N + 3m] = 0
15: Z_{carry}⁽ⁱ⁾ = Z_{S}⁽ⁱ⁾[m − 1] OR Z_{C}⁽ⁱ⁾[m − 1]
16: Z_{S}⁽ⁱ⁾ = Z_{S}⁽ⁱ⁾ >> m, Z_{C}⁽ⁱ⁾ = Z_{C}⁽ⁱ⁾ >> m
17: end for
18: Z = Z_{S}^{(d-1)} + Z_{C}^{(d-1)} + Z_{carry}^{(d-1)}
19: if Z > M then
20: Z = Z − M
21: else if Z < 0 then
22: Z = Z + M
23: end if
24: return Z
```

In this algorithm, Z⁽ⁱ⁻¹⁾ is represented by three values: an (N+2m+1)-bit signed number Z_{S}⁽ⁱ⁾, an (N+2m+1)-bit signed number Z_{C}⁽ⁱ⁻¹⁾, and a 1-bit unsigned value Z_{carry}⁽ⁱ⁻¹⁾. Note that we do not explicitly perform the addition.

$$\begin{matrix}{Z}^{( i - 1 )} & = ( {Z}_{S}^{( i - 1 )} , {Z}_{C}^{( i - 1 )} , {Z}_{carry}^{( i - 1 )} ) \\ & = {Z}_{S}^{( i - 1 )} + {Z}_{C}^{( i - 1 )} + {Z}_{carry}^{( i - 1 )}\end{matrix} \qquad ( 46 )$$

The operation (Z⁽ⁱ⁻¹⁾modr²) is simply replaced with Z_{L}⁽ⁱ⁻¹⁾ as follows:

$$\begin{matrix}{Z}_{L}^{( i - 1 )} & = ( {Z}_{S}^{( i - 1 )} [ 2 m - 1 : 0 ] , {Z}_{C}^{( i - 1 )} [ 2 m - 1 : 0 ] , {Z}_{carry}^{( i - 1 )} ) \\ & = {Z}_{S}^{( i - 1 )} [ 2 m - 1 : 0 ] + {Z}_{C}^{( i - 1 )} [ 2 m - 1 : 0 ] + {Z}_{carry}^{( i + 1 )} \\ & {≡}_{{r}^{2}} {Z}^{( i - 1 )} mod {r}^{2}\end{matrix} \qquad ( 47 )$$

Notice that the difference between (Z⁽ⁱ⁻¹⁾modr²) and Z_{L}⁽ⁱ⁻¹⁾ is only 0 or r². Similarly, q⁽ⁱ⁻¹⁾ is represented by an m-bit unsigned number q_{S}⁽ⁱ⁻¹⁾, an m-bit unsigned number q_{C}⁽ⁱ⁻¹⁾, and a 1-bit unsigned value q_{carry}⁽ⁱ⁻¹⁾:

$$\begin{matrix}{q}^{( i - 1 )} & = ( {q}_{S}^{( i - 1 )} , {q}_{C}^{( i - 1 )} , {q}_{carry}^{( i - 1 )} ) \\ & = {q}_{S}^{( i - 1 )} + {q}_{C}^{( i - 1 )} + {q}_{carry}^{( i - 1 )}\end{matrix} \qquad ( 48 )$$

Consider computing the expression Z=(A+B)*C, which shows up in each iteration of the Montgomery MM. Normally, we would need to first perform the full-size addition D=A+B followed by the multiplication Z=D*C (during which we can utilize the modified Booth coding to cut the number of generated partial product in half). This serial sequence of add and multiply operations increases the latency per iteration of algorithms 3.3 and 6.1. Notice that the hardware resource cost to compute the expression Z=A*C+B*C directly is costly so that is not an option. Instead, we propose a novel encoding technique (called Encode), which removes the necessity of performing the full-bitwidth addition of A and B when computing (A+B)*C, it does so by grouping and encoding every k bits of A and B and using these encoded k-bit groups to generate partial products of D*C. Although the Encode function is good for multiplication, the results of Encode are presented in a special format, which does not correspond to either signed number or unsigned number representations. Therefore, we propose an auxiliary version of Encode (call EncodeSN for Encode in Signed Numbers), which results are standard signed numbers. It will be shown that the sum of any values encoded by the EncodeSN function is equal to the sum of these values when they are encoded by the Encode function so that EncodeSN is used to perform addition and subtraction whereas Encode is used to do D*C.

We also point out that the Encode function when k=2 also results in removal of half of the partial products of D*C, similar to using a radix-4 modified Booth coding when doing D*C. In this thesis, we discuss and show the implementation of this encoding approach for the k=2 case. Extension to higher values of k is straight-forward.

2.2.1 EncodeSN

Using a similar procedure as the one we did for realization 9, we determine e⁽ⁱ⁻¹⁾ so that Z⁽ⁱ⁻¹⁾+q⁽ⁱ⁻¹⁾M ≡ᵣ 0. Recall that q⁽ⁱ⁻¹⁾ is only unique up to a modulo on r as proved in (7). This observation motivates our encoding techniques, name Encode and EncodeSN. EncodeSN calculates (t+1)-bit outputs â and \hat{b} from t-bit inputs a and b. The encoding process consists of the following steps:

a) calculate a 3-bit intermediate result d as d[2: 0]=a[t−1: t−2]+b[t−1: t−2]+(a[t−3]ANDb[t−3]);

b) calculate â[t−4: 0]=a[t−4: 0] and \hat{b}[t−4: 0]=b[t−4: 0];

c) calculate â[t−3]=a[t−3] XORb[t−3]; â[t−2]=d[0]; â[t−1]=d[1]; â[t]=d[2];

d) calculate \hat{b}[t−1: t−3]=0; \hat{b}[t]=d[1].

The values of outputs a and b are defined as

v_{â}=â[t]2^{t}−â[t−1]2^{t-1}+Σᵢ₌₀^{t-1}â[i]2ⁱ

v_{\hat{b}}=\hat{b}[t]2^{t}−\hat{b}[t−1]2^{t-1}+Σᵢ₌₀^{t-1}\hat{b}[i]2ⁱ (49)

ensuring that v_{â}+v_{\hat{b}}=a+b.

We first perform EncodeSN(q_{S}⁽ⁱ⁻¹⁾, q_{C}⁽ⁱ⁻¹⁾). Although the outputs are m+1 bits, we truncate outputs and assign the least m bits to \hat{q}_{S}⁽ⁱ⁻¹⁾ and \hat{q}_{C}⁽ⁱ⁻¹⁾. \hat{q}_{carry}⁽ⁱ⁻¹⁾ is simply the q_{carry}⁽ⁱ⁻¹⁾ itself. Because \hat{q}_{S}[m]2^{m} and \hat{q}_{C}[m]2^{m} are multiples of r=2^{m}, the difference between \hat{q}⁽ⁱ⁻¹⁾=(\hat{q}_{S}⁽ⁱ⁻¹⁾, \hat{q}_{C}⁽ⁱ⁻¹⁾, \hat{q}_{carry}⁽ⁱ⁻¹⁾) and q⁽ⁱ⁻¹⁾ is a multiple or r so that

\hat{q}⁽ⁱ⁻¹⁾≡ᵣq⁽ⁱ⁻¹⁾

Z⁽ⁱ⁻¹⁾+\hat{q}⁽ⁱ⁻¹⁾M≡ᵣ0 (50)

We use the notation \hat{q}⁽ⁱ⁻¹⁾=EncodeSN(q⁽ⁱ⁻¹⁾) to represent the said encoding process.

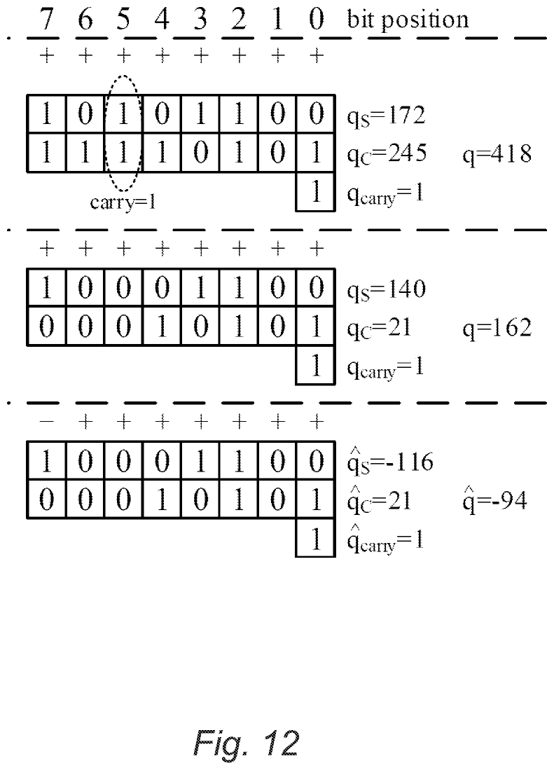

FIG. 12 shows the case of \hat{q}⁽ⁱ⁻¹⁾ when m=8, where the superscript (i−1) is omitted for brevity. The signs + and − stand for positive and negative weights respectively. As an example, q⁽ⁱ⁻¹⁾=418 and \hat{q}⁽ⁱ⁻¹⁾=−94. The difference q⁽ⁱ⁻¹⁾−\hat{q}⁽ⁱ⁻¹⁾=512=2*256=2*2⁸=2r.

2.2.2 Encode

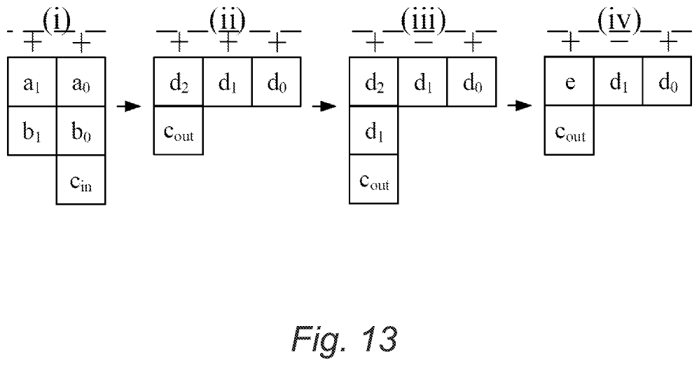

To explain the relationship between EncodeSN and Encode, we must carefully analyze the various steps of a 2-bit encoding as shown in FIG. 13. Considering 2-bit unsigned numbers a=2a₁+a₀ and b=2b₁+b₀, and 1-bit unsigned number cᵢₙ. The goal is to compute cₒᵤₜ, d, and e such that

a+b+cᵢₙ=4cₒᵤₜ−2d₁+d₀+4e (51)

Note that dᵢ=d[i] for i=0,1.

We define 2*c₁+d₀=a₀+b₀+cᵢₙ for step (i) of FIG. 13. Table 3 presents the truth table for different a₁, b₁, and c₁ so that a₁+b₁+c₁=2d₂+d₁+2cₒᵤₜ in step (ii). The overflow due to a₁=b₁ is captured in cₒᵤₜ=a₁ANDb₁.

TABLE 3
Truth table for a₁, b₁, c₁

| a₁ | b₁ | c₁ | Cₒᵤₜ | d₂ | d₁ | e |
|---|---|---|---|---|---|---|
| 0 | 0 | 0 | 0 | 0 | 0 | 0 |
| 0 | 0 | 1 | 0 | 0 | 1 | 1 |
| 0 | 1 | 0 | 0 | 0 | 1 | 1 |
| 0 | 1 | 1 | 0 | 1 | 0 | 1 |
| 1 | 0 | 0 | 0 | 0 | 1 | 1 |
| 1 | 0 | 1 | 0 | 1 | 0 | 1 |
| 1 | 1 | 0 | 1 | 0 | 0 | 0 |
| 1 | 1 | 1 | 1 | 0 | 1 | 1 |

In step (iii), we split d₁ as 2d₁−d₁. Notice that d₂ and d₁ cannot be 1 at the same time, therefore, we only need e=d₂ORd₁ to represent d₂+d₁ in step (iv). In conclusion, realization 11 shows the 2-bit encoding, which takes three inputs a, b, and cᵢₙ and generates outputs e, d, and cₒᵤₜ. The critical path delay is equal to that for a 2-bit adder. To avoid confusions, XOR and AND have the same precedence, which are higher than OR.

```
Realization 11 [cₒᵤₜ, d, e] = Encode2bit(a, b, cᵢₙ)
Input: a[1 : 0], b[1 : 0], cᵢₙ
Output: Cₒᵤₜ, d[1 : 0], e
  1: t = a₀ AND b₀ OR a₀ AND cᵢₙ OR b₀ AND cᵢₙ
  2: cₒᵤₜ = a₁ AND b₁
  3: d₀ = a₀ XOR b₀ XOR cᵢₙ
  4: d₁ = a₁ XOR b₁ XOR t
  5: e = a₁ XOR b₁ OR t
```

Taking a second look at \hat{q}⁽ⁱ⁻¹⁾=EncodeSN(q⁽ⁱ⁻¹⁾), we actually do 2-bit encoding for the leading 2 bits of q_{S}⁽ⁱ⁻¹⁾ and q_{C}⁽ⁱ⁻¹⁾ with cᵢₙ=q_{S}⁽ⁱ⁻¹⁾[m−3]ANDq_{C}⁽ⁱ⁻¹⁾[m−3] and ignore the outputs cₒᵤₜ and e. Note that q_{S}⁽ⁱ⁻¹⁾[m−3] and q_{C}⁽ⁱ⁻¹⁾[m−3] are adjusted accordingly. Instead of only encoding the leading 2 bits of q_{S}⁽ⁱ⁻¹⁾ and q_{C}⁽ⁱ⁻¹⁾, we can encode every 2 bits.

Realization 12 calculates (t+1)-bit outputs ã and \tilde{b} for two t-bit inputs a and b and a 1-bit input c. Without loss of generality, we assume the bitwidth t for inputs a and b is even. Otherwise, we can pad a 0 to the left of a and b. The output cₒᵤₜ in a 2-bit encoding is used as the input cᵢₙ for the next 2-bit encoding. For example, the cₒᵤₜ from Encode2 bit(a[t−3: t−4], b[t−3: t−4], cᵢₙ) serves as the cᵢₙ for Encode2 bit(a[t−1: t−2], b[t−1: t−2], cᵢₙ).

```
Realization 12 [ã, \tilde{b}] = Encode (a, b, c)
Input: t-bit unsigned a and b, 1-bit unsigned c
Output: (t + 1)-bit ã and \tilde{b}
  1: ã = \tilde{b} = 0, cₒᵤₜ⁽⁻¹⁾ = c
  2: for i = 0 to t/ 2 − 1 do
  3:  [cₒᵤₜ⁽ⁱ⁾, e⁽ⁱ⁾, d⁽ⁱ⁾] = Encode2bit(a[2i+1:2i], b[2i+1:2i], cₒᵤₜ^{(i-1),}
  4:  ã[2i + 1 : 2i] = d⁽ⁱ⁾
  5:  \tilde{b}[2i + 2] = e⁽ⁱ⁾
  6: end for
  7: ã[t] = cₒᵤₜ^{(t/2-1)}
```

Recall that the sum of inputs is equal to the sum of outputs for a 2-bit encoding as shown in (51). The goal of the Encode procedure is to represent the sum a+b+c in a different format. The values of ã and \tilde{b} are defined as

v_{ã}=Σᵢ₌₀^{t/2}ã[2i]2²ⁱ−Σᵢ₌₀^{t/2-1}ã[2i+1]2²ⁱ⁺¹

v_{\tilde{b}}=Σᵢ₌₀^{t/2}\tilde{b}[2i]2²ⁱ−Σᵢ₌₀^{t/2-1}\tilde{b}[2i+1]2²ⁱ⁺¹ (52)

ensuring that v_{ã}+v_{\tilde{b}}=a+b+c.

If we also apply (â, \hat{b})=EncodeSN(a, b), we must have

v_{â}+v_{\hat{b}}+c=a+b+c=v_{ã}+v_{\tilde{b}}

â[t]+\hat{b}[t]=ã[t]+\tilde{b}[t] (53)

We can perform Encode(q_{S}⁽ⁱ⁻¹⁾, q_{C}⁽ⁱ⁻¹⁾, q_{carry}⁽ⁱ⁻¹⁾. Similar to the computation of \hat{q}⁽ⁱ⁻¹⁾, we can truncate outputs and assign the least m bits to \tilde{q}_{S}⁽ⁱ⁻¹⁾ and \tilde{q}_{C}⁽ⁱ⁻¹⁾. Because of equation (53), we have:

\tilde{q}⁽ⁱ⁻¹⁾=\hat{q}⁽ⁱ⁻¹⁾

Z⁽ⁱ⁻¹⁾+\tilde{q}⁽ⁱ⁻¹⁾M≡ᵣ0 (54)

We use the notation \tilde{q}⁽ⁱ⁻¹⁾=Encode(q⁽ⁱ⁻¹⁾) to represent the said encoding process.

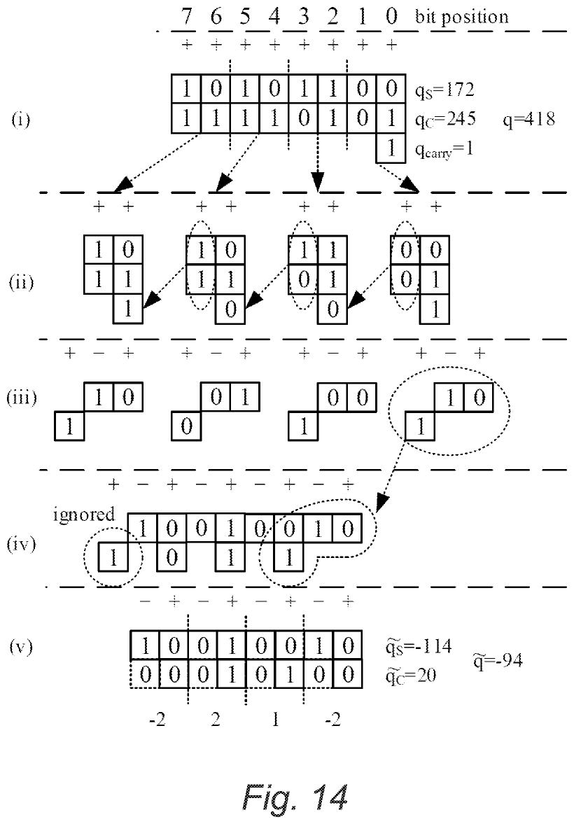

Although realization 12 is presented by a for loop, all 2-bit encodings can be preformed in parallel. FIG. 14 shows the example when m=8. In step (ii), we group 2 bits and compute cₒᵤₜ for each group. In step (iii), we perform 2-bit encoding and generate outputs e and d for each group. cₒᵤₜ is already computed and used in step (ii). In step (iv), we combine results into two numbers. Output e when encoding the leading 2 bits is ignored. In step (v), we fill empty slots with 0. Notice that we get all information in step (iii). Steps (iv) and (v) are only shown to explain the computation to the reader. The critical path delay to perform Encode is roughly equal to that of a 2-bit adder.

An important observation is that we can group 2-bit parts of \tilde{q}⁽ⁱ⁻¹⁾ again. As shown in step (v) of FIG. 14, some bits are constant 0. Their value can be treated as (−2)*4³+2*4²+1*4¹+(−2)*4⁰=−94. The value range for a group is [−2,2]. Like radix-4 modified Booth coding, we can use a group to generate a partial product directly. When we compute \tilde{q}⁽ⁱ⁻¹⁾M, we only have m/2 partial products. There is no need to do an m-bit addition for q_{S}⁽ⁱ⁻¹⁾+q_{C}⁽ⁱ⁻¹⁾+q_{carry}⁽ⁱ⁻¹⁾ any more. Since the range of a group is [−2,2], the range of m-bit \tilde{q}⁽ⁱ⁾ is

$$[ - \frac{2}{3} ( r - 1 ) , \frac{2}{3} ( r - 1 ) ]$$

as shown below:

$$\begin{matrix}{\tilde{q}}^{( i )} & \leq {\sum }_{k = 0}^{m / 2 - 1} 2 * {4}^{k} = 2 * \frac{{4}^{m / 2} - 1}{4 - 1} \\ & = \frac{2}{3} ( {2}^{m} - 1 ) = \frac{2}{3} ( r - 1 ) \\ {\tilde{q}}^{( i )} & \geq {\sum }_{k = 0}^{m / 2 - 1} ( - 2 ) * {4}^{k} = - \frac{2}{3} ( r - 1 )\end{matrix} \qquad ( 55 )$$

2.2.3 Computation of q⁽ⁱ⁾

Recall the computation of g⁽ⁱ⁾=(Z⁽ⁱ⁻¹⁾modr²)M″ modr² in realization 9, resulting in Z⁽ⁱ⁻¹⁾+g⁽ⁱ⁾ M ≡ᵣ_{²} 0, that is

Z⁽ⁱ⁻¹⁾+((Z⁽ⁱ⁻¹⁾mod r²)M″ mod r²)M≡ᵣ_{²}0 (56)

If we add/subtract any multiples of r² to/from (Z⁽ⁱ⁻¹⁾modr²), the above equation will still hold. In other words, it is safe to replace (Z⁽ⁱ⁻¹⁾modr²) with Z_{L}⁽ⁱ⁻¹⁾ or \tilde{Z}_{L}⁽ⁱ⁻¹⁾=Encode(Z_{L}⁽ⁱ⁻¹⁾), because the difference between any two of (Z⁽ⁱ⁻¹⁾modr²), Z_{L}⁽ⁱ⁻¹⁾, and \tilde{Z}_{L}⁽ⁱ⁻¹⁾ is a multiple of r². The benefit is that we will only have m partial products if we compute \tilde{Z}_{L}⁽ⁱ⁻¹⁾M″. We thus have:

Z⁽ⁱ⁻¹⁾+(\tilde{Z}_{L}⁽ⁱ⁻¹⁾M″ mod r²)M≡ᵣ_{²}0 (57)

Equation (57) implies:

Z⁽ⁱ⁻¹⁾+(\tilde{Z}_{L}⁽ⁱ⁻¹⁾M″ mod r)M≡ᵣ_{²}0 (58)

Considering equation (50) and the uniqueness of q⁽ⁱ⁻¹⁾ up to a modulo on r, we have

\tilde{Z}_{L}⁽ⁱ⁻¹⁾M″ mod r−\hat{q}⁽ⁱ⁻¹⁾≡ᵣ0 (59)

Following equation (43) which was related to realization 9, the obtained q⁽ⁱ⁾ for realization 10 should meet the following requirement:

$${q}^{( i )} {≡}_{r} \frac{{\tilde{Z}}_{L}^{( i - 1 )} {M}^{″} - {\hat{q}}^{( i - 1 )}}{r} \qquad ( 60 )$$

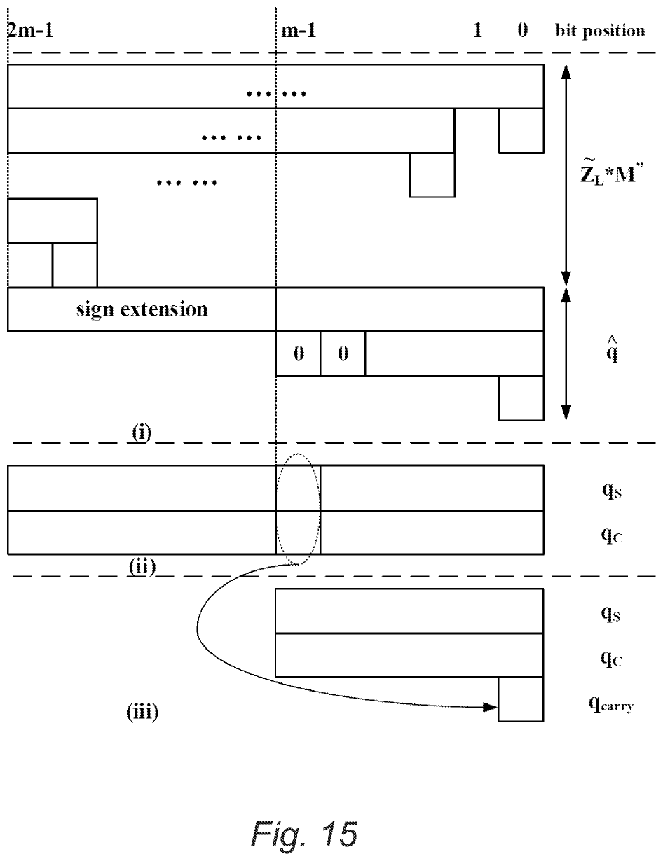

FIG. 15 shows compression of \tilde{Z}_{L}⁽ⁱ⁻¹⁾ M″−\hat{q}⁽ⁱ⁻¹⁾ for the least significant 2m bits. In step (i), we use CSA to compress m+3 numbers into two unsigned numbers q_{S}⁽ⁱ⁾ and q_{C}⁽ⁱ⁾. Notice that each partial product has a tail bit. The aforesaid m+3 numbers consist of three parts: m numbers from \tilde{Z}_{L}⁽ⁱ⁻¹⁾M″, 2 numbers from \hat{q}_{S}⁽ⁱ⁻¹⁾ and \hat{q}_{C}⁽ⁱ⁻¹⁾, and 1 number constructed by collecting the tail bits and \hat{q}_{carry}⁽ⁱ⁻¹⁾. We then use a balanced ternary tree arrangement of CSAs to perform the compression (q_{S}⁽ⁱ⁾, q_{C}⁽ⁱ⁾)=Compress(\tilde{Z}_{L}⁽ⁱ⁻¹⁾M″−\hat{q}⁽ⁱ⁻¹⁾) with O(log m) number of full adder cell delays. Here, we do the fixed-bitwidth compression and collect the least significant 2m bits of the two numbers after compression because any overflow is a multiple of r².

Because of equation (59), the sum of the least significant m bits can only be 0 or r. When q_{S}⁽ⁱ⁾[m−1]=1 or q_{C}⁽ⁱ⁾[m−1]=1, the following equality holds: q_{S}⁽ⁱ⁾[m−1: 0]+q_{C}⁽ⁱ⁾[m−1: 0]=r. On the other hand, when q_{S}⁽ⁱ⁾[m−1]=q_{C}⁽ⁱ⁾[m−1]=0, we have q_{S}⁽ⁱ⁾[m−1: 0]+q_{C}⁽ⁱ⁾[m−1: 0]=0. Therefore, we may define q_{carry}⁽ⁱ⁾ as follows:

q_{carry}⁽ⁱ⁾=q_{S}⁽ⁱ⁾[m−1]ORq_{C}⁽ⁱ⁾[m−1]

q_{carry}⁽ⁱ⁾r=q_{S}⁽ⁱ⁾[m−1: 0]+q_{C}⁽ⁱ⁾[m−1:0] (61)

In step (ii), the computation of (\tilde{Z}_{L}⁽ⁱ⁻¹⁾M″−\hat{q}⁽ⁱ⁻¹⁾)/r is reduced to a right shift by m bits:

q_{carry}⁽ⁱ⁾=q_{S}⁽ⁱ⁾[m−1]ORq_{C}⁽ⁱ⁾[m−1]

q_{S}⁽ⁱ⁾=q_{S}⁽ⁱ⁾>>m

q_{C}⁽ⁱ⁾=q_{C}⁽ⁱ⁾>>m (62)

Note that the resulting q⁽ⁱ⁾=(q_{S}⁽ⁱ⁾, q_{C}⁽ⁱ⁾, q_{carry}⁽ⁱ⁾) is valid since it meets equation (60). Consequently, the computation of q⁽ⁱ⁾ relies on encoding and compression operations, rather then the more expensive multiplication and addition operations.

2.2.4 Error Analysis

Before doing the error analysis for Z⁽ⁱ⁾, let us briefly discuss the optimization to compute XYᵢ based on the modified Booth coding. Instead of computing XYᵢ, we scan Yᵢ and Yᵢ₋₁[m−1] and encode them as \tilde{Y}ᵢ, that is,

$$\begin{matrix}{\tilde{Y}}_{i} & = {Y}_{i} - {Y}_{i} [ m - 1 ] r + {Y}_{i - 1} [ m - 1 ] \\ & = {\sum }_{k = 0}^{m / 2 - 1} ( - 2 Y [ 2 k + 1 + im ] \\ & + Y [ 2 k + im ] + Y [ 2 k - 1 + im ] k ) {4}^{k}\end{matrix} \qquad ( 63 )$$

Note that Y₋₁=0.

Following the radix-4 modified Booth coding, we can further divide \tilde{Y}ᵢ into m/2 groups if we group every 2 bits. In case m is an odd number, we can sign-extend \tilde{Y}ᵢ by 1 bit and generate ┌m/2┐ groups. Alternatively, we can directly apply radix-2^{m} modified Booth coding to \tilde{Y}ᵢ. Because the range of −2Y[2k+1+im]+Y[2k+im]+Y[2k−1+im] is [−2,2], we can use it to generate a partial product. Consequently, the product of X\tilde{Y}ᵢ has m/2 partial products, whereas XYᵢ has m/2+1 partial products. Moreover, the range of \tilde{Y}ᵢ falls in [−r/2, r/2] as shown next:

$$\begin{matrix}{Y}_{i} & ∈ [ 0 , {2}^{m} - 1 ] \\ {Y}_{i} - {Y}_{i} [ m - 1 ] r & ∈ [ - {2}^{m - 1} , {2}^{m - 1} - 1 ] \\ {\tilde{Y}}_{i} & = {Y}_{i} - {Y}_{i} [ m - 1 ] r + {Y}_{i - 1} [ m - 1 ] \\ & ∈ [ - {2}^{m - 1} , {2}^{m - 1} ] = [ - \frac{r}{2} , \frac{r}{2} ]\end{matrix} \qquad ( 64 )$$

We can further compute the range for Σₖ₌₀ⁱ \tilde{Y}ₖ as follows:

$$\begin{matrix}{\sum }_{k = 0}^{i} {\tilde{Y}}_{k} {r}^{k} & = {\sum }_{k = 0}^{i} {Y}_{k} {r}^{k} - Y [ ( i + 1 ) m - 1 ] r \\ & ∈ [ - {2}^{( i + 1 ) m - 1} , {2}^{( i + 1 ) m - 1} ) = [ - \frac{{r}^{i + 1}}{2} , \frac{{r}^{i + 1}}{2} )\end{matrix} \qquad ( 65 )$$

When (i+1)m−1≥N, we have Y[(i+1)m−1]=0 so that

Y=Σₖ₌₀^{┌N/m┐-1}Yₖr^{k}=Σₖ₌₀^{┌(N+1)/m┐-1}\tilde{Y}ₖr^{k} (66)

Since Z⁽ⁱ⁾=(Z⁽ⁱ⁻¹⁾+X\tilde{Y}ᵢr²+\tilde{q}⁽ⁱ⁻¹⁾M)/r, we can unfold the expression until Z⁽⁻¹⁾=0 as shown below:

Z⁽ⁱ⁾rⁱ⁺¹=Xr²Σₖ₌₀ⁱ\tilde{Y}ₖr^{k}+MΣₖ₌₀ⁱ\tilde{q}^{(k-1)}r^{k}

Z⁽ⁱ⁾rⁱ⁺¹=Xr²Σₖ₌₀ⁱ\tilde{Y}ₖr^{k}+Mr²Σₖ₌₀ⁱ⁻²\tilde{q}^{(k-1)}r^{k}

Z⁽ⁱ⁾rⁱ⁻¹=XΣₖ₌₀ⁱ\tilde{Y}ₖr^{k}+MΣₖ₌₀ⁱ⁻²\tilde{q}^{(k-1)}r^{k} (67)

Note that because Z⁽⁻¹⁾=0, we have \tilde{q}⁽⁰⁾=\tilde{q}⁽⁻¹⁾=0.

When i≥┌(N+1)/m┐−1, the following equality holds:

$$\begin{matrix}{Z}^{( i )} {r}^{( i + 1 )} & = X {\sum }_{k = 0}^{i} {\tilde{Y}}_{k} {r}^{k} + M {\sum }_{k = 0}^{i - 2} {\tilde{q}}^{( k + 1 )} {r}^{k} \\ & = XY + M {\sum }_{k = 0}^{i - 2} {\tilde{q}}^{( k + 1 )} {r}^{k}\end{matrix} \qquad ( 68 )$$

We can derive upper and lower bounds for Z⁽ⁱ⁾ as follows:

$$\begin{matrix}{Z}^{( i )} {r}^{i - 1} & < {M}^{2} + \frac{2}{3} M ( r - 1 ) {\sum }_{k = 0}^{i - 2} {r}^{k} \\ & < {M}^{2} + \frac{2}{3} M ( r - 1 ) \frac{{r}^{i - 1} - 1}{r - 1} \\ & < ( M + \frac{2}{3} {r}^{i - 1} ) M \\ {Z}^{( i )} & < ( \frac{2}{3} + \frac{M}{{r}^{i - 1}} ) M \\ {Z}^{( i )} {r}^{i - 1} & \geq 0 - \frac{2}{3} M ( r - 1 ) {\sum }_{k = 0}^{i - 2} {r}^{k} > ( - \frac{2}{3} {r}^{i - 1} ) M \\ {Z}^{( i )} & > - \frac{2}{3} M > - M\end{matrix} \qquad ( 69 )$$

When meeting the condition M/rⁱ⁻¹≤4/3, we have −M<Z⁽ⁱ⁾<2M. Equation (70) given below simplifies this condition. Because log₂^{3M}<N+2, this condition is met when N≤(i−1)m. Therefore, when we set d=┌N/m┐+2, we have Z^{(d-1)}∈(−M, 2M). We only need one correction, either addition or subtraction, to adjust Z back to [0, M).

M/rⁱ⁻¹≤4/3⇔3M≤2^{(i-1)m+2}

⇔ log₂^{3M}≤(i−1)m+2 (70)

We can also compute the maximum size of any intermediate result Z⁽ⁱ⁾ as follows. Recall that

$$\vert {\sum }_{k = 0}^{i} {\tilde{Y}}_{k} {r}^{k} \vert \leq \frac{{r}^{i + 1}}{2} and \vert {\tilde{q}}^{( k + 1 )} \vert \leq \frac{2}{3} ( r - 1 ) .$$

$$\begin{matrix}{Z}^{( i )} {r}^{i - 1} & = X {\sum }_{k = 0}^{i} {\tilde{Y}}_{k} {r}^{k} + M {\sum }_{k = 0}^{i - 2} {\tilde{q}}^{( k + 1 )} {r}^{k} \\ \vert {Z}^{( i )} {r}^{i - 1} \vert & < M \frac{{r}^{i + 1}}{2} + \frac{2}{3} M ( r - 1 ) {\sum }_{k = 0}^{i - 2} {r}^{k} \\ & < M ( \frac{{r}^{i + 1}}{2} + \frac{2}{3} {r}^{i - 1} ) \\ \vert {Z}^{( i )} \vert & < M ( \frac{{r}^{2}}{2} + \frac{2}{3} ) < {2}^{N + 2 m}\end{matrix} \qquad ( 71 )$$

In other words, independent of the iteration count i, any Z⁽ⁱ⁾ can be represented by an (N+2m+1)-bit signed number.

2.2.5 Computation of Z⁽ⁱ⁾

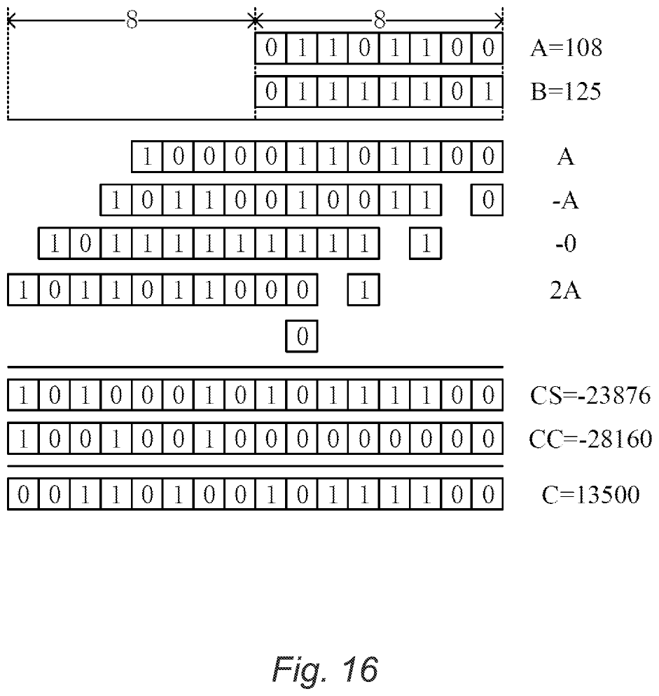

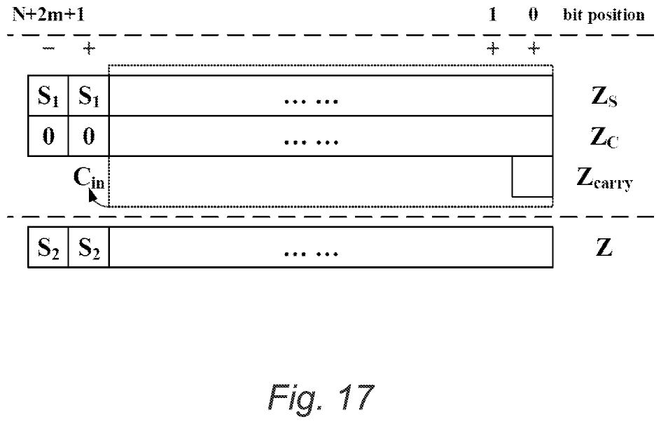

The last thing to do is to efficiently compute Z⁽ⁱ⁾=(Z⁽ⁱ⁻¹⁾+X\tilde{Y}ᵢr²+\tilde{q}⁽ⁱ⁻¹⁾M)/r. At this time, it is not safe to add or subtract a multiple of r. Our proposed encoding and modified Booth coding save half of the partial products and reduce the hardware area. After compression, the partial products are compressed into two signed numbers. We can do an addition (while ignoring any overflows) to get the correct result. FIG. 16 shows an example to compute 8-bit signed multiplication for C=AB with radix-4 modified Booth coding. For A=108 and B=125, the correct product C is 13,500. Once we get all 4 partial products, we compress them into two 16-bit signed numbers CS and CC. Although CS+CC=−52,036≠13,500, we can perform the 16-bit addition while ignoring the overflow bit, thereby obtaining the correct result.

The said addition of the two signed numbers seems necessary. We show next that in fact this costly add operation can be avoided and the computation of Z⁽ⁱ⁾ can be accomplished by using only encoding and compression operations.

As we discussed in equation (71), Z⁽ⁱ⁾ is an (N+2m+1)-bit signed number. We want to accurately represent Z⁽ⁱ⁾ by a triplet: an (N+2m+2)-bit signed number Z_{S}⁽ⁱ⁾, an (N+2m+2)-bit signed number Z_{C}⁽ⁱ⁾, and a 1-bit unsigned value Z_{carry}⁽ⁱ⁾. FIG. 15 shows our general data model, where the leading 2 bits of Z_{S} are same and the leading 2 bits of Z_{C} are 0. Because the resulting Z is an (N+2m+1)-bit signed number, Z[N+2m+1] must be the sign extension.

We define the carry from the addition for the least significant (N+2m) bits as Cᵢₙ. Table 4 shows all possible combinations of S₁ and Cᵢₙ. Notice that it is impossible to have S₁=0 and Cᵢₙ=1 because the resulting Z becomes larger than 2^{N+2m}, which would violate the fact that Z is a (N+2m+1)-bit signed number. For the remaining three cases, Z_{S}⁽ⁱ⁾+Z_{C}⁽ⁱ⁾+Z_{carry}⁽ⁱ⁾ can never have any overflows, therefore, the sum Z⁽ⁱ⁾ can be correctly presented.

TABLE 4
Truth table for the proposed data mode

| S₁ | Cᵢₙ | S₂ |
|---|---|---|
| 0 | 0 | 0 |
| 0 | 1 | N.A. |
| 1 | 0 | 1 |
| 1 | 1 | 0 |

We again prove the result by using mathematical induction. The base case is Z⁽⁻¹⁾=Z_{S}⁽⁻¹⁾+Z_{C}⁽⁻¹⁾+Z_{carry}⁽⁻¹⁾=0. Assume Z⁽ⁱ⁻¹⁾=(Z_{S}⁽ⁱ⁻¹⁾, Z_{C}⁽ⁱ⁻¹⁾, Z_{carry}⁽ⁱ⁻¹⁾) fits in the data model of FIG. 15, if we show that Z⁽ⁱ⁾=(Z_{S}⁽ⁱ⁾, Z_{C}⁽ⁱ⁾, Z_{carry}⁽ⁱ⁾) also fits in the data model, then we will have proven that the sum Z⁽ⁱ⁾ can be correctly presented.

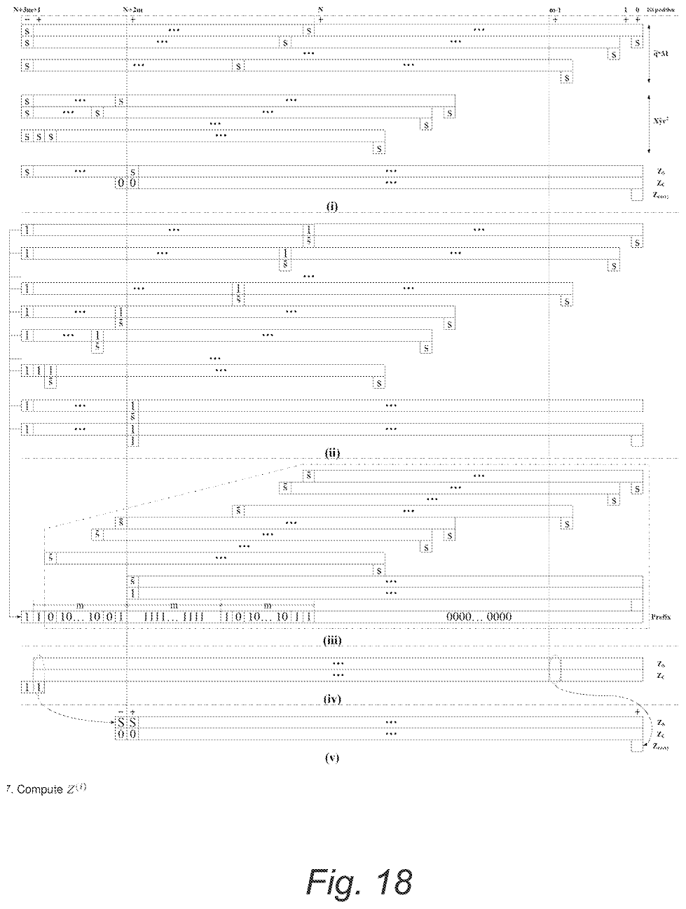

FIG. 18 shows the computation of Z⁽ⁱ⁾. Both \tilde{q}⁽ⁱ⁻¹⁾M and X\tilde{Y}ᵢr² generate m/2 partial products. Z⁽ⁱ⁻¹⁾ is represented by Z_{S}⁽ⁱ⁻¹⁾, Z_{C}⁽ⁱ⁻¹⁾, and Z_{carry}⁽ⁱ⁻¹⁾. Because Z⁽ⁱ⁾ is an (N+2m+1)-bit signed number, Z⁽ⁱ⁻¹⁾+X\tilde{Y}ᵢr²+\tilde{q}⁽ⁱ⁻¹⁾M=Z⁽ⁱ⁾r is an (N+3m+1)-bit signed number, which is also a multiple of r. To sum all partial products together, the first thing to do is to sign extend the numbers so that all of them have same bitwidth. Here, we deliberately extend them into N+3m+2 bits in step (i) of FIG. 18. For sake of brevity, all signs are labelled as S although different numbers could have different sign values.

The sign bits in a number can be converted into 1's followed by a S̅ in step (ii). Any overflows can be ignored because Z⁽ⁱ⁾r only has (N+3m+1) bits. S̅ is the Boolean inversion of S. We further merge all constant 1's into a number called prefix in step (iii) after ignoring any overflows. Because the prefix is a constant number which is only dependent on m, the real implementation can skip steps (i) and (ii), and start at step (iii). When m≥4, we can prove that the maximum value for dashed polygon in step (iii) is less than 2^{N+3m+1} as shown below:

$$\begin{matrix}( {\sum }_{k = 0}^{m / 2 - 1} ( {2}^{N} - 1 ) {4}^{k} ) & + ( {\sum }_{k = 0}^{m / 2 - 1} ( {2}^{N} - 1 ) {4}^{k} ) {2}^{2 m} \\ & + 2 ( {2}^{N + 2 m + 1} - 1 ) + 1 \\ & + 3 * {2}^{N + 3 m - 3} \\ & < {2}^{N + 3 m + 1}\end{matrix} \qquad ( 72 )$$

Since the dashed polygon is less than 2^{N+3m+1} the compression of the m+3 numbers will result in two (N+3m+1)-bit unsigned numbers Z_{S}⁽ⁱ⁾ and Z_{C}⁽ⁱ⁾ in step (iv) regardless of the compression strategy. Note that Z_{S}[N+3m] and Z_{C}[N+3m] cannot be 1 at the same time; otherwise Z_{S}⁽ⁱ⁾+Z_{C}⁽ⁱ⁾ will be larger than 2^{N+3m+1}. As a result, the sum of Z_{S}[N+3m], Z_{C}[N+3m], and the leading 2 bits of the prefix will be a 2-bit number with the same value, which is Z_{S}[N+3m]XNORZ_{C}[N+3m]. Since Z_{S}[N+3m] is always the same as Z_{S}[N+3m+1], we can hide Z_{S}[N+3m+1] and Z_{C}[N+3m+1] in a hardware implementation.

Because Z⁽ⁱ⁻¹⁾+X\tilde{Y}ᵢr²+\tilde{q}⁽ⁱ⁻¹⁾M ≡ᵣ 0, in step (v), the operation (Z⁽ⁱ⁻¹⁾+X\tilde{Y}ᵢr²+\tilde{q}⁽ⁱ⁻¹⁾M)/r can be simplified as shown below:

Z_{carry}⁽ⁱ⁾=Z_{S}⁽ⁱ⁾[m−1]ORZ_{C}⁽ⁱ⁾[m−1]

Z_{S}⁽ⁱ⁾=Z_{S}⁽ⁱ⁾>>m

Z_{C}⁽ⁱ⁾=Z_{C}⁽ⁱ⁾>>m (73)

Because Z⁽ⁱ⁾=(Z_{S}⁽ⁱ⁾, Z_{C}⁽ⁱ⁾, Z_{carry}⁽ⁱ⁾) fits the data model in FIG. 17, we thus correctly present Z⁽ⁱ⁾ without doing an addition.

When m<4, we can modify the data model of FIG. 17 to have N+2m+3 bits, sign extend all numbers into (N+3m+3) bits in step (i), and prove the dashed polygon is less than 2^{N+3m+2} in step (iii). The remaining proofs are similar to what we did above and are thus omitted here for brevity.

2.3 Hardware Implementation

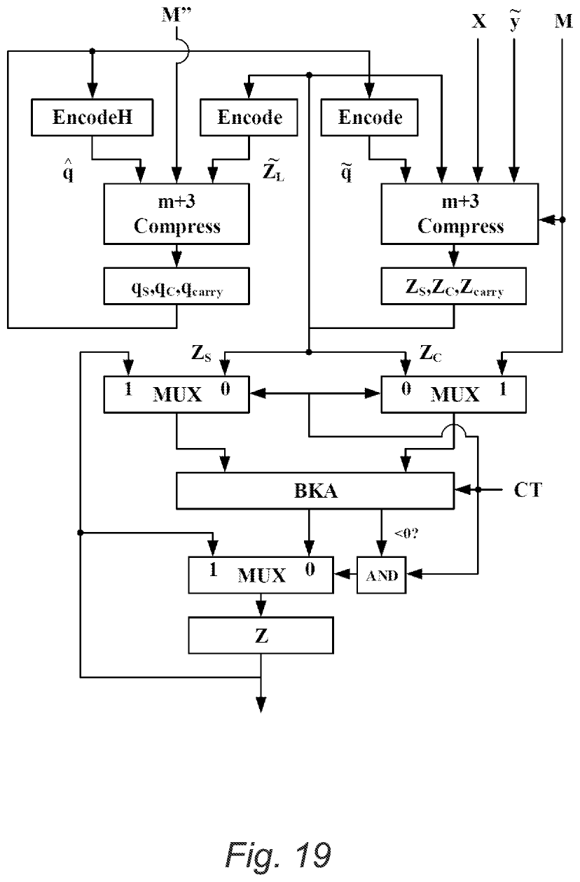

FIG. 19 shows the block-level diagram for the hardware implementation of the proposed Montgomery modular multiplier. With the help of Encode, EncodeSN, and compression, the critical paths to update (q_{S}, q_{C}, q_{carry}) and (Z_{S}, Z_{C}, Z_{carry}) correspond to those for doing a 2-bit addition and compression of m+3 numbers.

The critical path of the proposed Montgomery MM thus lies in the addition module for the final summation and correction step. Considering the trade-off between time and area, we use a high performance logarithmic Brent-Kung adder (BKA) [2] and specify a 3-cycle timing constraint. Note that we need to perform one final summation and do at most one correction. We only need to use BKA twice in 6 consecutive cycles, which justifies the 3-cycle timing constraint. The control signal CT is used to control the data flow of BKA. When CT=0, we compute Z_{S}+Z_{C}+Z_{carry} and store it in Z. When CT=1, we check the sign of Z. If Z<0, we compute Z+M. If Z≥0, we compute Z−M. If the computation result is negative, we do not need any correction and simply choose the original Z. Otherwise, the result, which is positive, is stored into Z. In conclusion, the total clock cycle count to do the Montgomery MM is only

CycleCount=u+6 (74)

where u=┌N/m┐+2 is the number of iterations.

2.4 Complexity Analysis

Table 5 shows complexity analysis for different algorithms in terms of area and time. The iteration count, which remains the same for all algorithms, is equal to O(N/m). Assume we use a textbook multiplier to perform an N×m multiplication with area and time complexities of O(Nm). For algorithms 3.3 and 6.1, the critical path in each iteration is bounded by the multiplications such that the area and time complexity per iteration of the realization are O(Nm). Meanwhile, the clock period (latency per iteration) for realization 10 is reduced a lot due to replacement of additions and multiplications with compression and encoding operations. More precisely, since encoding only takes a constant delay and compression has O(log m) time complexity, the clock period is O(log m) time. Although encoding technique and modified Booth coding reduce the number of partial products by a factor of two, the area complexity remains O(Nm). As a result, the area-time product complexity is reduced from O(N³m) in algorithms 3.3 and 6.1 to O(N² log m) in realization 10.

TABLE 5
Complexity Analysis of Montgomery MM Algorithms

| | Complexity | | | |
|---|---|---|---|---|
| | Cycle | Clock | Area | Area-Time |
| | Count | Period | Cost | Product |
| realization 2 | O(N/m) | O (Nm) | O (Nm) | O (N³ m) |
| realization 9 | O(N/m) | O (Nm) | O (Nm) | O (N³ m) |
| realization 10 | O(N/m) | O (logm) | O (Nm) | O (N² log m) |

2.5 Hardware Emulation Results

The proposed fixed-precision Montgomery MM design was coded in the Verilog hardware description language and implemented using the default flow of the Xilinx Vivado Virtex-7 xc7v585tffg1157-3 device, including synthesis and implementation. Instead of optimizing the realization for a specific value of m, our design maintains the flexibility to implement different m values, reflecting the trade-off between latency and area.

References [21] and [4] present two Montgomery MM designs that are parametric on m. When m doubles, the area roughly doubles whereas the cycle count is cut in half. However, the clock period also increases a lot. The period when m=8 is more than double that of m=2. Consequently, the area-time product (ATP) increases a lot when m increases.

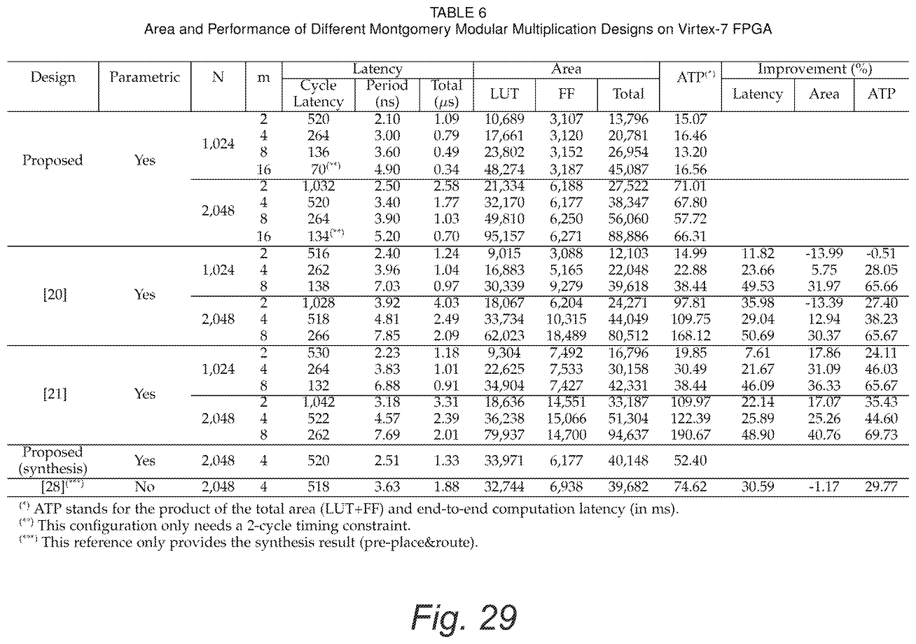

Because of the modified Booth coding and the proposed Encode/EncodeSN, we eliminate half of the partial products. Meanwhile, the critical path of our design only depends on m so that the clock period does not change by much. The increase in the clock period is mainly due to the larger fan-out count and more challenging placement and routing problems when N changes from 1,024 to 2,048. Considering the configuration N=1,024 and m=8, compared with [21] and [4], our design reduces the computation latency by 49.53% and 46.09%, respectively, and the area by 31.97% and 36.33%, respectively. As a result, we save more than 65% in terms of the ATP metric. The advantages of our design in other configurations are also evident. When increasing m, the clock period gradually increases so that the savings in computation latency decrease accordingly. Based on the experimental results for our proposed Montgomery MM, we achieve the minimum value of the ATP metric for m=8. Finally, reference [18] provide a Montgomery MM design specifically optimized for the configuration N=2,048 and m=4. Compared with its synthesis results, our flexible design (which is parameterizable in m) achieves 29.77% reduction in the ATP. (see, Table 6, FIG. 29).

3 Inventive Design of a High-Performance, Scalable Montgomery Modular Multiplier Circuit

It is desirable to design a high-performance, yet scalable, architecture for doing Montgomery modular multiplication. In the realization 8, both the quotient and intermediate result for each iteration are unsigned numbers so that it is not necessary to worry about the overflow problem mentioned in FIG. 16. Instead, both quotient and intermediate result of the realization 10 are signed numbers. This property gives rise to two problems:
Once we apply intermediate result decomposition in section 5.1.2, the resulting ZMₑ₋₁ is a signed number whereas the lower significant words are unsigned numbers. We need a special task to complete the last iteration of the inner loop.
Following the data model in FIG. 17, we can prevent any overflows of applying compression on the signed numbers by representing results in w+m+2 bits. In the last iteration of the inner loop, we need to fit the results in w+m bits but it would not be safe to simply truncate the leading 2 bits.

3.1 Variant for a Different Input Range

As we discussed, the scalable design targets to compute Z=XYR⁻¹modM when inputs X and Y and output Z all lie in the range [0,2M). This can be done easily by adjusting the number of iterations.

Intermediate result Z⁽ⁱ⁾ satisfies the following relation:

Z⁽ⁱ⁾rⁱ⁻¹=XΣₖ₌₀ⁱ\tilde{Y}ₖr^{k}+MΣₖ₌₀ⁱ⁻²\tilde{q}^{(k+1)}r^{k} (75)

When (i+1)≥┌(N+2)/m┐, we have Σₖ₌₀ⁱ \tilde{Y}ₖr^{k}=Y so that

Z⁽ⁱ⁾rⁱ⁻¹=XY+MΣₖ₌₀ⁱ⁻²\tilde{q}^{(k+1)}r^{k} (76)

Based on equation (76), we can calculate the range of Z⁽ⁱ⁾ as follows:

$$\begin{matrix}{Z}^{( i )} {r}^{i - 1} & < 4 {M}^{2} + \frac{2}{3} M ( r - 1 ) {\sum }_{k = 0}^{i - 2} {r}^{k} \\ & < 4 {M}^{2} + \frac{2}{3} M ( r - 1 ) \frac{{r}^{i - 1} - 1}{r - 1} \\ & < ( 4 M + \frac{2}{3} {r}^{i - 1} ) M \\ {Z}^{( i )} & < ( \frac{2}{3} + \frac{4 M}{{r}^{i - 1}} ) M \\ {Z}^{( i )} {r}^{i - 1} & \geq 0 - \frac{2}{3} M ( r - 1 ) {\sum }_{k = 0}^{i - 2} {r}^{k} > ( - \frac{2}{3} {r}^{i - 1} ) M \\ {Z}^{( i )} & > - \frac{2}{3} M > - M\end{matrix} \qquad ( 77 )$$

Therefore, when 4M/r^{d-2}≤1/3 or 12M<r^{d-2}, we have Z^{(d-1)}∈(−M, M). We can set d=┌(N+4)/m┐+2 to ensure 12M<16M<2^{N+4}≤2^{m(d-2)}=r^{d-2}. Realization 13 shows the details.

Since we prove Z^{(d-1)}∈(−M, M), the final result Z=Z^{(d-1)}+M∈(0,2M). Equation (78) generalizes the constraint:

md≥N+2m+4 (78)

When the number of iteration d meets the above equation, the final result Z lies in (0,2M).

```
Realization 13 Inventive fixed-precision radix-2^{m} Mont-
gomery modular multiplication: advanced version
Input: X, Y ∈ [0, 2M), odd M < 2^{N}, r = 2^{m},
    d = ┌N + 4)/m┐ + 2, R = r^{d-2}, r²r⁻¹, − M M″ = 1
    r²r⁻¹ − M M″ = 1
Output: Z ∈ [0, 2M)
  1: Z_{S}⁽⁻¹⁾ = Z_{C}⁽⁻¹⁾ = Z_{carry}⁽⁻¹⁾ = q_{S}⁽⁻¹⁾ = q_{C}⁽⁻¹⁾ = q_{carry}⁽⁻¹⁾ = 0
  2: for i = 0 to d − 1 do
  3: Z⁽ⁱ⁻¹⁾ = (Z_{S}⁽ⁱ⁻¹⁾, Z_{C}⁽ⁱ⁻¹⁾, Z_{carry}⁽ⁱ⁻¹⁾)
  4: Z_{L}⁽ⁱ⁻¹⁾ = (Z_{S}⁽ⁱ⁻¹⁾[2m − 1 : 0], Z_{C}⁽ⁱ⁻¹⁾[2m − 1 :
      0], Z_{carry}⁽ⁱ⁻¹⁾)
  5: Z_{L}⁽ⁱ⁻¹⁾ = Encode(Z_{L}⁽ⁱ⁻¹⁾)
  6: q⁽ⁱ⁻¹⁾ = (q_{S}⁽ⁱ⁻¹⁾, q_{C}⁽ⁱ⁻¹⁾, q_{carry}⁽ⁱ⁻¹⁾)
  7: \tilde{q}⁽ⁱ⁻¹⁾ = Encode(q⁽ⁱ⁻¹⁾), \hat{q}⁽ⁱ⁻¹⁾ = EncodeSN(q⁽ⁱ⁻¹⁾)
  8: (q_{S}⁽ⁱ⁾, q_{C}⁽ⁱ⁾) = Compress(\tilde{Z}_{L}⁽ⁱ⁻¹⁾ M″ − \hat{q}⁽ⁱ⁻¹⁾)
  9: q_{carry}⁽ⁱ⁾ = q_{S}⁽ⁱ⁾[m − 1] OR q_{C}⁽ⁱ⁾[m − 1]
10: q_{S}⁽ⁱ⁾ = q_{S}⁽ⁱ⁾ >> m, q_{C}⁽ⁱ⁾ = q_{C}⁽ⁱ⁾ >> m
11: Yᵢ = Yᵢ − Yᵢ[m − 1]r + Yᵢ₋₁[m − 1]
12: (Z_{S}⁽ⁱ⁾, Z_{C}⁽ⁱ⁾) = Compress(Z⁽ⁱ⁻¹⁾ + X\tilde{Y}ᵢr² + \hat{q}⁽ⁱ⁻¹⁾ M)
13: (Z_{S}⁽ⁱ⁾[N + 3m] = (Z_{S}⁽ⁱ⁾[N + 3m] XNOR Z_{C}⁽ⁱ⁾[N + 3m]
14: Z_{C}⁽ⁱ⁾[N + 3m] = 0
15: Z_{carry}⁽ⁱ⁾ = Z_{S}⁽ⁱ⁾[m − 1] OR Z_{C}⁽ⁱ⁾[m − 1]
16: Z_{S}⁽ⁱ⁾ = Z_{S}⁽ⁱ⁾ >> m, Z_{C}⁽ⁱ⁾ = Z_{C}⁽ⁱ⁾ >> m
17: end for
18: Z = Z_{S}^{(d-1)} + Z_{C}^{(d-1)} + Z_{carry}^{(d-1)} + M
19: return Z
```

```
Realization 14 Inventive fixed-precision radix-2^{m} Mont-
gomery modular multiplication after homogeneous decom-
position
Input: X, Y ∈ [0, 2M), odd M < 2^{N}, r = 2^{m},
  d = ┌(N + 4)/m┐ + 2, R = r^{d-2}, r²r⁻¹, − M M″ = 1
Output: Z ∈ [0, 2M)
  1: ZSME⁽⁻²⁾ = ZCME⁽⁻²⁾ = 0
  2: ZSME⁽⁻¹⁾ = ZCME⁽⁻¹⁾ = 0
  3: ZSRE⁽⁻¹⁾ = ZCRE⁽⁻¹⁾ = 0
  4: q_{S}⁽⁻¹⁾ = q_{C}⁽⁻¹⁾ = q_{carry}⁽⁻¹⁾ = 0
  5: for i = 0 to d − 1 do
  6:  ZRE⁽ⁱ⁻¹⁾ = (ZSRE⁽ⁱ⁻¹⁾, ZCRE⁽ⁱ⁻¹⁾)
  7:  ZME⁽ⁱ⁻²⁾ = (ZSME⁽ⁱ⁻²⁾, ZCME⁽ⁱ⁻²⁾)
  8:  (T_{S}⁽ⁱ⁻¹⁾, T_{C}⁽ⁱ⁻¹⁾)  =  Compress(ZRE⁽ⁱ⁻¹⁾ +
      ZME⁽ⁱ⁻¹⁾/r)
  9:  Z_{L}⁽ⁱ⁻¹⁾ = (T_{S}⁽ⁱ⁻¹⁾[2m − 1 : 0], T_{C}⁽ⁱ⁻¹⁾[2m − 1 :0])
10:  \tilde{Z}_{L}⁽ⁱ⁻¹⁾ = Encode(Z_{L}⁽ⁱ⁻¹⁾)
11:  q⁽ⁱ⁻¹⁾ = (q_{S}⁽ⁱ⁻¹⁾, q_{C}⁽ⁱ⁻¹⁾, q_{carry}⁽ⁱ⁻¹⁾)
12:  \tilde{q}⁽ⁱ⁻¹⁾ = Encode(q⁽ⁱ⁻¹⁾), \hat{q}⁽ⁱ⁻¹⁾ = EncodeSN(q⁽ⁱ⁻¹⁾)
13:  (q_{S}⁽ⁱ⁾, q_{C}⁽ⁱ⁾) = Compress(\tilde{Z}_{L}⁽ⁱ⁻¹⁾ M″ − \hat{q}⁽ⁱ⁻¹⁾)
14:  q_{carry}⁽ⁱ⁾ = q_{S}⁽ⁱ⁾[m − 1] OR q_{C}⁽ⁱ⁾[m − 1]
15:  q_{S}⁽ⁱ⁾ = q_{S}⁽ⁱ⁾ >> m, q_{C}⁽ⁱ⁾ = q_{C}⁽ⁱ⁾ >> m
16:  Yᵢ = Yᵢ − Yᵢ[m − 1]r + Yᵢ₋₁[m − 1]
17:  (Z_{S}⁽ⁱ⁾, Z_{C}⁽ⁱ⁾) = Compress(X\tilde{Y}ᵢr² + \hat{q}⁽ⁱ⁻¹⁾M +
      ZRE⁽ⁱ⁻¹⁾ + ZME⁽ⁱ⁻²⁾/r)
18:  (Z_{S}⁽ⁱ⁾[N + 3m] = (Z_{S}⁽ⁱ⁾[N + 3m] XNOR Z_{C}⁽ⁱ⁾[N + 3m]
19:  Z_{C}⁽ⁱ⁾[N + 3m] = 0
20:  Z_{carry}⁽ⁱ⁾ = Z_{S}⁽ⁱ⁾[m − 1] OR Z_{C}⁽ⁱ⁾[m − 1]
21:  (ZSME⁽ⁱ⁾, ZSRE⁽ⁱ⁾) = Decomposed(Z_{S}⁽ⁱ⁾ >> m)
22:  (ZCME⁽ⁱ⁾, ZCRE⁽ⁱ⁾) = Decomposed(Z_{C}⁽ⁱ⁾ >> m)
23:  TAIL(ZCRE₀⁽ⁱ⁾, Z_{carry}⁽ⁱ⁾
24: end for
25: Z = ZSME^{(d-2)} /r + ZSME^{(d-2)} /r + ZSME^{(d-1)} +
    ZSME^{(d-1)} + ZSRE^{(d-1)} + ZCRE^{(d-1)} + M
26: return Z
```

3.2 Homogeneous Decomposition of the Intermediate Result

Taking a closer look at realization 13, it can be seen that we only need the 2m least significant bits of Z_{S}⁽ⁱ⁻¹⁾ and Z_{C}⁽ⁱ⁻¹⁾ to compute q⁽ⁱ⁾. We may decompose both Z_{S}⁽ⁱ⁻¹⁾ and Z_{C}⁽ⁱ⁻¹⁾ into e words where each word has w bits (see the discussion of e below). In this case, the most significant word is a signed number whereas the remaining (lower significant) words are unsigned numbers. Instead, we extend the decomposition for Z (Z_{S} or Z_{C} in any iteration) into e words as shown below:

$$\begin{matrix}Z & = - Z [ N + 2 m ] {2}^{N + 2 m} + {\sum }_{i = 0}^{N + 2 m - 1} Z [ i ] {2}^{i} \\ & = {\sum }_{i = 0}^{e - 1} ( {ZE}_{i} ) {2}^{wi} \\ {ZE}_{i} & = {\sum }_{k = 0}^{w - 2} Z [ iw + k ] {2}^{k} - Z [ ( i + 1 ) w - 1 ] {2}^{w - 1} \\ & + Z [ iw - 1 ]\end{matrix} \qquad ( 79 )$$

Notice that Z[i]=Z[N+2m] for i≥N+2m to perform sign extension and Z[−1]=0.

In this case, Z is homogeneously decomposed into words ZEᵢ for 0≤i≤e−1. Each ZEᵢ is a w-bit signed number and a 1-bit unsigned tail number such that: Z=Σᵢ₌₀^{e-1} (ZEᵢ)2^{wi}. We can further decompose ZEᵢ into two parts ZMEᵢ and ZREᵢ as shown in (80). The least w−m bits of ZMEᵢ are 0 and the most m bits of ZREᵢ are 0. When w≥3m and w−m≥2m, we only need ZRE (more precisely ZRE₀) to compute q.

ZEᵢ=ZMEᵢ+ZREᵢ

ZMEᵢ=Σ_{k=w-m}^{w-1}Z[iw+k]2^{k}−Z[(i+1)w−1]2^{w-1}

ZREᵢ=Σₖ₌₀^{w-m-1}Z[iw+k]2^{k}+Z[iw−1]

Z=ZME+ZRE

ZME=Σᵢ₌₀^{e-1}ZMEᵢ2^{wi}

ZRE=Σᵢ₌₀^{e-1}ZREᵢ2^{wi} (80)

Realization 14 shows the Montgomery modular multiplication after the aforesaid homogeneous decomposition. We simply place Z_{carry}⁽ⁱ⁾ in the following bit of ZCRE₀⁽ⁱ⁾, say TAIL(ZCREV₀⁽ⁱ⁾).

3.3 Scalable Architecture

Similar to realization 8, we use an inner loop in realization 15 to do the operation Compress(X\tilde{Y}ᵢr²+\tilde{q}⁽ⁱ⁻¹⁾M+ZRE⁽ⁱ⁻¹⁾+ZME⁽ⁱ⁻¹⁾/r) by scanning w bits of X′=Xr², M, ZRE⁽ⁱ⁻¹⁾, and ZME⁽¹⁻¹⁾ in each iteration.

Realization 15 Inventive scalable radix-2^{m} Montgomery modular
multiplication (MWR2tm)

```
Input: X, Y ∈ [0, 2M), X′ = Xr², odd M < R = r^{kp-2},
    $r = {2}^{m} , {r}^{2} {r}^{- 1} - {MM}^{″} = 1 , w \geq 2 m , e = ⌈ \frac{N + 2 m + 3}{w} ⌉ ,$
    $k = ⌈ \frac{N + 2 m + 4}{m p} ⌉ , p = PE count$
Output: Z ∈ [0, 2M)
  1: ZSME′ = 0, ZSME = 0, ZSRE = 0
  2: ZCME′ = 0, ZCME = 0, ZCRE = 0,
  3: qs = 0, qc = 0, q_{carry} = 0
  4: for i = 0 to kp − 1 do {/ /outer loop}
  5:  FBS = FBC = 0
  6:  for j = 0 to e − 1 do {/ /inner loop}
  7:  (TS, TC) = Compress(ZSREⱼ + ZCREⱼ + ZSMEⱼ′/r +
        ZCMEⱼ′/r)
  8:  if j = = 0 then
  9:  Z_{L} = (T_{S}[2m − 1:0], T_{C}[2m − 1:0])
10:  Z̅_{L} = Encode(Z_{L})
11:  q = (q_{S}, q_{C}, q_{carry})
12:  q̅ = Encode(q), \hat{q} = EncodeSN(q)
13:  (q_{S}, q_{C}) = Compress(\tilde{Z}_{L}M″ − \hat{q})
14:  q_{carry} = q_{S}[m − 1] OR q_{C}[m − 1]
15:  q_{S} = q_{S} >> m, q_{C} = q_{C} >> m
16:  end if
```

3.3.1 Inner Loop Computations

In the first iteration of the inner loop (j=0), we need to compute the sum of ZSRE₀, ZCRE₀, ZSME₀/r, ZCME₀/r, X′₀\tilde{Y}ᵢ, and \tilde{q}M₀. Notice that they are signed numbers. We can use two (w+x)-bit signed numbers OS and OC (x≥0) to accurately represent the sum. Based on the least w bits, we can compute ZSRE₀ and ZCRE₀ as in (81). Notice that OS+OC is a multiple of r, we can embed Z_{carry}=OS[m−1]OROC[m−1] to the tail bit of ZCRE₀. The leading x bits of OS and OC are stored in FBS and FBC for future reference.

$$\begin{matrix}{ZSRE}_{0} + {ZCRE}_{0} & = \frac{OS [ w - 1 : 0 ] + OC [ w - 1 : 0 ]}{r} \\ & = OS [ w - 1 : m ] + OC [ w - 1 : m ] \\ & + {Z}_{carry}\end{matrix} \qquad ( 81 )$$

In the second iteration (j=1), we need to compute the sum of ZSRE₁, ZCRE₁, ZSME₁/r, ZCME₁/r, X′₁\tilde{Y}ᵢ, qM₁, FBS, and FBC. Again, we represent them into two (w+x)-bit signed number OS and OC. Based on the least w bits and the homogeneous decomposition in (80), we can compute ZSRE₁/ZCRE₁ and ZSME₀/ZCME₀. The leading x bits of OS and OC are again stored in FBS and FBC for future reference.

ZSME₀=Σₖ₌₀^{m-2}OS[k]2^{w-m+k}−OS[m−1]2^{w-1}

ZCME₀=Σₖ₌₀^{m-2}OC[k]2^{w-m+k}−OC[m−1]2^{w-1}

ZSRE₁=OS[w−1: m]+OS[m−1]

ZCRE₁=OC[w−1: m]+OC[m−1] (82)

The next question is what bitwidth w+x for OS and OC is sufficient to accurately represent intermediate results in each iteration of the inner loop. Following the data model in FIG. 17 and optimization in FIG. 18, we can prove that setting x=m+3 will suffice. Since OS[w+m+2] and OS[w+m+1] are the same, we may hide OS[w+m+2].

3.3.2 Scheduling and Computation of e

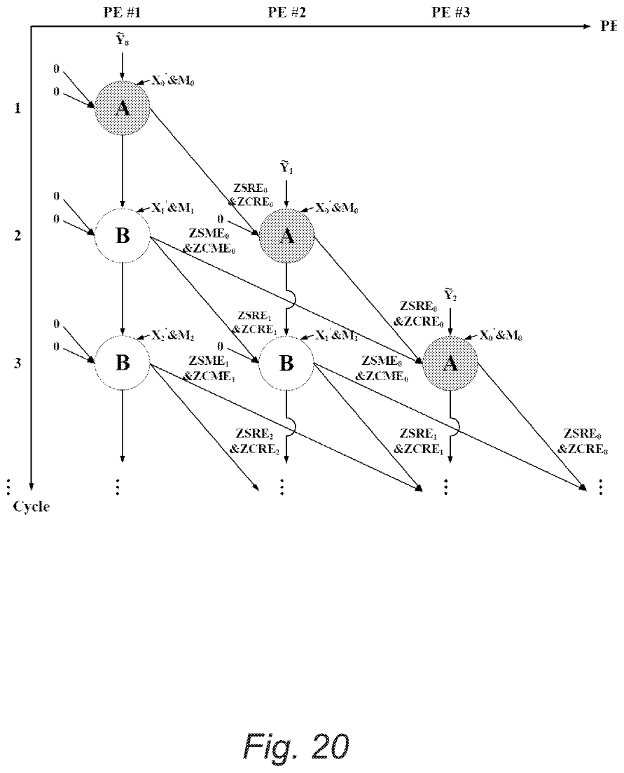

FIG. 20 shows the data dependency graph, where we can issue a new word of multiplier \tilde{Y}ᵢ every cycle. In the A task, we compute quotient q and intermediate result ZSRE₀ and ZCRE₀. In each of the B tasks, we compute ZSREⱼ and ZCREⱼ, ZSMEⱼ₋₁, and ZCMEⱼ₋₁.

FIG. 20(a) shows the schedule when we have 3 PEs to finish the computation in 3 rounds. In the A task of the second round of PE, we generate ZSRE₀ and ZCRE₀ and also generate ZSMEₑ₋₁ and ZCMEₑ₋₁ for the first round. Since we generate w bits every cycle, we actually try to fit intermediate result into ew+m bits. Based on the number of PE instances, we can compute the number of cycles as shown below:

$$cycle\_cnt = ( \begin{matrix}kp + e + 1 & ife \leq p \\ ke + p + 1 & otherwise\end{matrix} \qquad ( 83 )$$

3.3.3 Overflow Correction

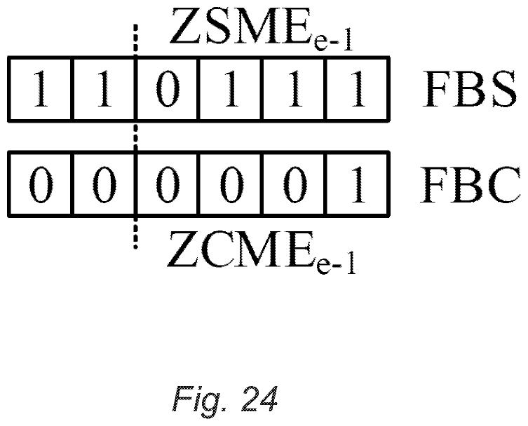

Ideally, we can generate w bits of the intermediate result until the last iteration j=e−1, in which we compute ZSREₑ₋₁, ZCREₑ₋₁, ZSMEₑ₋₂, and ZCMEₑ₋₂. If we use the whole m+2 bits of FBS and FBC to represent ZSMEₑ₋₁ and ZCMEₑ₋₁, we can accurately represent the data without overflow. However, it is dangerous to directly take m bits to fit ZSMEₑ₋₁ and ZCMEₑ₋₁. FIG. 24 shows an example. If we finish the addition, the sum is a negative number, but if we directly use the 4 least significant bits, ZSMEₑ₋₁ and ZCMEₑ₋₁ become positive and thus cause overflow. We need a method to correct the potential overflow.

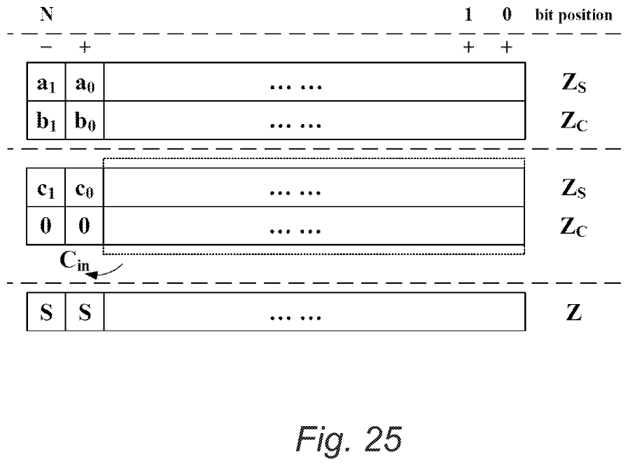

Fortunately, we just need a 2-bit addition to correct the overflow. FIG. 25 shows our data model. Assume we have two (N+1)-bit signed number Z_{S} and Z_{C} and we know the sum Z is an N-bit signed number, we just need one addition on the leading 2 bits. Since Z is a N-bit signed number, Z[N] must be the sign extension and Z[N]=Z[N−1].

Once we do the addition and ignore any overflow, we can deduce the possible carry Cᵢₙ for the least N−1 bits as shown in table 7. When (c₁, c₀)=(0,0), Cᵢₙ has to be 0 and Z[N]=Z[N−1]=0. Cᵢₙ cannot be 1, otherwise Z[N]≠Z[N−1]. Similarly, Cᵢₙ is 1 when (c₁, c₀)=(1,0). The case when (c₁, c₀)=(0,1) is impossible since Z[N] is always different from Z[N−1] no matter what Cᵢₙ is. When (c₁, c₀)=(1,1), Cᵢₙ can be 0 or 1. Except for the case (c₁, c₀)=(0,1), the remaining cases will not cause overflow and thus accurately represent the final sum Z.

TABLE 7
Truth table for the overflow correction

| c₁ | c₀ | Cᵢₙ |
|---|---|---|
| 0 | 0 | 0 |
| 0 | 1 | N.A. |
| 1 | 0 | 1 |
| 1 | 1 | 0/1 |

We can use the data model in FIG. 25 to compute ZSMEₑ₋₁ and ZCMEₑ₋₁. redEquation (84) shows that the intermediate result Z⁽ⁱ⁾ (after division by r) is an (N+2m+2)-bit signed number.

$$\begin{matrix}{Z}^{( i )} {r}^{i - 1} & = X {\sum }_{k = 0}^{i} {\tilde{Y}}_{k} {r}^{k} + M {\sum }_{k = 0}^{i - 2} {\tilde{q}}^{( k + 1 )} {r}^{k} \\ \vert {Z}^{( i )} {r}^{i - 1} \vert & < 2 M \frac{{r}^{i + 1}}{2} + \frac{2}{3} M ( r - 1 ) {\sum }_{k = 0}^{i - 2} {r}^{k} \\ & < 2 M ( \frac{{r}^{i + 1}}{2} + \frac{2}{3} {r}^{i - 1} ) \\ \vert {Z}^{( i )} \vert & < M ( {r}^{2} + \frac{2}{3} ) < {2}^{N + 2 m + 1}\end{matrix} \qquad ( 84 )$$

We thus require ew+m≥(N+3m+2)+1.

$$e = ⌈ \frac{N + 2 m + 3}{w} ⌉ \qquad ( 85 )$$

Assume we instantiate p PEs and go through them k rounds, we equivalently finish kp iterations of the outer loop. Based on equation (78), we have

$$m ( kp ) \geq N + 2 m + 4 \\ k = ⌈ \frac{N + 2 m + 4}{mp} ⌉ \qquad ( 86 )$$

Since e is large enough, we just need to add FBS[m−1: m−2] and FBC[m−1: m−2] and then assign the summation results to ZSMEₑ₋₁/ZCMEₑ₋₁.

3.3.4 Hardware Implementation

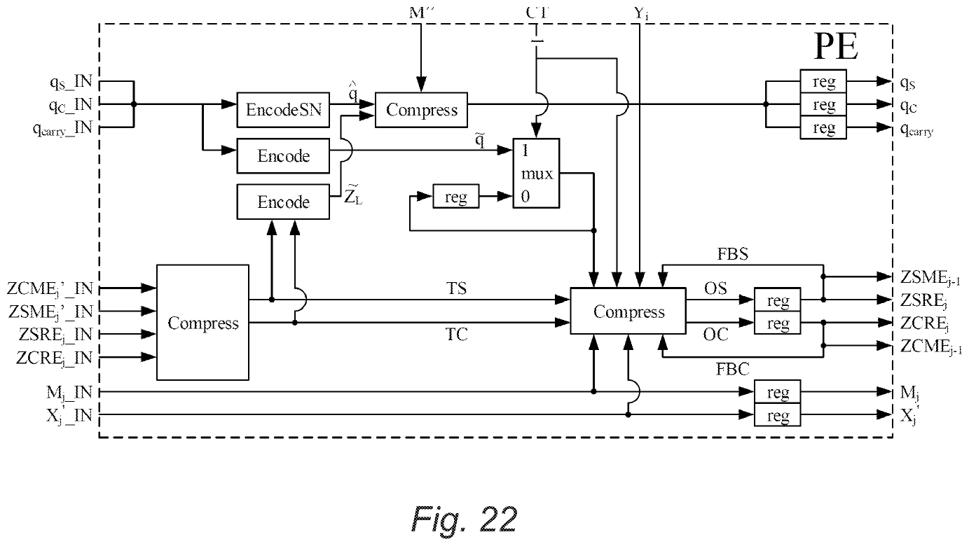

FIG. 22 shows the implementation of processing elements to do tasks A and B. In task A (CT=1), we perform the following operations:
compute \tilde{Z}_{L} and \hat{q} and compute q_{S}, q_{C}, and q_{carry};
compute \tilde{q} and compress \tilde{q}M₀+X′₀\tilde{Y}ᵢ+ZSME′₀/r+ZCME′₀/r+ZSRE₀+ZCRE₀;
generate results ZSRE₀ and ZCRE₀;
generate results ZSREₑ₋₁ and ZCREₑ₋₁ for the previous iteration based on the value stored in FBS and FBC; and
update FBS and FBC.

In task B (CT=0), we perform the following operations:
compress \tilde{q}Mⱼ+X′ⱼ\tilde{Y}ᵢ+ZSME′ⱼ/r+ZCME′ⱼ/r+ZSREⱼ+ZCREⱼ+FBS+FBC based on the stored \tilde{q};
generate results ZSREⱼ, ZCREⱼ, ZSMEⱼ₋₁, and ZCMEⱼ₋₁; and
update FBS and FBC.

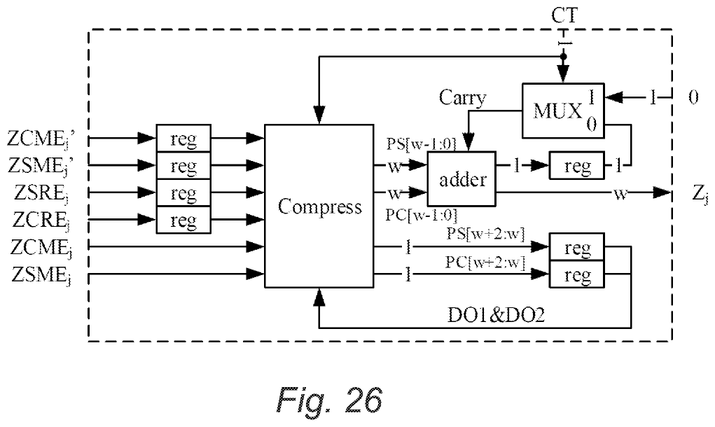

Unlike the A and B tasks, the C task needs only one special processing element (named PEc). FIG. 26 shows the implementation of the PEc. When CT=1, we force feedback signals DO1 and DO2 to 0 and set the carry signal as 0. When CT=0, we accept feedback signals DO1 and DO2 and set the carry signal as the carry-out bit from the previous cycle.

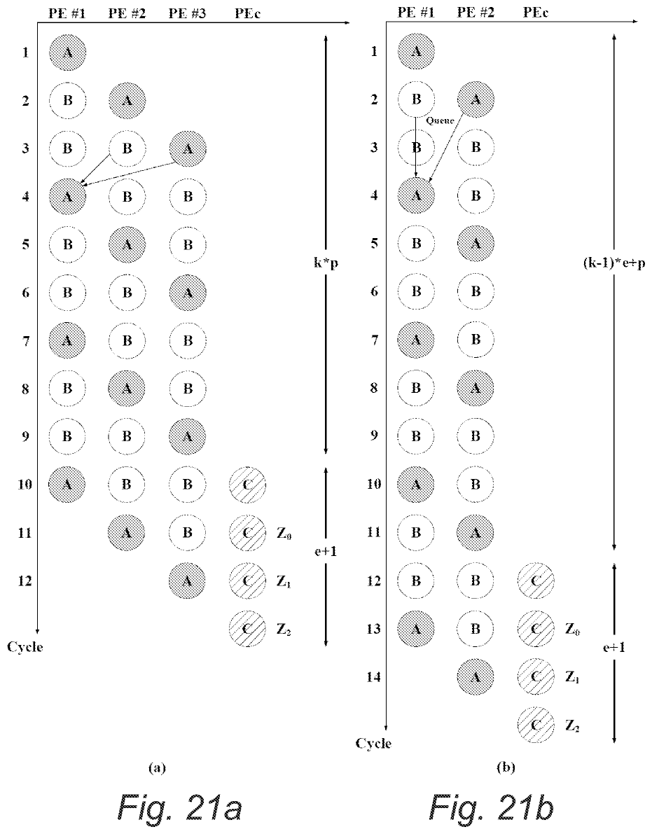

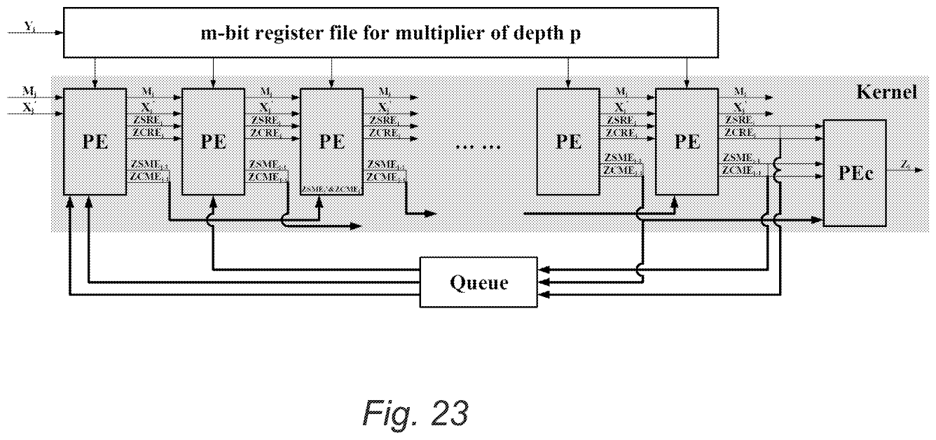

We also show the block-level architecture of the proposed high-performance, radix-2^{m} scalable Montgomery modular multiplication in FIG. 23. The required ZSME′ⱼ and ZCME′ⱼ in the i-th outer loop iteration in realization 8 are actually ZSMEⱼ and ZCMEⱼ which are generated in the (i−2)-nd outer loop iteration. Similarly, ZSME′ⱼ and ZCME′ⱼ required in the PEc are ZSMEⱼ and ZCMEⱼ generated by the next to the last PE. To compute Zⱼ, we need ZSME′ⱼ, ZCME′ⱼ, ZSMEⱼ, ZCMEⱼ, ZSREⱼ, ZCREⱼ. However, they are not generated in the same cycle. More precisely, ZSMEⱼ and ZCMEⱼ are generated in the (j+1)-st inner loop iteration whereas ZSME′ⱼ, ZCME′ⱼ, ZSREⱼ, and ZCREⱼ are generated in the j-th inner loop iteration and need to be delayed by one clock cycle as shown in FIG. 26. When p<e as in FIG. 21(b), a first-in first-out queue with a depth of e−p slots is necessary to buffer the outputs.

3.3.5 Pipelining

The design in section 7.3.4 finishes each iteration of the inner loop in one cycle. Instead, we can pipeline the processing element in FIG. 22 into 2 stages or more. Once the connections among different PEs are adjusted accordingly, we can achieve an issue latency (L) of 2 or more. Equation (87) generalizes the number of cycles.

$$cycle\_cnt = ( \begin{matrix}kLp + e + 1 & ife \leq Lp \\ ke + Lp + 1 & otherwise\end{matrix} \qquad ( 87 )$$

Although the number of cycles increases when L is more than 1, the required number of PEs (which is optimal for a specified bitwidth N) is reduced to e/L which results in area savings. If we balance the delay in each stage of the pipeline, the impact on the full circuit latency will be minimized.

Additional details of some aspects of the invention are set forth in B. Zhang, Z. Cheng and M. Pedram, “High-Radix Design of a Scalable Montgomery Modular Multiplier with Low Latency,” in IEEE Transactions of Computers, doi: 10.1109/TC.2021.3052999; the entire disclosure of which is hereby incorporated by reference.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

[1] Dorian Amiet, Andreas Curiger, and Paul Zbinden. Flexible fpga-based architectures for curve point multiplication over gf (p). In 2016 Euromicro Conference on Digital System Design (DSD), pages 107-114. IEEE, 2016.
[2] Richard P Brent and Hsiang T Kung. A regular layout for parallel adders. IEEE Computer Architecture Letters, 31(03):260-264, 1982.
[3] Viktor Bunimov and Manfred Schimmler. Area and time efficient modular multiplication of large integers. In Proceedings IEEE International Conference on Application-Specific Systems, Architectures, and Processors. ASAP 2003, pages 400-409. IEEE, 2003.
[4] Serdar Süer Erdem, Tuğrul Yanik, and Anil Çelebi. A general digit-serial architecture for montgomery modular multiplication. IEEE Transactions on Very Large Scale Integration (VLSI) Systems, 25(5):1658-1668, 2017.
[5] Sahar Fatemi, Maryam Zare, Amir Farzad Khavari, and Mohammad Maymandi-Nejad. Efficient implementation of digit-serial montgomery modular multiplier architecture. IET Circuits, Devices & Systems, 13(7):942-949, 2019.
[6] Craig Gentry. Fully homomorphic encryption using ideal lattices. In Proceedings of the forty-first annual ACM symposium on Theory of computing, pages 169-178, 2009.
[7] Zhen Gu and Shuguo Li. A division-free toom-cook multiplication-based montgomery modular multiplication. IEEE Transactions on Circuits and Systems II: Express Briefs, 66(8):1401-1405, 2018.
[8] Gaël Hachez and Jean-Jacques Quisquater. Montgomery exponentiation with no final subtractions: Improved results. In International Workshop on Cryptographic Hardware and Embedded Systems, pages 293-301. Springer, 2000.
[9] David Harris, Ram Krishnamurthy, Mark Anders, Sanu Mathew, and Steven Hsu. An improved unified scalable radix-2 montgomery multiplier. In 17th IEEE Symposium on Computer Arithmetic (ARITH'05), pages 172-178. IEEE, 2005.
[10] Miaoqing Huang, Kris Gaj, and Tarek El-Ghazawi. New hardware architectures for montgomery modular multiplication algorithm. IEEE Transactions on computers, 60(7):923-936, 2010.
[11] Neal Koblitz. Elliptic curve cryptosystems. Mathematics of computation, 48(177):203-209, 1987.
[12] Ciaran Mclvor, Maire McLoone, and John V McCanny. Fast montgomery modular multiplication and rsa cryptographic processor architectures. In The Thirty-Seventh Asilomar Conference on Signals, Systems & Computers, 2003, volume 1, pages 379-384. IEEE, 2003.
[13] NIEL Michael. Montgomery multiplication method, Feb. 17, 2015. U.S. Pat. No. 8,959,134.
[14] Peter L Montgomery. Modular multiplication without trial division. Mathematics of computation, 44(170):519-521, 1985.
[15] Miguel Morales-Sandoval and Arturo Diaz-Perez. Scalable gf (p) montgomery multiplier based on a digit-digit computation approach. IET Computers & Digital Techniques, 10(3):102-109, 2016.
[16] Michael Andrew Moshier and Jeff Furlong. Scalable, faster method and apparatus for montgomery multiplication, Sep. 28, 2010. U.S. Pat. No. 7,805,479.
[17] Michael Naehrig, Kristin Lauter, and Vinod Vaikuntanathan. Can homomorphic encryption be practical? In Proceedings of the 3rd ACM workshop on Cloud computing security workshop, pages 113-124, 2011.
[18] Bien-Cuong Nguyen and Cong-Kha Pham. An efficient hardware implementation of radix-16 montgomery multiplication. In 2019 IEEE 8th Global Conference on Consumer Electronics (GCCE), pages 1121-1122. IEEE, 2019.
[19] Holger Orup. Simplifying quotient determination in high-radix modular multiplication. In Proceedings of the 12th Symposium on Computer Arithmetic, pages 193-199. IEEE, 1995.
[20] Erdem Özcan and Serdar S Erdem. A fast digit based montgomery multiplier designed for fpgas with dsp resources. Microprocessors and Microsystems, 62:12-19, 2018.
[21] Jeng-Shyang Pan, Pengfei Song, and Chun-Sheng Yang. Efficient digit-serial modular multiplication algorithm on fpga. IET Circuits, Devices & Systems, 12(5):662-668, 2018.
[22] Ronald L Rivest, Len Adleman, Michael L Dertouzos, et al. On data banks and privacy homomorphisms. Foundations of secure computation, 4(11):169-180, 1978.
[23] Ronald L Rivest, Adi Shamir, and Leonard Adleman. A method for obtaining digital signatures and public-key cryptosystems. Communications of the ACM, 21(2):120-126, 1978.
[24] Sudhir K Satpathy, Raghavan Kumar, Sanu K Mathew, and Vikram B Suresh. Parallel computation techniques for accelerated cryptographic capabilities, Dec. 3, 2019. U.S. Pat. No. 10,498,532.
[25] Ming-Der Shieh and Wen-Ching Lin. Word-based montgomery modular multiplication algorithm for low-latency scalable architectures. IEEE transactions on computers, 59(8):1145-1151, 2010.
[26] Alexandre F Tenca and Çetin K Koç. A scalable architecture for modular multiplication based on montgomery's algorithm. IEEE Transactions on computers, 52(9):1215-1221, 2003.
[27] Colin D Walter. Montgomery's multiplication technique: How to make it smaller and faster. In International Workshop on Cryptographic Hardware and Embedded Systems, pages 80-93. Springer, 1999.
[28] Tao Wu, ShuGuo Li, and LiTian Liu. Fast rsa decryption through high-radix scalable montgomery modular multipliers. Science China Information Sciences, 58(6):1-16, 2015.

What is claimed is:

1. A Montgomery modular multiplier circuit comprising at least one digital processing component which produces a modular multiplication result by
(a) decomposing a multiplier into a group of words, each word containing a number of bits, and
(b) calculating one or more intermediate results based on the one or more intermediate results from a previous iteration and a product of a multiplicand and each word of the multiplier in an outer loop iteration.

2. The Montgomery modular multiplier circuit of claim 1 wherein the one or more intermediate results in each outer loop iteration is decomposed into a number of parts where some parts are moved to the next outer loop iteration for processing.

3. The Montgomery modular multiplier circuit of claim 2, wherein carry-save compressors are used to replace multiplication operations to generate the one or more intermediate results.

4. The Montgomery modular multiplier circuit of claim 3 wherein:
(a) the multiplicand is first left shifted by some number of bits and is then decomposed into a second group of words, each word containing a second number of bits, and
(b) the one or more intermediate results in each outer loop iteration are calculated based on the one or more intermediate results from two previous outer loop iterations and products of each word of the multiplicand and one word of the multiplier in an inner iteration loop.

5. The Montgomery modular multiplier circuit of claim 1 wherein the modular multiplication result is produced by
(a) decomposing the multiplier into the group of words, each word containing a number of bits, and
(b) independently calculating two sets of one or more intermediate results based on two sets of one or more intermediate results from the previous iteration and the product of the multiplicand and each word of the multiplier in the outer loop iteration.

6. The Montgomery modular multiplier circuit of claim 5 wherein first encoding circuits are used to speed up calculation of any expression that may be modelled as the product of a sum of two integers with another integer.

7. The Montgomery modular multiplier circuit of claim 4 wherein:
(a) the one or more intermediate results in each outer loop iteration are partitioned into two sets which can be calculated independently,
(b) first encoding circuits are used to speed up the calculation of any expression that may be modelled as the product of a sum of two integers with another integer, and
(c) second encoding circuits are used to decompose each of the intermediate results in a set of one or more intermediate results into two corresponding intermediate results.

8. The Montgomery modular multiplier circuit of claim 6 wherein:
(i) the multiplicand is first left shifted by some number of bits and is then decomposed into a third group of words, each word containing a third number of bits,
(ii) the one or more intermediate results in each outer loop iteration are calculated based on the two sets of one or more intermediate results from two previous outer loop iterations and products of each word of the multiplicand and one word of the multiplier in an inner iteration loop, and
(iii) second encoding circuits are used to decompose each of the intermediate results in the set of one or more intermediate results into two corresponding intermediate results.

9. The Montgomery modular multiplier circuit of claim 1 wherein the modular multiplication result is an output value Z congruent to XYR⁻¹ modM, wherein X is an (N+1)-bit wide multiplicand and Y is an (N+1)-bit wide multiplier with X and Y being integer numbers in the range [0,2M), M is an N-bit wide modulus, R is an integer that is a power of 2 such that R>M, and R⁻¹ is a modular multiplicative inverse of R with respect to M, the Montgomery modular multiplier circuit using a first input r⁻¹∈[0, M) and a second input M′∈[0, r) such that rr⁻¹−MM′=1 with r=2^{m} and wherein the least one digital processing component is configured to:
a) decompose multiplier Y into nₘ=┌(N+m+2)/m┐ words of m bits each, pad (nₘ*m−N−1) zero's to the left of Y such that Y=Σᵢ₌₀ⁿ^{ₘ} Yᵢ2^{im} with Yᵢ=Y[im+m−1: m] for 0≤i≤nₘ; and
b) produce output value Z by iteratively calculating and combining XYᵢr.

10. The Montgomery modular multiplier circuit of claim 9 wherein the at least one digital processing component comprises:
a) a plurality of processing elements (PEs) such that the i-th PE produces first intermediate results based on one or more intermediate results from the (i−2)-nd PE, one or more second intermediate results from the (i−1)-st PE, and the value of XYᵢr; and
b) a post-processing processing element which takes as input the intermediate results of the last two PEs and produces the output value Z.

11. The Montgomery modular multiplier circuit of claim 10 wherein a weighted sum of first intermediate results produced by the i-th PE is congruent to X(Σⱼ₌₀ⁱ Yⱼ2^{jm})r⁻ⁱ.

12. The Montgomery modular multiplier circuit of claim 1 wherein the at least one digital processing component is further configured to:
a) left shift multiplicand X by m bits to produce X′=Xr, pad (e*w−N−m−1) zero's to the left of X′, and decompose X′ into e=┌(N+2m+2)/w┐ words of w bits each such that X′=Σⱼ₌₀^{e-1} X′ⱼ2^{jw} with X′ⱼ=X′[jw+w−1: jw] for 0≤j≤e−1; and
b) produce output value Z by iteratively calculating and combining X′ⱼYᵢ.

13. The Montgomery modular multiplier circuit of claim 12 wherein the at least one digital processing component comprises:
a) a plurality of processing elements (PEs) such that the i-th PE produces first intermediate results based on one or more intermediate results from the (i−2)-nd PE, one or more intermediate results from the (i−1)-st PE, and the value of XYᵢr in e cycles, where in each cycle the i-th PE receives w bits of each intermediate result from the (i−2)-nd PE and the (i−1)-st PE, and produces w bits of the first intermediate results; and
b) a post-processing processing element which takes intermediate results of the last two PEs and produces the output value Z in e cycles.

14. The Montgomery modular multiplier circuit of claim 12, wherein the data initiation latency is 1 cycle and wherein the Montgomery modular multiplier circuit is scalable.

15. The Montgomery modular multiplier circuit of claim 12, wherein there are two or more first intermediate results and two of the first intermediate results are decomposed into e=┌(N+2m+2)/w┐ words of w bits, where m≥2 and w≥2m.

16. The Montgomery modular multiplier circuit of claim 15, wherein at least one of the first intermediate results has zero's at bit positions iw to iw+w−m−1 for 0≤i≤e−1.

17. The Montgomery modular multiplier circuit of claim 15, wherein at least one of the first intermediate results has zero's at bit positions iw+w−m to iw+w−1 for 0≤i≤e−1.

18. The Montgomery modular multiplier circuit of claim 10, wherein integer multiplication operations are unrolled into partial products, addition operations that are required to sum partial products and other results are replaced with k-to-2 compressors where k indicates numbers of integers that need to be compressed successively.

19. The Montgomery modular multiplier circuit of claim 18, wherein the at least one digital processing component is further configured to pad (nₘ*m−(N+1)) zero's to the left of multiplier Y and decompose the padded Y into nₘ=┌(N+2m+2)/m┐ words of m bits each, such that Y=Σᵢ₌₀ⁿ^{ₘ} Yᵢ2^{im} with Yᵢ=Y[im+m−1: m] for 0≤i≤nₘ, and wherein the at least one digital processing component comprises:
a) a plurality of processing elements (PEs), the i-th PE producing first intermediate results based on intermediate results from the (i−2)-nd PE and the (i−1)-st PE and such that a weighted sum of intermediate results is congruent to X(Σⱼ₌₀ⁱ Yⱼ2^{jm})r⁻ⁱ; and
b) a post-processing processing element taking intermediate results of the last and next to the last PEs and producing the output value Z.

20. The Montgomery modular multiplier circuit of claim 18, wherein there are two or more first intermediate results and at least two of the first intermediate results are decomposed into e=┌(N+2m+2)/w┐ words of w bits, where m≥2 and w≥2m.

21. The Montgomery modular multiplier circuit of claim 20, wherein at least one of the first intermediate results has zero's at bit positions iw to iw+w−m−1 for 0≤i≤e−1.

22. The Montgomery modular multiplier circuit of claim 20, wherein at least one of the first intermediate results has zero's at bit positions iw+w−m to iw+w−1 for 0≤i≤e−1.

23. The Montgomery modular multiplier circuit of claim 19, wherein one of the intermediate results is a 1-bit value.

24. The Montgomery modular multiplier circuit of claim 18, wherein a Booth coding technique is used to speed up the compressors.

25. The Montgomery modular multiplier circuit of claim 19, wherein multiplicand X is left shifted by m bits to produce X′=Xr, padded with (e*w−m−(N+1)) zero's on the left, and the padded X′ is decomposed into e words of w bits each with such that X′=Σⱼ₌₀^{e-1} X′ⱼ2^{jw} with X′ⱼ=X′[jw+w−1: jw] for 0≤j≤e−1) such that the PEs compute their first intermediate results by repeatedly calculating the product of X′ⱼYᵢ for different i and j indices, thereby, enabling design of PEs that are independent of value of N, and producing a scalable Montgomery modular multiplier circuit.

26. The Montgomery modular multiplier circuit of claim 25, wherein the data initiation latency is 1 cycle and wherein the Montgomery modular multiplier circuit is scalable.

27. The post-processing processing element of claim 25 repeatedly taking intermediate results of the last two PEs and producing the partial output value Z.

28. A Montgomery modular multiplier circuit, which calculates an output value Z congruent to XYR⁻¹modM, wherein X is an N-bit multiplicand and Y is an N-bit multiplier with X and Y being integer numbers in the range [0, M), M is a N-bit wide modulus, R is an integer that is a power of 2 such that R>M, and R⁻¹ is a modular multiplicative inverse of R with respect to M, Montgomery modular multiplier circuit receiving a first additional input r⁻¹∈[0, M) and a second additional input M″∈[0, r²) such that r²r⁻¹−MM″=1 with r=2^{m} and comprises at least one digital processing component configured to:
a) decompose multiplier Y into nₘ=┌N/m┐ words of m bits each, pad (nₘ*m−N) zero's to the left of Y such that Y=Σᵢ₌₀ⁿ^{ₘ}⁻¹ Yᵢ2^{im} with Yᵢ=Y[im+m−1: m] for 0≤i<nₘ; and
b) produce output value Z by iteratively calculating and combining values of XYᵢr².

29. The Montgomery modular multiplier circuit of claim 28 comprising:
a) a digital processing component configured to produce two intermediate results independently of one another in the i-th iteration, wherein the two intermediate results are calculated based on the value of XYᵢr² and the corresponding two intermediate results produced in the (i−1)-st iteration; and
b) a post-processing processing element which takes intermediate results of the last iteration as input and produces the output value Z.

30. The Montgomery modular multiplier circuit of claim 29 wherein one intermediate result produced in the i-th iteration is congruent to X(Σⱼ₌₀ⁱ Yᵢr^{j})r⁻⁽ⁱ⁻¹⁾modM where r⁻⁽ⁱ⁻¹⁾ is the multiplicative inverse of rⁱ⁻¹modM.

31. The Montgomery modular multiplier circuit of claim 20 further comprising a first encoder circuit, which calculates (t+1)-bit outputs â and \hat{b} from t-bit inputs a and b, wherein t≥3. The encoder circuit ensuring that v_{â}+v_{\hat{b}}=a+b where v_{â}=â[t]2^{t}−â[t−1]2^{t-1}+Σᵢ₌₀^{t-1} â[i]2ⁱ and v_{\hat{b}}=\hat{b}[t]2^{t}−\hat{b}[t−1]2^{t-1}+Σᵢ₌₀^{t-1} \hat{b}[i]2ⁱ, and comprising at least one digital processing component configured to:
a) calculate a 3-bit intermediate result d as d[2: 0]=a[t−1: t−2]+b[t−1: t−2]+(a[t−3]ANDb[t−3]);
b) if t≥4, calculate â[t−4: 0]=a[t−4: 0] and \hat{b}[t−4: 0]=b[t−4: 0];
c) calculate â[t−3]=a[t−3]XORb[t−3]; â[t−2]=d[0]; â[t−1]=d[1]; â[t]=d[2]; and
d) calculate \hat{b}[t−1: t−3]=0; \hat{b}[t]=d[1].

32. The Montgomery modular multiplier circuit of claim 31, further comprising a second encoder circuit which calculates (t+1)-bit outputs ã and \tilde{b} from t-bit inputs a and b and 1-bit input c, where t≥2. The encoder circuit ensuring that v_{ã}+v_{\tilde{b}}=a+b+c where v_{ã}=Σᵢ₌₀^{t/2} ã[2i]2²ⁱ−Σᵢ₌₀^{t/2-1} ã[2i+1]2²ⁱ⁺¹ and v_{\tilde{b}}=Σᵢ₌₀^{t/2} \tilde{b}[2i]2²ⁱ−Σᵢ₌₀^{t/2-1} \tilde{b}[2i+1]2²ⁱ⁺¹, and comprising at least one digital processing component configured to:
a) encode a[1: 0], b[1: 0], and c to generate outputs cₒᵤₜ⁽⁰⁾, d⁽⁰⁾, and e⁽⁰⁾;
c) encode a[2i+1: 2i], b[2i+1: 2i], and cₒᵤₜ⁽ⁱ⁻¹⁾ to generate outputs cₒᵤₜ⁽ⁱ⁾, d⁽ⁱ⁾, and e⁽ⁱ⁾ for 0<i≤t/2−1;
d) calculate ã[2i+1: 2i]=d⁽ⁱ⁾ for 0≤i≤t/2−1; ã[t]=cₒᵤₜ^{(t/2-1)}; and
e) calculate \tilde{b}[2i+2]=e⁽ⁱ⁾ for 0≤i≤t/2−1.

33. The Montgomery modular multiplier circuit of claim 32 wherein:
the digital processing component produces two groups of intermediate results independently of one another in the i-th iteration;
the two groups of intermediate results produced in i-th iteration are calculated based on the value of X\tilde{Y}ᵢr² and the corresponding two groups of intermediate results produced in the (i−1)-st iteration wherein each group contains three intermediate results and \tilde{Y}ᵢ=Yᵢ−Yᵢ[m−1]r+Yᵢ₋₁[m−1];
the first encoder circuit and the second encoder circuit accelerate calculation of intermediate results in the i-th iteration; and
the post-processing processing element takes intermediate results of the last iteration as input and produces the output value Z.

34. The Montgomery modular multiplier circuit of claim 33 wherein a weighted sum of first intermediate results produced in the i-th iteration is congruent to X(Σⱼ₌₀ⁱ Yᵢr^{j})r⁻⁽ⁱ⁻¹⁾modM where r⁻⁽ⁱ⁻¹⁾ is the multiplicative inverse of r¹⁻¹modM.

35. The Montgomery modular multiplier circuit of claim 33 wherein X is an (N+1)-bit multiplicand and Y is an (N+1)-bit multiplier with X and Y being integer numbers in the range [0,2M) wherein:
the number of iterations d is at least ┌(N+4)/m┐ and R is r^{d-2}; and
the post-processing processing element which takes intermediate results of the last iteration as input and produces the output value Z.

36. The Montgomery modular multiplier circuit of claim 35 wherein the at least one digital processing component wherein:
the i-th PE produces first intermediate results based on one or more intermediate results from the (i−2)-nd PE, one or more second intermediate results from the (i−1)-st PE, and the value of X\tilde{Y}ᵢr²; and
the post-processing processing element which takes as input the intermediate results of the last two PEs and produces the output value Z.

37. The Montgomery modular multiplier circuit of claim 36, wherein there are two or more first intermediate results and two of the first intermediate results are decomposed into e=┌(N+2m+3)/w┐ words where w≥3m.

38. The Montgomery modular multiplier circuit of claim 37, wherein
at least one of the first intermediate results has zero's at bit positions iw to iw+w−m−1 for 0≤i≤e−1.; and
at least one of the first intermediate results has a tail bit at bit positions iw for 0≤i≤e−1.

39. The Montgomery modular multiplier circuit of claim 37, wherein
at least one of the first intermediate results has zero's at bit positions iw+w−m to iw+w−1 for 0≤i≤e−1; and
the weight of bit positions iw for 0≤i≤e−1 is −2^{iw}.

40. The Montgomery modular multiplier circuit of claim 36 whereby multiplicand X is left shifted by 2m bits to produce X′=Xr², padded with (e*w−N−m−1)) zero's on the left, and the padded X′ is decomposed into e words of w bits each with such that X′=Σⱼ₌₀^{e-1} X′ⱼ2^{jw} with X′ⱼ=X′[jw+w−1: jw] for 0≤j≤e−1) such that the PEs compute their first group of intermediate results by repeatedly calculating the product of X′ⱼYᵢ for different i and j indices, thereby, enabling design of PEs that are independent of value of N, and producing a scalable Montgomery modular multiplier circuit.

41. The Montgomery modular multiplier circuit of claim 40 where the data initiation latency is 1 cycle and wherein the Montgomery modular multiplier circuit is scalable.

42. The Montgomery modular multiplier circuit of claim 40 wherein post-processing repeatedly takes intermediate results of the last two PEs and producing the partial output value Z.

43. The Montgomery modular multiplier circuit of claim 40 wherein post-processing repeatedly is designed into a pipeline with L stages where the data initiation latency is L cycle.

44. An encoder circuit, which calculates (t+1)-bit outputs â and \hat{b} from t-bit inputs a and b, wherein t≥3. The encoder circuit ensuring that v_{â}+v_{\hat{b}}=a+b where v_{â}=â[t]2^{t}−â[t−1]2^{t-1}+Σᵢ₌₀^{t-1} â[i]2ⁱ and v_{\hat{b}}=\hat{b}[t]2^{t}−\hat{b}[t−1]2^{t-1}+Σᵢ₌₀^{t-1} \hat{b}[i]2ⁱ, and comprising at least one digital processing component configured to:
a) calculate a 3-bit intermediate result d as d[2: 0]=a[t−1: t−2]+b[t−1: t−2]+(a[t−3]ANDb[t−3]);
b) if t≥4, calculate â[t−4: 0]=a[t−4: 0] and \hat{b}[t−4: 0]=b[t−4: 0];
c) calculate â[t−3]=a[t−3]XORb[t−3]; â[t−2]=d[0]; â[t−1]=d[1]; â[t]=d[2]; and
d) calculate \hat{b}[t−1: t−3]=0; \hat{b}[t]=d[1].

45. The encoder circuit of claim 44 wherein v_{â[t-1:0]}+v_{\hat{b}[t-1:0]} is congruent to a+bmod2^{t} with v_{â[t-1:0]}=−â[t−1]2^{t-1}+Σᵢ₌₀^{t-1} â[i]2ⁱ and v_{\hat{b}[t-1:0]}=−\hat{b}[t−1]2^{t-1}+Σᵢ₌₀^{t-1} \hat{b}[i]2ⁱ.

46. An encoder circuit, which calculates 3-bit outputs â and \hat{b} from 2-bit inputs a and b, wherein the encoder circuit ensures that v_{â}+v_{\hat{b}}=a+b with v_{â}=4â[2]−2â[1]+â[0] and v_{\hat{b}}=4\hat{b}[2]−2\hat{b}[1]+\hat{b}[0], and comprising at least one digital processing component configured to:
calculate a 3-bit intermediate result d as d [2: 0]=a+b;
calculate â=d; and
calculate \hat{b}[1: 0]=0; \hat{b}[2]=d[1].

47. The encoder circuit of claim 46 wherein v_{â[1:0]}+v_{\hat{b}[1:0]} is congruent to a+bmod4 with v_{â[1:0]}=−2â[1]+â[0] and v_{\hat{b}[1:0]}=−2\hat{b}[1]+\hat{b}[0].

48. An encoder circuit, which calculates 1-bit outputs cₒᵤₜ and e and a 2-bit output d from 2-bit inputs a and b, and 1-bit input cᵢₙ. The encoder circuit ensures that 4cₒᵤₜ+4e−2d[1]+d[0]=a+b+c and comprises at least one digital processing component configured to:
calculate a 2-bit value as 2c [1]+d[0]=a[0]+b[0]+cᵢₙ;
calculate cₒᵤₜ=a[1]ANDb[1];
calculate d[1]=a[1]XORb[1]XORc[1]; and
calculate e=a[1]XORb[1]ORc[1].

49. The encoder circuit of claim 48, configured to calculate (t+1)-bit outputs ã and \tilde{b} from t-bit inputs a and b and 1-bit input c, where t≥2. The encoder circuit ensuring that v_{ã}+v_{\tilde{b}}=a+b+c where v_{â}=Σᵢ₌₀^{t/2} ã[2i]2²ⁱ−Σᵢ₌₀^{t/2-1} ã[2i+1]2²ⁱ⁺¹ and v_{\tilde{b}}=Σᵢ₌₀^{t/2} \tilde{b}[2i]2²ⁱ−Σᵢ₌₀^{t/2-1} \tilde{b}[2i+1]2²ⁱ⁺¹, and comprising at least one digital processing component configured to:
a) encode a[1: 0], b[1: 0], and c to generate outputs cₒᵤₜ⁽⁰⁾, d⁽⁰⁾, and e⁽⁰⁾;
c) encode a[2i+1: 2i], b[2i+1: 2i], and cₒᵤₜ⁽ⁱ⁻¹⁾ to generate outputs cₒᵤₜ⁽ⁱ⁾, d⁽ⁱ⁾, and e⁽ⁱ⁾ for 0<i≤t/2−1;
d) calculate ã[2i+1: 2i]=d⁽ⁱ⁾ for 0≤i≤t/2−1; ã[t]=cₒᵤₜ^{(t/2-1)}; and
e) calculate \tilde{b}[2i+2]=e⁽ⁱ⁾ for 0≤i≤t/2−1.

50. The encoder circuit of claim 49 wherein if parameter t is odd, inputs a and b are padded by one 0 on the left.

51. The encoder circuit of claim 49 wherein v_{ã[t-1:0]}+v_{\tilde{b}[t-1:0]} is congruent to a+bmod2^{t} with v_{ã[t-1:0]}=Σᵢ₌₀^{t/2-1} ã[2i]2²ⁱ−Σᵢ₌₀^{t/2-1} ã[2i+1]2²ⁱ⁺¹ and v_{\tilde{b}[t-1:0]}=Σᵢ₌₀^{t/2-1} \tilde{b}[2i]2²ⁱ−Σᵢ₌₀^{t/2-1} \tilde{b}[2i+1]2²ⁱ⁺¹.

52. The encoder circuit of claim 49 wherein v_{ã}+v_{\tilde{b}}−c is equal to v_{â}+v_{\hat{b}}.

53. The encoder circuit of claim 49 wherein v_{ã[t-1:0]}+v_{\tilde{b}[t-1:0]}−c is equal to v_{â[t-1:0]}+v_{\hat{b}[t-1:0]}.
